(19) United States
(12) Patent Application Publication
(10) Pub. No.: US 2026/0220868 A1
(43) Pub. Date: Jul. 30, 2026

(54) CUSTOMIZED USER INTERFACES AND MEDIA CONTENT EXPERIENCES

(71) Applicant: Roku, Inc., San Jose, CA (US)

(72) Inventors: Shashank Merchant, Sunnyvale, CA (US); Ryan P. Pressler, Novato, CA (US); Nicole Sarah Wargon, Santa Cruz, CA (US); Margret Schmidt, Redwood City, CA (US); Kaushiki Priyam, San Jose, CA (US); Neala Gollomp, Villanova, PA (US); Matthieu Chamik, Sebastopol, CA (US); Noah Henry Kaarbo, Seattle, WA (US); Shraddha Chudasama, Pleasanton, CA (US); I Chun Lin, Rowland Heights, CA (US)

(21) Appl. No.: 19/279,951

(22) Filed: Jul. 24, 2025

Related U.S. Application Data
(60) Provisional application No. 63/749,854, filed on Jan. 27, 2025.

(51) Int. Cl. G06T 13/80; G06F 3/04842

(52) U.S. Cl. CPC G06T 13/80; G06F 3/04842

(57) ABSTRACT

System, apparatus, article of manufacture, method and/or computer program embodiments are provided for customizing user interfaces (UIs) and UI experiences based on UI themes and features. An example method can include determining features of a UI of an application, the features comprising a content item, functionality, setting, and/or UI destination; selecting a feature from the features based on a theme of the UI and/or a respective selection parameter of each feature, the respective selection parameter defining a feature preference, priority, metric, and/or relevance with respect to a date associated with a presentation of the UI, a user, the application, and/or feature topic; generating, via an AI model, animated content for display at the UI, the animated content depicting the feature and/or an interaction between the animated content and a portion of the UI associated with the feature; and providing the animated content to the UI and/or a device.

### CROSS-REFERENCE TO RELATED APPLICATIONS

This application claims the benefit of, and priority to, U.S. Provisional Application No. 63/749,854 filed on Jan. 27, 2025, the contents of which are incorporated herein by reference in their entirety and for all purposes. This application is also related to U.S. Non-Provisional Patent Application Ser. No. 19/279,419, filed on Jul. 24, 2025; and U.S. Non-Provisional Patent Application Ser. No. 19/279,741, filed on Jul. 24, 2025; which are expressly incorporated by reference herein in their entirety and for all purposes.

### BACKGROUND

### Field

This disclosure is generally directed to media content interfaces and, more specifically, user interfaces and immersive user interface experiences customized based on themes.

### SUMMARY

Provided herein are system, apparatus, article of manufacture, method and/or computer program product embodiments (and/or combinations and/or sub-combinations thereof) for generating customized user interfaces and user interface experiences. In some aspects, a method is provided for generating customized user interfaces (UIs) and UI experiences. An example method can include determining a set of features associated with a UI of an application, the set of features including a content item, a functionality of the UI, a setting of the UI, and/or a destination of the UI; selecting a feature from the set of features based on a theme of the UI and/or a respective selection parameter associated with each feature from the set of features, the respective selection parameter defining a feature preference, a feature priority, a feature metric, and/or a feature relevance with respect to a date (e.g., a date associated with a presentation of the UI, a date of an event such as a content release event or a competition, a date in which the feature has a different significance than in other dates, etc.), a user associated with the UI, the application, and/or topic; generating, via an artificial intelligence (AI) model, animated content for the UI, the animated content depicting the selected feature and/or an interaction between the animated content and a portion of the UI associated with the selected feature; and providing the animated content to the UI and/or a device associated with the user.

In some aspects, a system is provided for generating customized UIs and UI experiences. The system can include one or more computing and/or media devices such as, for example, a television, a media player, a server, a computer, a set-top box, an Internet-of-Things (IoT) device, a peripheral device, a mobile device (e.g., a smartphone, etc.), a wearable computing device (e.g., a smartwatch, smartglasses, a head-mounted display (HMD), an extended reality (e.g., virtual reality, augmented reality, mixed reality, virtual reality with video passthrough, etc.) glasses, etc.) system, a single-board computer (SBC) or system-on-chip (SoC) device, a video game console, and/or a smart device, among others.

The system can include memory used to store data, such as computing instructions, and one or more processors coupled to the memory and configured to perform operations including determining a set of features associated with a UI of an application, the set of features including a content item, a functionality of the UI, a setting of the UI, and/or a destination of the UI; selecting a feature from the set of features based on a theme of the UI and/or a respective selection parameter associated with each feature from the set of features, the respective selection parameter defining a feature preference, a feature priority, a feature metric, and/or a feature relevance with respect to a date associated with a presentation of the UI, a user associated with the UI, the application, and/or feature topic; generating, via an artificial intelligence (AI) model, animated content for display at the UI, the animated content depicting the selected feature and/or an interaction between the animated content and a portion of the UI associated with the selected feature; and providing the animated content to the UI and/or a device associated with the user.

In some aspects, a non-transitory computer-readable medium is provided for generating customized UIs and UI experiences. In some cases, the non-transitory computer-readable medium can have instructions stored thereon that, when executed by one or more processors, cause the one or more processors to perform operations including determining a set of features associated with a UI of an application, the set of features including a content item, a functionality of the UI, a setting of the UI, and/or a destination of the UI; selecting a feature from the set of features based on a theme of the UI and/or a respective selection parameter associated with each feature from the set of features, the respective selection parameter defining a feature preference, a feature priority, a feature metric, and/or a feature relevance with respect to a date associated with a presentation of the UI, a user associated with the UI, the application, and/or feature topic; generating, via an artificial intelligence (AI) model, animated content for display at the UI, the animated content depicting the selected feature and/or an interaction between the animated content and a portion of the UI associated with the selected feature; and providing the animated content to the UI and/or a device associated with the user.

### BRIEF DESCRIPTION OF THE FIGURES

The accompanying drawings are incorporated herein and form a part of the specification.

FIG. 1 is a block diagram illustrating an example multimedia environment, according to some examples of the present disclosure.

FIG. 2 is a block diagram illustrating an example media device, according to some examples of the present disclosure.

FIG. 3A illustrates an example of a customized user interface implementing a theme and associated content, according to some examples of the present disclosure.

FIG. 3B illustrates another example of a customized user interface implementing a theme and associated content, according to some examples of the present disclosure.

FIG. 4 illustrates another example of a user interface configured with a theme, according to some examples of the present disclosure.

FIGS. 5A through 5D illustrate example user interfaces customized based on a theme(s), according to some examples of the present disclosure.

FIGS. 6A and 6B are diagrams illustrating example user interfaces and immersive experiences customized based on themes, according to some examples of the present disclosure.

FIGS. 7A and 7B are diagrams illustrating example user interfaces and interface containers customized based on themes, according to some examples of the present disclosure.

FIGS. 8A through 8C are diagrams illustrating example user interfaces and interface containers customized based on themes, according to some examples of the present disclosure.

FIG. 9 is a diagram illustrating an example system process for customizing user interfaces, according to some examples of the present disclosure.

FIGS. 10A through 12B are diagrams illustrating example user interfaces customized to provide immersive experiences, according to some examples of the present disclosure.

FIGS. 13A and 13B are flowcharts illustrating example methods for customizing user interfaces based on themes, according to some examples of the present disclosure.

FIG. 14 illustrates an example computer system that can be used for implementing various aspects of the present disclosure.

In the drawings, like reference numbers generally indicate identical or similar elements. Additionally, generally, the left-most digit(s) of a reference number identifies the drawing in which the reference number first appears.

### DETAILED DESCRIPTION

Users can access and consume media content using media devices such as, for example and without limitation, mobile phones (e.g., smartphones), set-top boxes, computers (e.g., desktop computers, laptop computers, tablet computers, etc.), televisions (TVs), Internet Protocol television (IPTV) devices or receivers, media players, displays or monitors, projectors, video game consoles, smart wearable devices (e.g., smartwatches, smartglasses, head-mounted displays (HMDs), extended reality devices (e.g., virtual reality glasses, augmented reality glasses, mixed reality glasses, virtual reality devices with video passthrough, etc.), single-board computers (SBCs) or system-on-chip (SoC) devices, and Internet-of-Things (IoT) devices, among other devices. The media content can include or encompass digital formats and/or assets such as, for example and without limitation, videos (e.g., live videos, pre-recorded or on-demand videos, streamed videos, TV shows, movies, animated videos, motion graphics videos, live action recordings, video clips, any sequence of video frames or graphics, etc.), video games, audio, text (e.g., closed captions, subtitles, onscreen text, intertitles, superimposed text, and/or any other text content), graphics, video and/or application channels, and/or images, among other types.

For example, a user can use a media device to watch a video available through a content platform. The content platform can include a software application, infrastructure, and/or environment associated with (e.g., that includes, hosts, provides, implements, runs on, corresponds to, can be accessed via, etc.) a streaming service, set-top box, set-top box application or environment, online content delivery network, video game system, media application, media player, video sharing application, web browser, TV (and/or, TV application, operating system, and/or platform), entertainment system, online content service, media channel, content provider, media broadcast system, podcast system, linear content system, media receiver, and/or the like. The video can include, for example, a video (e.g., movie, TV show, podcast, livestream, video stream or feed, video broadcast, video recording, video clip, animated video, etc.), broadcast, video game, video conference, video podcast, etc. The media device can access or stream the video from the content platform or a web browser, access the video from storage, or obtain the video from another device. The media device can display the video on a display of the media device and/or a separate/external display. The user can use the media device, a remote control, and/or an application to manage any settings of the video (e.g., volume, closed caption settings, subtitles, resolution, color settings, brightness levels, etc.), navigate to and/or access other content, control a behavior or functionality of the video (e.g., playback, pause, stop, rewind, record, forward, etc.), etc. The media device can include, obtain, and/or manage content (e.g., videos, images, audio, etc.), channels, applications, settings, input and/or output devices, media functionalities, and/or other features/components, which the user can access via the media device.

The media device can content via a user interface. The user can use the user interface to access and consume (e.g., view/watch, play/replay, etc.) content, interact with content, select content, navigate content and pages, manage a behavior of a content item, adjust content settings, engage in content experiences, etc. The user interface, as well as the user interface configuration and attributes, can affect the user experience. For example, the configuration of the user interface can affect the level of difficulty for the user to find/discover or identify/navigate content and features/functionalities, search or access content, interact with the user interface or content available through the user interface, navigate the user interface, understand the user interface layout, explore the user interface, etc. A poorly designed user interface can frustrate the content experience of a user, cause a user to lose interest in a content experience and/or an associated content platform, frustrate the ability of a user to navigate or explore the user interface and its content, frustrate the ability of a user to learn or discover features and functionalities available through the user interface, discourage or deter a user from engaging with the user interface and/or associated content, etc.

For example, a user interface that is cumbersome, unorganized, confusing, unengaging, or visually unappealing may frustrate a user's experience when using the user interface, cause the user to lose interest in content or experiences available through the user interface, negatively impact the user's view or impression of an application or platform associated with the user interface, discourage or deter the user from using the user interface and an associated application or platform, impede the user's ability to find/discover content and features/functionalities available through the user interface, etc. By contrast, a user interface that is organized, engaging, user friendly, visually appealing, immersive, easy to navigate, and easy to understand can provide numerous advantages, such as drawing users to an application/platform (and associated content and experiences) associated with the user interface, increasing a userbase and user retention, evoking positive feelings from users towards the user interface and an associated application/platform, improving user experiences, etc. However, it can be very difficult to create a well-designed user interface that captures these (and other) advantages. The design of a user interface can be further complicated as the amount and type of content or experiences provided by the user interface increase.

Provided herein are system, apparatus, device, method (also referred to as a process) and/or computer program product embodiments, combinations and/or sub-combinations thereof (also referred to as “systems and techniques” hereinafter) for customized and immersive user interfaces and associated content, themes, features, and experiences. In some examples, the systems and techniques described herein can be used to generate customized user interfaces for accessing media content (e.g., playing media content, interacting with media content, engaging with media content, etc.), navigating media content and associated features (e.g., searching and finding content and features, discovering content and features, etc.), engaging in customized and/or immersive content experiences, etc. The user interfaces can be intelligently designed (e.g., customized, organized, etc.) and can be engaging, appealing, immersive, user friendly (e.g., easy to navigate, easy to understand, etc.) and configured to increase user interest, draw and retain users, increase or maximize user and content experiences, evoke positive feelings from users, improve user experiences, etc. The user interfaces can optionally implement customized or intelligently-selected user profiles, avatars, and/or associated content/experiences.

In some cases, a customized user interface can implement a theme, display selective/tailored content, a tailored look and feel, a user or group-specific configuration (e.g., a configuration tailored to or selected for a user or group), a device-specific configuration (e.g., a configuration tailored or selected for a device), a customized user avatar, a customized user/group profile, a customized experience(s), etc. In some examples, the user interface can be customized based on user preferences or characteristics, temporally relevant topics (e.g., events, people, content, announcements, contexts, environments, activities, preferences, etc., relevant to a current or specific event, trend, context, activity, interaction, condition, preference, user, group, device, setting, environment, etc.), featured content (e.g., highlighted or promoted content, recommended content, tailored content, preferred content, etc.), a theme, a performance goal, a design preference, a user history, a trend, a customization criteria, and/or any other factor.

For example, a user interface (and/or aspects thereof) can be customized based on a relevant event (e.g., a current or trending event) such as a competition (e.g., the Olympics, World Cup, World Series, Superbowl, a game show, etc.). The user interface can implement, present, promote, and/or highlight content selected based on the relevant event (e.g., the current or trending event), immersive and/or interactive experiences related to the event, a theme and/or visual appearance based on the event, attributes based on the event, and/or other customization details. The user interface can optionally invite users to interact with content or features related to the event, steer users to certain content or features, help the user explore or discover content and features, and even teach the user certain features or functionalities of the user interface.

To illustrate, on the day of a football championship that has a broad user interest in some regions and can represent a trending event, the user interface presented to users in such regions (and/or users identified as having a potential interest in football and the football championship) or all users can include a football theme or a theme based on the football championship. The theme can include or implement attributes related to football and/or the football championship, such as artwork, images, videos, animations, content, experiences, audio, visual attributes (e.g., visual aesthetics, patterns, etc.), interface elements, customized features (e.g., avatars or profile images, profiles, etc.), and/or design characteristics depicting and/or related to football, the football championship, a football team(s) such as a team or both teams in the football championship, a half-time show of the football championship, a trending advertisement from the football championship, a player(s) in the football championship (or any football player), a stadium where the football championship is played, a trophy given to the winner of the football championship, a football or championship history or statistic, a user-preferred football team or player, etc. When certain (or all) users access the user interface, the users can correlate the user interface with the football or the football championship and interact or engage with content related to football and/or the football championship. The user interface can remind users or convey to users that the football championship is a current/trending event and remind users that the football championship is played today (or within a timeframe), highlight or promote content and/or experiences (e.g., activities, interactions, features, etc.) relevant to football and/or the football championship, and even evoke certain feelings on users based on or associated with football or the football championship.

As another example, on a particular holiday, the user interface presented to users (and/or certain users) can include, depict, and/or incorporate features selected based on the holiday, attributes correlated with the holiday, promoted or highlighted content related to the holiday, experiences (e.g., activities, interactions, features, behaviors, etc.) associated with the holiday, a look and feel customized based on the holiday, avatars or profile images customized based on the holiday, profiles customized based on the holiday, etc. The user interface can additionally or alternatively include and/or depict any details or content customized for a specific user or group.

To illustrate, referring back to the example of the user interface presented on the day of the football championship, if a user is a fan of a particular football team participating in the football championship, the user interface can include a theme based on that particular football team, such as the colors of the football team, any symbols or logos associated with that football team, a mascot of the football team, a city and/or state associated with the football team, a player(s) associated with the football team, etc. The user interface can be customized for the user and selected theme based on a user preference(s) of the user (e.g., the user's preference for the football team), information from a user profile, a user input (e.g., an input providing relevant information, an input request or selection, etc.), a user history (e.g., a content consumption history, a user preference history, a user purchasing history, etc.), social media information associated with the user (e.g., social media posts or content, a social media profile, social media connections, social media likes or interactions, etc.), user photos and/or a photo library of the user made available by the user, previous user interactions and/or activity, customization weights or criteria, and/or any other information.

In some cases, the user interface can provide, highlight, promote, prioritize, and/or recommend information, features, and/or experiences (e.g., content, interactions, destinations, products, etc.) associated with the football team. For example, the user interface can display information about the football team, such as team statistics or a team history, promote merchandise associated with the football team, highlight videos associated with the football team (e.g., previous games, game highlights, team reels, player highlights, historical highlights, etc.), offer an immersive experience or interactive activity associated with the football team (e.g., an offer to bet on the football team, an activity to create a preferred starting lineup, an activity to predict or select a particular play during the game, a video game including that football team, an interaction with other users involving the football team, a prediction of player or game statistics, etc.), customize an avatar or profile image of the user to depict any details associated with the football team, customize a user profile based on the football team (e.g., to provide, recommend, or promote content, features, and/or experiences associated with football and/or the football team, etc.), etc.

A theme implemented by a user interface can optionally continue or evolve across user interface spaces (e.g., pages, screens, windows, frames, regions, instances, etc.), user sessions, days of use, etc. For example, a theme implemented by a user interface on a particular day can continue user interface screens, components, pages, sections, experiences, and/or spaces on that day (or a timespan including multiple days) and/or session (or multiple sessions), and can optionally evolve during the user session, experience, or interaction with the user interface. To illustrate, if the user interface implements a theme related to a trending event in social media, the user interface may first incorporate the theme in a particular page (e.g., home page, landing or welcome page, etc.). If the user navigates to a different page or a different section of the user interface, the different page or section of the user interface can also incorporate the theme (and/or aspects thereof). As the user interacts with the user interface, the user interface can persist the theme (and/or aspects thereof) and can optionally evolve the theme by adjusting or updating the theme at certain points.

If the user wants the user interface to stop implementing the theme or switch to a different theme, the user can optionally request so or can trigger the user interface to stop implementing the theme or implement a different theme. When the user accesses the user interface on a different day, the user interface may continue with the same theme or may implement another theme. For example, if another event is temporally relevant to that day, has a higher relevance score, or is otherwise selected based on certain data (e.g., rules, inputs, weights, criteria, preferences, promotions, etc.), the user interface can incorporate a different theme on that day, such as a theme that is based on an event that has a higher relevance score or is more temporally on that day. This way, the user interface can adapt to user interests/preferences, temporal events, changes, content experiences, locations, information, devices, etc.

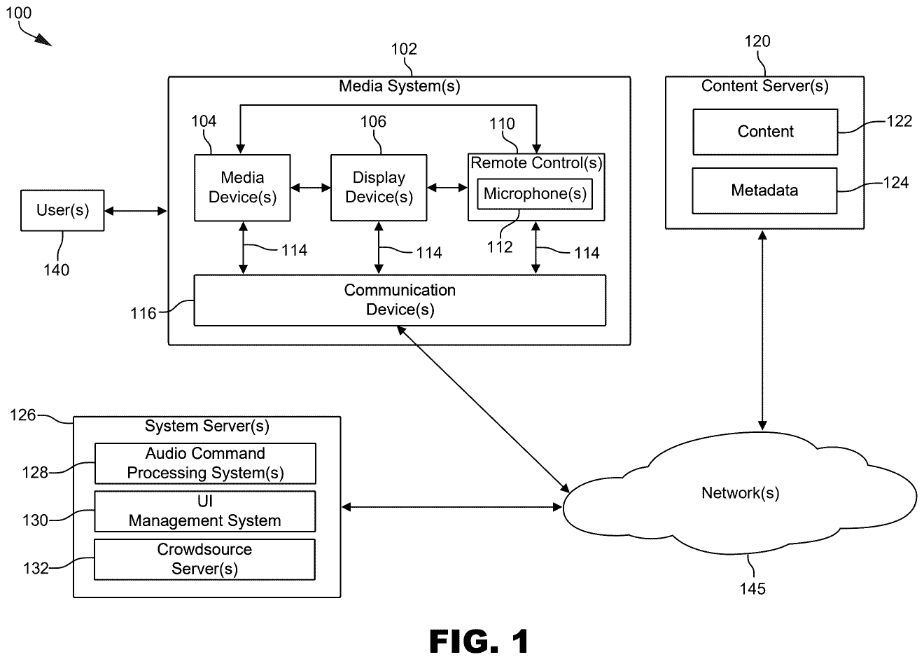

Embodiments and aspects of the disclosure may be part of and/or implemented using multimedia environment 100 shown in FIG. 1. However, multimedia environment 100 is provided for illustrative purposes and is not limiting. Examples and embodiments of this disclosure may be part of and/or implemented using environments that are different from and/or in addition to multimedia environment 100, as will be appreciated by one of skill in the art based on the teachings contained herein. An example of multimedia environment 100 shall now be described.

### Example Multimedia Environment

FIG. 1 is a block diagram illustrating an example multimedia environment 100. In a non-limiting example, multimedia environment 100 may be directed to media content. However, this disclosure is applicable to any type of content (instead of or in addition to media content), as well as any mechanism, means, protocol, method and/or process for distributing content (e.g., media content, etc.), interacting with media content, and/or interacting with media devices. Multimedia environment 100 may include media system(s) 102.

Media system(s) 102 can include one or more media systems, and each media system can include and/or represent a scene or environment and/or one or more devices in a scene or environment. The scene or environment can include, for example and without limitation, a family room, a kitchen, a backyard, a home theater, a school classroom, a library, a car, a boat, a bus, a plane, a movie theater, a stadium, an auditorium, a park, a bar, a conference room, a home, an entertainment room, a restaurant, an office, or any other location or space where it is desired to receive and play media content, such as streaming content. A user(s) 140 may operate media system(s) 102 (and/or one or more devices associated with media system(s) 102) to select/access content (e.g., videos, images, audio, text, user interfaces, application content, etc.), consume content (e.g., watch/view content, play or replay content, interact with content, engage with content, play video game content, etc.), stream content, engage in content interactions or activities, etc. User(s) 140 can include or represent one or more users in multimedia environment 100. The content can include, for example and without limitation, visual content (e.g., movies, television shows and/or programs, images, graphics, visual animations, videos, etc.), audio content (e.g., music, speech or dialogue, sounds, noise, etc.), text content (e.g., subtitles, closed captions, superimposed text or supers, overlaid text, scene text, etc.), metadata, podcasts, application content (e.g., content depicted and/or available via an application, application pages, application menus, etc.), user interfaces and/or user interface content, etc.

Media system(s) 102 may include media device(s) 104, display device(s) 106, remote control(s) 110, communication device(s) 116, and any other device(s). Media device(s) 104 can be coupled to display device(s) 106 and/or can include a display device(s) used to display content. Media device(s) 104 can include one or more media devices, and each media device can be coupled to or include a display device (or multiple display devices). Terms such as “coupled,” “connected to,” “attached,” “linked,” “combined” and similar terms may refer to physical, electrical, magnetic, logical, direct, wired, wireless, etc., connections, unless otherwise specified herein. The one or more media devices can include, for example, one or more streaming devices, DVD or BLU-RAY devices, audio/video playback devices, cable boxes, gaming systems or consoles, televisions, head-mounted displays (HMDs), set-top boxes, video display devices, computers (e.g., laptops, desktops, tablets, etc.), mobile phones, smart wearable devices (e.g., smartwatches, smart glasses, etc.), screens, appliances, internet-of-things (IoT) devices, monitors, single-board computers (SBCs), system-on-chip (SoC) devices, projectors, extended reality (XR) devices (e.g., augmented reality (AR) devices, virtual reality (VR) devices, mixed reality (MR) devices, video-passthrough devices, etc.), and/or digital video recording devices, to name just a few non-limiting examples.

Media device(s) 104 (and/or each media device of media device(s) 104) can include and/or implement and/or be part of, integrated with, operatively coupled to, and/or connected to one or more display devices, such as display device(s) 106 and/or a separate display. Media device(s) 104 may be configured to communicate with network 145 via communication device(s) 116. Communication device(s) 116 may include a cable modem, a satellite television (TV) transceiver, a router, an access point, a network device, an antenna, a gateway, a network switch, a cellular communication device or interface, etc. For example, communication device(s) 116 can include a network device such as a router, switch, gateway, access point, modem, etc. Media device(s) 104 may communicate with communication device(s) 116 over a link. The link may include a wireless (e.g., WiFi, Bluetooth, cellular, etc.) and/or wired connection(s).

Network 145 can include a public, private, cloud, wired, and/or wireless network. For example, network 145 can include the Internet, an intranet, an extranet, a cellular network, a Bluetooth network, an infrared network, a wide area network (WAN), a backbone network, an internet service provider (ISP) network, a network segment, a local area network (LAN), a wireless LAN (e.g., a WIFI network, etc.), an on-premises network, a public and/or private cloud network, and/or any short range, long range, local, regional, global communications mechanism, means, approach, protocol and/or network, or combination(s) thereof.

Display device(s) 106 can include one or more display devices and each display device can include one or more displays, screens, monitors, televisions, projectors, HMDs, XR devices, heads-up devices, any other display and/or presentation devices, and/or the like. In some cases, display device(s) 106 can include one or more media devices and each media device can be coupled to or include a display (or multiple displays). In some examples, display device(s) 106 may include, represent, implement, and/or be part of and/or coupled to one or more monitors, televisions (TVs), displays, screens, computers (e.g., desktop computers, laptop computers, tablet computers, etc.), mobile phones (e.g., smartphones), smart wearable devices (e.g., smart glasses, HMDs, etc.), appliances, IoT devices, SBCs, SoCs, XR devices, set-top boxes, video game consoles, digital media players, home entertainment systems, video display devices, electronic ink (eInk) devices or displays, and/or projectors, to name a few non-limiting examples.

Remote control(s) 110 can include, implement, represent, or be part of any component, apparatus, and/or software for controlling media device(s) 104 and/or display device(s) 106, such as a remote control, an electronic device with remote control software and/or with or coupled to remote control hardware (e.g., a tablet computer, laptop computer, desktop computer, tablet computer, etc.), on-screen control, integrated control button, audio control, input device, peripheral device, touch screen, or any combination thereof. In some examples, remote control(s) 110 can communicate with media device(s) 104 and/or display device(s) 106 using any wireless and/or wired communication link, technology, and/or protocol such as, for example, cellular, Bluetooth, infrared, WIFI, WIFI direct, etc., or any combination thereof. For example, remote control(s) 110 can communicate with media device(s) 104 and/or display device(s) 106 via a wireless connection and/or wireless signals such as a Bluetooth connection and/or signal, a WIFI connection and/or signal, a WIFI direct connection and/or signal, a cellular connection and/or signal, an infrared connection and/or signal, any other wireless connection or signal, or any combination thereof. In some cases, remote control(s) 110 may optionally include a microphone(s) 112. Microphone(s) 112 can record audio such as speech commands, voice commands, dialogue, and/or utterances used to interact with, control, and/or transmit commands and/or data to media device(s) 104 and/or display device(s) 106. Microphone(s) 112 can optionally record other audio as well such as noise, sounds, music, etc. Microphone(s) 112 can include a hardware and/or software components/features (e.g., buttons, settings, functionalities, etc.) that user(s) 140 can use to activate the recording functionality of microphone(s) 112 to record audio.

Multimedia environment 100 may include content server(s) 120 (e.g., content provider(s), channel(s), source(s), platform(s), storage, system, etc.). Content server(s) 120 can include, implement, and/or represent one or more content servers, storage systems, content delivery services, distributed storage systems, content streaming and/or broadcasting systems, etc. Although only one server is shown in FIG. 1, in practice, content server(s) 120 may include any number of content servers. Content server(s) 120 may communicate with other devices via network 145. Content server(s) 120 may store content 122 and metadata 124. Content 122 may include any type of content and/or combination of content such as music, videos, movies, video games, television (TV) programs, multimedia content, TV shows, images, text, graphics, video games, applications, advertisements, programming content, public service content, channels, media, user interface data, user profiles, user avatars, templates, content items, files, targeted content, software, and/or any other content/data and/or objects in electronic form.

Metadata 124 can include data about content 122. For example, metadata 124 may include ancillary information indicating or related to a writer, director, producer, composer, artist, actor, summary, chapters, production, settings, history, year, trailers, alternate versions, related content, application, title, and/or any other information pertaining to content 122. Metadata 124 may also or alternatively include links to such information pertaining to content 122. Metadata 124 may also or alternatively include one or more content indexes, such as but not limited to a trick mode index.

Multimedia environment 100 may include system server(s) 126, which may support media device(s) 104 and/or display device(s) 106 from a remote location and/or network, such as a cloud network, a backend network, a datacenter, etc. The structural and functional aspects of system server(s) 126 may wholly or partially exist in the same or different system servers. In some examples, system server(s) 126 may include, host, operate, and/or implement audio command processing system(s) 128, user interface (UI) management system 130, and/or crowdsource server(s) 132. Audio command processing system(s) 128 can process audio data such as speech/voice inputs and/or commands, audio/speech in videos, etc. For example, remote control(s) 110 may include a microphone(s) 112 that can record audio from user(s) 140 (and/or other sources). In some examples, media device(s) 104 may be audio responsive, and the audio data may represent verbal commands from user(s) 140 to control media device(s) 104 and/or any other components in media system(s) 102, such as display device(s) 106.

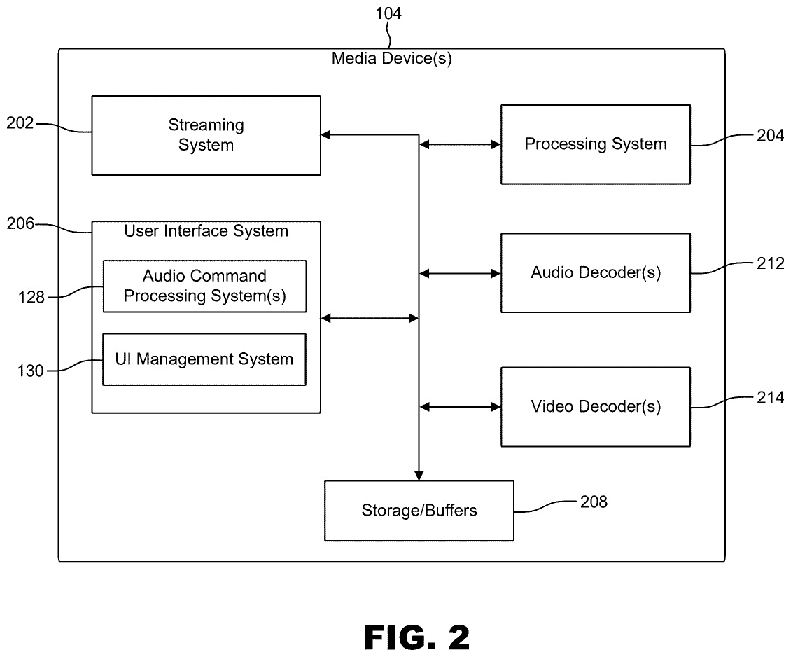

In some examples, the audio data recorded by microphone(s) 112 can be transferred to media device(s) 104, which can forward the audio data (with or without first processing the audio data) to audio command processing system(s) 128. Audio command processing system(s) 128 may process and analyze the audio data to recognize any verbal commands in the audio data. Audio command processing system(s) 128 may forward the verbal commands back to media device(s) 104 for processing. In some cases, the audio data may be alternatively or additionally processed and analyzed by a copy or version of audio command processing system(s) 128 in media device(s) 104 (see FIG. 2). Media device(s) 104 and system server(s) 126 may cooperate to pick any of the verbal commands for processing (e.g., verbal commands recognized by audio command processing system(s) 128 in system server(s) 126 and/or by a copy or version of audio command processing system(s) 128 in media device(s) 104). In some cases, audio command processing system(s) 128 can include, perform, or implement automatic speech recognition (ASR), natural language processing (NLP), natural language understanding (NLU), natural language generation (NLG), text-to-speech generation, etc.

UI management system 130 can select, configure, generate, deliver, and/or customize user interfaces and associated content, settings, behaviors, features, designs, themes, experiences, attributes, etc. The user interfaces can be rendered/displayed by media device(s) 104 and/or display device(s) 106. The user interface content can include any type of content, data, and/or metadata, such as content 122, metadata 124, etc. UI management system 130 can select content and/or metadata for presentation to user(s) 140 via media device(s) 104 and/or display device(s) 106. For example, UI management system 130 can generate, render, configure, manage, and/or provide a user interface(s) for display by media device(s) 104 and/or display device(s) 106.

UI management system 130 can additionally or alternatively generate, configure, and/or provide user interface data that media device(s) 104 and/or display device(s) 106 can use to render, display, generate, configure, and/or implement a user interface(s). The user interface(s) can include and/or can be used to access content, settings, experiences, controls, menus, metadata, user profiles and/or avatars, media, features, UI spaces, content services, etc. For example, UI management system 130 can provide and/or render a user interface(s) or interface data (e.g., used to render, display, generate, and/or configure a user interface) to media device(s) 104 and/or display device(s) 106 for presentation to user(s) 140. User(s) 140 can use the user interface(s) to access, navigate, view, control, engage with, and/or interact with content, content services, UI data, etc.

UI management system 130 can configure the user interface(s) and/or a content, behavior, setting, design, theme, artwork, experience, functionality, and/or feature of the user interface(s) and/or data thereof. The user interface(s) can include a dynamic, static, customized, and/or shared user interface (UI), content experience, UI theme, UI configuration, UI behavior, UI experience, etc. For example, UI management system 130 can configure, adjust, generate, select, and/or customize any content, pages, screens, windows, themes, appearances, designs, immersive experiences, user profiles, avatars, content, interface elements, interface attributes, visual effects, UI styles, UI settings, etc., of user interfaces presented to users.

UI management system 130 can configure, adjust, generate, select, and/or customize such content, pages, screens, windows, features, themes, appearances, experiences, interface attributes, interface settings, etc., based on one or more signals. The one or more signals can include profile data, user interactions, user history, event data (e.g., content release events, current events, promotion events, trending events, cultural events, user and/or device events, news events, competitions, games, content events, group events, social events, etc.), group profile data, activity data, purchase history, statistics, interactions, location information, preferences, inputs, social media signals (e.g., connections, posts, content, feedback, subscriptions, etc.), trends (e.g., social media trends, user ratings, consumption trends, activity trends, etc.), calendar data, temporal cues, sensor data, device data, context data, content or promotion campaigns, content consumption data, historical data, usage patterns, user data, promoted content, statistics, interactions, etc.

UI management system 130 can host, include, execute, represent, and/or be part of one or more software algorithms, neural networks and/or models (e.g., artificial intelligence (AI) and/or machine learning (ML) models, etc.), applications, interfaces (e.g., application programming interfaces (APIs), etc.), code, servers, application services, software containers, virtual machines, software engines, software logic, hardware and/or software resources, etc. For example, UI management system 130 can include an API used to obtain or retrieve data from content server(s) 120 and/or provide data to user devices. UI management system 130 can include software, such as an algorithm(s) and/or model(s) (e.g., an AI/ML model(s), etc.), configured to generate, customize, modify, update, render, manage, and/or configure user interfaces (and associated data, behaviors, experiences, settings, etc.), such as a user interface(s) of a content platform/application. The user interfaces can include, depict, or implement a theme, including related visual attributes, content, immersive experiences, profiles, profile-based experiences, user avatars (e.g., profile images), tailored experiences, features, etc. UI management system 130 can configure the user interfaces to provide theme-based, immersive content and experiences for users, such as interactive/immersive games, activities, animations, interactions, etc. ; theme-based content; etc. Users can interact with the user interfaces via media device(s) 104 and/or display device(s) 106.

In some cases, crowdsource server(s) 132 can turn closed captioning on and/or off during playback/streaming of content, such as a movie. For example, using information received from media device(s) 104 in media system(s) 102 (e.g., in thousands or millions of media systems), crowdsource server(s) 132 may identify similarities and overlaps between closed captioning requests issued by different users watching a movie. Based on such information, crowdsource server(s) 132 may determine that turning closed captioning on may enhance the users'viewing experience at particular portions of the movie (e.g., when the soundtrack of the movie is difficult to hear), and turning closed captioning off may enhance the users'viewing experience at other portions of the movie (for example, when displaying closed captioning obstructs important or relevant visual aspects of the movie). Accordingly, crowdsource server(s) 132 may automatically turn closed captioning on and/or off during playback/streaming of content.

In some cases, audio command processing system(s) 128, UI management system 130, and/or crowdsource server(s) 132 can be part of, hosted at, and/or implemented by a same server (or set of servers) from system server(s) 126 or different/separate servers from system server(s) 126. In other cases, UI management system 130 can be part of, hosted at, and/or implemented by a server (or set of servers) that is (or are) separate from a server(s) that includes, implements, and/or hosts audio command processing system(s) 128 and/or crowdsource server(s) 132. In other cases, audio command processing system(s) 128, UI management system 130, and/or crowdsource server(s) 132 can be distributed across multiple and/or different servers.

In some cases, media device(s) 104 can include, implement, and/or host a copy or version of audio command processing system(s) 128 and/or UI management system 130 as shown in FIG. 2. Moreover, audio command processing system(s) 128, UI management system 130, and crowdsource server(s) 132 can each include, implement, be part of, and/or host one or more servers, computers, models and/or neural networks, models (e.g., AI/ML models, statistical models, etc.), algorithms, applications, software engines or modules, code/logic, software components, processors and/or processing circuitry (e.g., central processing units (CPUs), compute resources, application services, software containers, virtual machines, microservices, digital signal processors (DSPs), graphics processing units (GPUs), image signal processors (ISPs), processor cores, system-on-chip (SOC) devices, application-specific integrated circuits (ASICs), field-programmable gate arrays (FPGAs), integrated circuits, etc.), software and/or hardware elements, software platforms, and/or any hardware and/or software components.

FIG. 2 illustrates a block diagram of an example of media device(s) 104. For illustration and explanation purposes, in FIG. 2, media device(s) 104 represents a single media device. However, media device(s) 104 can include multiple media devices. Media device(s) 104 in FIG. 2 may include a streaming system 202, processing system 204, storage/buffers 208, user interface system 206, audio decoder(s) 212, and video decoder(s) 214. User interface system 206 may optionally include a copy or version of audio command processing system(s) 128 to perform some or all of the operations, tasks, functions, and/or actions of audio command processing system(s) 128. Additionally or alternatively, user interface system 206 may optionally include a copy or version of UI management system 130 to perform some or all of the operations, tasks, functions, and/or actions of UI management system 130.

Media device(s) 104 may optionally include a copy or version of audio command processing system(s) 128 and/or UI management system 130 to allow media device(s) 104 to respectively perform any of the tasks, operations, functions, actions, etc., described herein with respect to audio command processing system(s) 128 and/or UI management system 130 (e.g., in addition to or instead of any of such tasks, operations, functions, etc. (or portions thereof), performed by audio command processing system(s) 128 and/or UI management system 130 in/from system server(s) 126 shown in FIG. 1).

In some examples, audio command processing system(s) 128 and/or UI management system 130 can be optionally included in, implemented by, and/or part of the user interface system 206. Alternatively, audio command processing system(s) 128 and/or UI management system 130 can be optionally included in, implemented by, hosted at, and/or part of media device(s) 104, such as processing system 204, or represent one or more separate components.

In some cases, audio command processing system(s) 128 optionally included in media device(s) 104 can be the same as audio command processing system(s) 128 in/from system server(s) 126 in multimedia environment 100 shown in FIG. 1. In other cases, audio command processing system(s) 128 optionally included in media device(s) 104 in FIG. 2 can be a version of audio command processing system(s) 128 in/from system server(s) 126 in multimedia environment 100 shown in FIG. 1, such as a local version, a client version, a standalone version, and/or a lighter version (e.g., a smaller version having a smaller data size; a version with less components, features, functions, modules, libraries, and/or capabilities; a version with less code or a smaller package of code; etc.) of audio command processing system(s) 128 in/from system server(s) 126 in FIG. 1.

In some cases, UI management system 130 optionally included in media device(s) 104 in FIG. 2 can be the same as UI management system 130 in/from system server(s) 126 in multimedia environment 100 shown in FIG. 1. In other cases, UI management system 130 optionally included in media device(s) 104 in FIG. 2 can be a version of UI management system 130 in/from system server(s) 126 in multimedia environment 100 shown in FIG. 1, such as a local version, a client version, a standalone version, and/or a lighter version (e.g., a smaller version having a smaller data size; a version with less components, features, functions, modules, libraries, and/or capabilities; a version with less code or a smaller package of code; etc.) of UI management system 130 in/from system server(s) 126 in FIG. 1.

As shown in FIG. 2, media device(s) 104 may also include one or more audio decoders 212 and one or more video decoders 214. Each audio decoder 212 may be configured to decode audio of one or more audio formats, such as but not limited to AAC, HE-AAC, AC3 (Dolby Digital), EAC3 (Dolby Digital Plus), WMA, WAV, PCM, MP3, OGG GSM, FLAC, AU, AIFF, and/or VOX, to name just some examples. Media device(s) 104 can implement other applicable decoders, such as a closed caption decoder.

Similarly, each video decoder 214 may be configured to decode video of one or more video formats, such as but not limited to MP4 (mp4, m4a, m4v, f4v, f4a, m4b, m4r, f4b, mov), 3GP (3gp, 3gp2, 3g2, 3gpp, 3gpp2), OGG (ogg, oga, ogv, ogx), WMV (wmv, wma, asf), WEBM, FLV, AVI, QuickTime, HDV, MXF (OP1a, OP-Atom), MPEG-TS, MPEG-2 PS, MPEG-2 TS, WAV, Broadcast WAV, LXF, GXF, and/or VOB, to name just some examples. Each video decoder 214 may include one or more video codecs, such as but not limited to, H.263, H.264, H.265, VVC (also referred to as H.266), AVI, HEV, MPEG1, MPEG2, MPEG-TS, MPEG-4, Theora, 3GP, DV, DVCPRO, DVCPRO, DVCProHD, IMX, XDCAM HD, XDCAM HD422, and/or XDCAM EX, to name some examples.

### Customized User Interfaces And Content Experiences

Referring again to FIGS. 1 and 2, UI management system 130 (e.g., at system server(s) 126 and/or media device(s) 106) can generate, render, and/or provide theme-based, customized user interfaces and immersive experiences. The user interfaces can be used to access content, navigate content, search/find content, play and/or interact with content, engage in content experiences, participate in content activities or immersive interactions, access and/or adjust associated settings, access and/or manage user data such as profiles/avatars, etc. UI management system 130 can design, generate, configure, and/or customize user interfaces and immersive experiences based on themes and other data. The user interfaces can be organized, engaging, visually appealing, immersive, user friendly, and customized to increase user interest and retention, draw new users, increase and/or maximize user retention, improve user experiences, evoke positive feelings from users, and improve an overall performance.

UI management system 130 can customize, configure, and/or adjust any aspect of a user interface. For example, UI management system 130 can customize a user interface to implement a theme(s), display specific content (and/or categories of content), organize content in a customized way, customize an appearance, implement a design and/or configuration (e.g., a configuration and/or design selected for and/or tailored to a user(s), device(s), context, topic, event, etc.), etc. In some examples, UI management system 130 can customize a design (e.g., structure, template, organization, appearance, style, setting, behavior, etc.) of the user interface according to a theme and/or associated preferences and/or characteristics, temporally relevant features (e.g., based on a current event, context, activity, interaction, condition, topic, etc.), trending topics, featured content (e.g., highlighted content, promoted content, relevant content, preferred content, etc.), performance goals and/or characteristics, design preferences, and/or any other factors.

UI management system 130 can customize a theme of the user interface based on a topic. For example, UI management system 130 can configure a theme for the user interface based on a current or upcoming competition, a game, a show, a reality TV or show competition, an awards ceremony/competition, a trending event, etc. The user interface can present, promote, and/or highlight content related to a theme and/or topic, provide immersive experiences, incorporate visual appearances and/or attributes, invite users to interact with certain content and/or features, provide animations, provide access to content and/or features, etc. To illustrate, if UI management system 130 determines that a trending or anticipated movie is being released on a particular day, UI management system 130 can customize the user interface users (or some users) on that day (or an associated timeframe) based on the movie. The user interface can include a theme related to the movie. The theme can promote merchandise and/or content related to the movie, highlight/promote and/or prioritize the movie and/or related content, offer options to engage in an immersive experience related to the movie, customize a user avatar based on the movie, customize a user/group profile based on the movie, convey aspects of the movie, etc.

For example, the theme can include attributes related to the movie (e.g., characters, imagery, visual effects, animations, visual content, colors and/or patterns, logos, thumbnails, symbols, backgrounds, etc.), content related to the movie (e.g., the movie, related movies, movies from a same genre or category, movies from a same actor or producer, etc.), theme-based content associated with the movie (e.g., images, videos, thumbnails, text, audio, etc.), interface elements based on the movie, design characteristics based on the movie, features related to the movie (e.g., related to a content of the movie, a character(s) of the movie, a plot of the movie, a landmark in the movie, a scene in the movie, an activity in the movie, a condition in the movie, an object in the movie, a context of the movie, etc.), hidden messages associated with the movie, artwork based on the movie, a background based on the movie, animations based on the movie, avatars customized based on the movie, and/or any other settings/content associated with the movie. When users access the user interface, the users can correlate the user interface (or theme) with the movie, access the movie or content promoted/recommended based on the movie, interact with content from/related to the movie, engage in an immersive experience generated based on the movie, etc. The user interface can convey that the movie is a current/trending event and/or was or is being released, highlight or provide content and/or activities/interactions relevant to the movie, promote merchandise associated with the movie, invoke feelings or a mood based on the movie, etc.

If a topic is trending (e.g., in social media, the news, current events, etc.) or promoted by an application/platform associated with the user interface, UI management system 130 can customize the user interface to incorporate content and/or features associated with that topic, tailor a theme of the user interface based on that topic, include attributes associated with that topic, promote or highlight content associated with that topic, provide an immersive experience(s) associated with that topic, customize an appearance of the user interface based on that topic, etc. To illustrate, if the topic is basketball, UI management system 130 can customize the user interface to implement a basketball theme. The user interface can include basketball content, basketball artwork, basketball attributes, basketball-related content, basketball-related promotions and/or merchandise, basketball information, basketball-related immersive experiences, basketball imagery, basketball colors, links to basketball events and/or content, basketball-themed interface elements, etc. The user interface can optionally prioritize and/or suggest content related to basketball (e.g., basketball games, media/TV channels, applications, movies, social media content or posts, documentaries, videos, etc.), provide access to basketball events or activities (e.g., betting options, game events, etc.), provide basketball-themed avatars, etc.

The user interface can incorporate a theme and/or features customized for a user. For example, referring back to the user interface with a basketball theme, if a user is a fan of a basketball team, the user interface can include a theme based on that team, such as the colors of the team, any symbols or logos of the team, a team mascot, a city and/or state of the team, a player(s) in the team, a team jersey/uniform, etc. UI management system 130 can determine that the user likes that team based on information from a user profile, a user input, a user history, user preferences, social media data (e.g., posts, likes, subscriptions, a social media profile, etc.) of the user, user photos (e.g., made available by the user), user interactions and/or activity, content (e.g., channels, shows, videos, etc.) and/or content categories (e.g., sports, basketball, etc.) added to a favorites list or designated as favorites by the user, a user purchase history, user characteristics, content subscriptions, and/or any other source of user information.

In the example of the basketball team preference/theme, UI management system 130 can optionally configure the user interface to highlight, promote, prioritize, and/or recommend information, content, interactions, and/or any features associated with the basketball team. For example, UI management system 130 can configure the user interface to display information about the basketball team, such as team statistics or a team history, promote content and/or merchandise associated with the basketball team, highlight videos associated with the basketball team (e.g., previous games, game or player highlights, team reels, etc.), offer an interactive experience associated with the basketball team (e.g., an offer to bet on the basketball team, an activity to create a starting lineup, an activity to predict or select a play during a game, a video game including the basketball team, an interaction with other users involving the basketball team, a prediction of player/team statistics, etc.), etc.

UI management system 130 can configure a user interface to continue to implement a theme across user sessions, interfaces, pages, spaces, interface experiences, etc. For example, UI management system 130 can configure a user interface to implement a theme on a particular day and continue implementing the theme on that day (and/or one or more subsequent days) across user interface screens, views, pages, sections, sessions, spaces, content, experiences, etc. The theme can be maintained (or variations of the theme) until a user session (or multiple user sessions) ends, a timeframe ends, another theme is selected/implemented, a different theme is requested, a trigger is detected, a condition is satisfied, a threshold period is met, etc. To illustrate, UI management system 130 can configure a user interface to implement a theme related to a trending game show. If user(s) 140 navigates to a different user interface destination (e.g., a different page, section, view, location, window, screen, experience, etc.), the different user interface destination can incorporate the theme (e.g., can retain/maintain the theme for continuity), aspects of the theme, or an updated version of the theme. As the user interacts with different destinations (e.g., views, screens, pages, experiences, locations, sections, windows, etc.) of the user interface, the user interface can persist the theme (and/or aspects thereof) across the different destinations or update the theme to depict a continuous and/or progressively changing theme. If the user wants the user interface to stop implementing the theme or switch to a different theme, the user can optionally request (e.g., via an input) that the user interface switches to the different theme or stop implementing the theme. When the user accesses the user interface on a different day, if a different theme is selected on that day, the user interface can incorporate the different theme. This way, the user interface can adapt to different themes, preferences, constraints, conditions, etc.

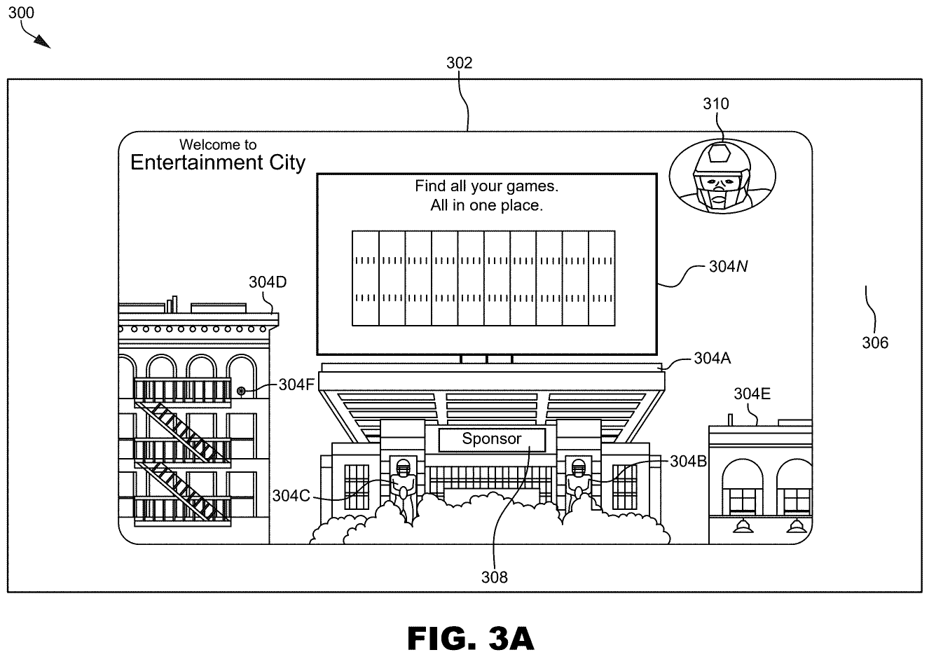

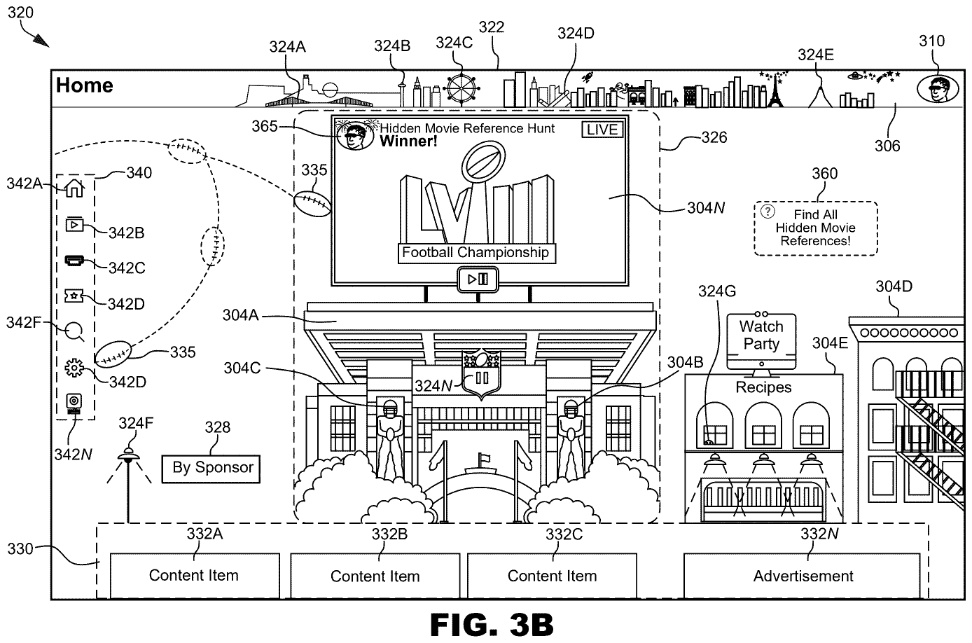

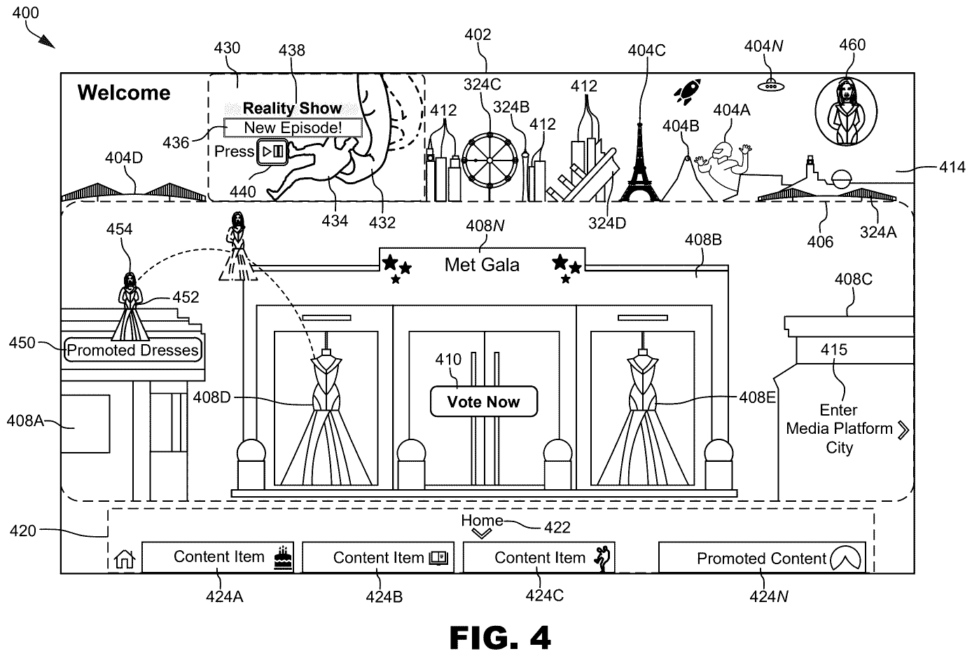

FIG. 3A illustrates an example of a user interface (UI) 300 customized based on a theme. UI 300 can be used to access, navigate (e.g., search, find, browse, etc.), consume (e.g., watch/view, play, stream, display, etc.), interact with, and manage content, access and engage in content experiences, etc. UI 300 can display and/or include content (e.g., media content, interactive content, interface content, etc.) and a theme selected for UI 300. UI 300 can also include a backdrop 306, which includes or represents a background, wallpaper, page with artwork, screensaver, etc. The backdrop 306 may or may not be animated (and/or include animated content). The backdrop 306 can be theme-based (e.g., can implement a theme and/or features selected or configured based on a theme).

UI 300 can display, include, and/or represent a page, window, screen, section, area, library, platform, application, portal, and/or interface that includes and/or displays content, features, activities, interface elements, visual elements, etc. UI 300 can be used to access and/or navigate content (e.g., media content, interactive/immersive content, static content, dynamic content, etc.), content experiences/activities (e.g., animations, games, immersive experiences, exploration scenes, etc.), etc. The content can include, for example, one or more movies, TV shows, podcasts, videos, broadcasts, live content (e.g., live TV, livestreams, live video feeds, etc.), channels, audio content, media applications, artwork, content libraries and/or catalogs, video games, interactive and/or dynamic content, static content, suggested content, application content, animated content, UI features, streaming content, image content, and/or any other content/features.

In some cases, UI 300 can be part of, implemented by, executed by, used to access, and/or associated with a media platform. The media platform can include a media application/platform, a streaming platform/application, a media player application, a media entertainment system platform/application, a home theater application, a set-top box platform/application, a content service application/platform, a media library, a media portal, a video game application/platform, a TV platform, a digital receiver application, an online media service platform, a digital player application, a TV software or framework, a media content suite, an electronic programming guide (EPG) platform/portal, a multimedia interface, etc. Moreover, UI 300 and/or backdrop 306 can implement a theme(s). For example, UI 300 includes an interface section 302 that implements a city theme depicting a city theme or cityscape. The theme(s) can be selected, generated, customized, and/or configured based on topic(s) selected based on one or more signals.

The one or more signals can include a user preference, an event, a context, a user and/or group characteristic, group data, a trend, social media data, content statistics, historical data (e.g., content consumption data, historical input data, historical interactions, etc.), a pattern (e.g., content pattern, usage pattern, etc.), promotional data (e.g., promotional preferences, campaigns, priorities and/or rankings, content, etc.), sessions, temporal information, activity, device characteristics, etc.

The theme(s) can include visual elements 304A-N (collectively referred to as “visual elements 304” hereinafter) and backdrop 306. The visual elements 304 and/or backdrop 306 can be selected, customized, generated, and/or configured based on the theme(s). For example, the visual elements 304 and/or backdrop 306 can be related to (e.g., having a threshold relevance to) the theme(s) and/or designed to convey the theme(s) and/or aspects of thereof. To illustrate, the visual elements 304 and/or backdrop 306 can include, depict, and/or represent content and/or a content experience(s) associated with the theme(s), such as artwork (e.g., imagery, visualizations, representations, etc.), a design, a color(s), a pattern(s), an object(s), a video(s), a character(s), imagery, an interface element(s), a content item(s), a UI behavior(s), a tile(s), a design element(s), an animation(s), a game(s), an activity, and/or any other feature associated with the theme(s).

UI 300 and backdrop 306 include a city theme. UI 300 also includes a sports theme, which in FIG. 3 is a football theme. The city and football themes are depicted or conveyed through visual elements 304 (and optionally through backdrop 306). For example, the visual elements 304 can include artwork, text, objects, interface elements, content experiences, animations, and/or visual elements (e.g., objects, buildings, imagery, characters, structures, landmarks/landscapes, designs, views, etc.) depicting city, a city environment, a portion and/or view of a city, football imagery, football players or characters, football buildings/structures (e.g., a stadium, a field, etc.), football objects, football symbols, football teams, football information, football team colors, etc. In some examples, the visual elements 304 can convey the theme(s) (e.g., the city and football themes). The visual elements 304 can also convey an associated mood, scene and/or atmosphere (e.g., a city and/or football scene and/or atmosphere).

To illustrate, visual element 304A depicts a football stadium, visual elements 304B-C depict football players (e.g., images of real football players, fake or computer-generated football players, football player avatars, football player icons, football player characters, football player representations, etc.), visual elements 304D-E depict city buildings, and visual element 304N depicts a display (e.g., television, projection, screen, billboard, display surface, etc.) depicting football-related content, such as a football field, image, video, game, promotion, trailer, thumbnail, artwork, interactive content, etc.

UI 300 and/or backdrop 306 can optionally include any promotional items, such as promotional content, merchandise, channel, etc. For example, in FIG. 3A, UI 300 includes a promotional content item 308 identifying a sponsor and/or content associated with a sponsor (e.g., a logo, sign, advertisement, trademark, etc.), such as a sponsor of the backdrop 306, a sponsor of a content of any of the visual elements 304, a sponsor of the display depicted by visual element 304N, a content of UI 300, and/or content accessible via UI 300. In some cases, the promotional content item 308 can include interactive content, such as a button or link to a content, product, or destination; an interactive element that user(s) 140 can use to access an item associated with a sponsor (e.g., a page, merchandise, product or service, information, activity, game, etc.); a content experience sponsored by the sponsor; content associated with the sponsor; etc. In some cases, UI 300 and/or backdrop 306 can include hidden messages (also referred to as “Easter eggs” or “hidden references” herein), such as references from or clues about a content item (e.g., movie, TV show, video game, application, channel, etc.) and/or a feature of the content item (e.g., an activity, an object, a character, a building, an animal, an animation, a scene, etc.). In some cases, the hidden messages can include content (e.g., artwork, images, animations, icons, visual elements, etc.) depicting a message or reference/clue associated with a content item.

For example, in FIG. 3A, the visual element 304D includes a city building from a movie. Thus, the visual element 304D is a reference to the city building from that movie. A window of the city building (visual element 304D) includes a visual element 304F that depicts a graphic representing a reference to another movie. Some users may recognize the city building depicted by the visual element 304D as a city building from the corresponding movie, and the graphic depicted by the visual element 304F in the window of the city building as a graphic (e.g., object, character, etc.) from the other movie. Thus, the visual elements 304D and 304F represent hidden messages (e.g., clues) or references to the movies associated with the city building and the graphic.

Similarly, the visual element 304E depicts a barbershop from a movie, which some users may recognize as the barbershop from that movie. Accordingly, the visual element 304E represents a hidden message (e.g., hidden clue) or reference to the barbershop from that movie.

The visual element 304A depicts a football stadium. In some cases, the football stadium can represent a reference to a football stadium from a particular content item (e.g., movie, TV show, game, video game, image, animation, etc.), which some users may recognize as the football stadium from that particular content item. The visual elements 304B-C can depict football players. The football players can be fictitious football players, real football players, or football players or characters from a content item (e.g., from a movie, show, video game, etc.). In some cases, the backdrop 306 can include interactive elements that user(s) 140 can use to interact with content. For example, the display depicted by visual element 304N can include an interactive image or video that user(s) 140 can select or click to initiate a football video, trailer, and/or interactive experience such as a football activity, game, challenge, etc.

Thus, UI 300 may enable user(s) 140 to interact with content or engage in immersive experiences provided by UI 300. For example, when the visual element 304N is selected/activated, visual element 304N can initiate a video that user(s) 140 can interact with or is part of an experience. To illustrate, the display depicted by visual element 304N can play a video. User(s) 140 can optionally engage with a content of the video. In some cases, user(s) 140 can also engage in an experience where user(s) 140 can look for a hidden message/clue in the video, such as a hidden reference to a movie or TV show. If user(s) 140 finds the hidden message/clue, user(s) 140 can optionally submit an input identifying the hidden message/clue or indicating that user(s) 140 found the hidden message/clue. In response to finding the hidden message/clue, user(s) 140 can optionally receive a benefit (e.g., a credit, discount, subscription or subscription reward, redeemable points, digital trophy, recognition, award, monetary benefit, score, add-on, rank, recognition within user interfaces displayed on other user devices, etc.) or UI 300 can provide additional content or modify the user experience associated with the video (e.g., show additional portions of the video, show an additional video, customize the video accordingly, overlay content such as a recognition over the video, add more clues in the video or increase the difficulty of clues, etc.).

In some examples, an interface element(s) in UI 300 and/or backdrop 306 can include a personalized element. For example, if UI 300 and/or backdrop 306 incorporates a football theme, the football theme can be personalized to include content from user(s) 140 (e.g., a video, a social media post, etc.), content representing or showing user(s) 140 (e.g., a visual representation or avatar), content of interest to user(s) 140 (e.g., content showing a team of user(s) 140), content showing user(s) 140 in an activity (e.g., playing football, etc.), etc. This way, UI 300 and/or backdrop 306 can incorporate a football theme that is further personalized for user(s) 140.

The football theme can be based on a topic (e.g., a football topic) selected based on one or more signals. For example, the topic can include a football topic selected based on a relevance, popularity, and/or preference associated with the football topic (and thus the football theme) with respect to a temporal (e.g., a date, timeframe, day, time, season, etc.) cue (e.g., a relationship between a current or specific date and/or time a date of a football game, event, topic, content item, etc.), a context, an event, a trend, a user/group preference, a user location and/or characteristic, a location and/or device type of a device used to display UI 300, a user statistic and/or history (e.g., content consumption history, content preference history, etc.), a content pattern (e.g., associated with a user, group, content, etc.), calendar data, social media connections, platform data (e.g., a promotion, a weight associated with the football topic/theme, a rank or priority for the football topic/theme, an input from a user or device associated with the platform, business preferences, etc.), a rule or filter, a user input, and/or any other cue(s).

For example, assume that UI 300 is displayed on a day of a football championship. Given the scheduled football championship, UI management system 130 may determine that football is a temporally relevant or trending topic on that day. UI management system 130 can select a football theme based on the determination that football is a temporally relevant or trending topic on that day. UI management system 130 can configure UI 300 and/or backdrop 306 to implement the football theme when displayed on that day (and/or within a time period). UI 300 and/or the backdrop 306 can include one or more interface elements.

UI 300 and/or backdrop 306 can include user avatar 310 associated with user(s) 140. User avatar 310 can include a real or fake image or visual representation of user(s) 140. The user avatar 310 can be used as a profile image of user(s) 140. In some cases, the user avatar 310 can include or be based on an image of user(s) 140, such as a photograph of user(s) 140 uploaded by user(s) 140, selected by user(s) 140, and/or shared by user(s) 140. For example, the user avatar 310 can include an image of user(s) 140 customized by UI management system 130 (e.g., by an AI/ML model of UI management system 130 such as a generative AI model) or an image generated by UI management system 130 (e.g., via the AI/ML model) based on information associated with user(s) 140, such as a user image or description.

An avatar (e.g., user avatar, group avatar, etc.) can include any visual representation of a user or group (e.g., a real picture, an image generated by an AI/ML model(s) of UI management system 130 such as a synthetic image, an image generated by the AI/ML model(s) of UI management system 130 based on a real picture such as a real picture modified by the AI/ML model(s), a graphic representing or depicting the user or group such as a cartoonized image of the user or group, etc.). An avatar can include or be used as a profile image. For example, user avatar 310 can include or be used as a profile image of a user profile of user(s) 140. If a group of users has a group/shared profile, the group/shared profile can include an avatar of the group, which can include or be used as a profile image for the group/shared profile. The profile image can include any visual representation of a user or group.

UI management system 130 can customize the user avatar 310 (e.g., an image of user(s) 140 used for the user avatar 310 and/or generated as a representation of user(s) 140 for the user avatar 310) to implement or depict features, attributes, and/or visual content associated with a theme(s) of UI 300 and/or backdrop 306. For example, the user avatar 310 in FIG. 3A includes an image of user(s) 140 customized based on the football theme by depicting user avatar 310 with a football helmet and jersey.

User(s) 140 can navigate away from UI 300 to access another interface, page, window, screen, area, section, etc. In some cases, if user(s) 140 navigates to another destination (e.g., page, window, screen, area, or section), the other destination can implement a different theme(s) and/or retain any theme (or aspects thereof) of UI 300 to maintain a consistent theme and navigation experience across destinations/experiences. For example, if user(s) 140 navigates to the page in FIG. 3B, page 322 can incorporate attributes (e.g., artwork, colors, patterns, content, etc.) of the theme(s) associated with UI 300 (e.g., football theme and/or city theme). In some examples, if the page 322 (or any other section/page) incorporates a theme(s), the page 322 can optionally include, highlight, prioritize, recommend, and/or promote content related to the theme(s) such as, for example, videos, movies, shows, channels, games, advertisements, interactive content, games, and/or any other content associated with the theme(s).

FIG. 3B illustrates another example of a customized user interface (UI) 320 implementing a theme and associated content. In this example, UI 320 depicts and/or represents a page 322 of a media platform. The page 322 can be displayed when the media platform is loaded or after a user interface associated with the media platform, such as UI 300. For example, user(s) 140 can transition from UI 300 to UI 320. UI 320 and/or page 322 can implement a theme(s) and/or retain a theme(s) associated with UI 300.

For example, UI 320 can include visual attributes (e.g., artwork, color, color scheme, pattern, appearance, visual elements, content, interface elements, design, style, etc.), a topic (e.g., sports, football, a holiday, an event, etc.), a content experience (e.g., content interaction, animation, activity, game, etc.), a content item(s), a behavior, and/or any features associated with the football theme and/or city theme of UI 300. In some cases, a user interface theme, content experience, and/or appearance can vary or remain consistent (e.g., same or with a threshold similarity or relevance) across user interfaces, pages, spaces, sections, content areas, etc. For example, UI 320 and/or page 322 can include a football theme like UI 300. UI 320 and/or page 322 can maintain a similar or consistent appearance as UI 300.

UI 320 can include a backdrop 306. The backdrop 306 can include visual attributes such as a background, a color or color scheme, artwork, imagery, content, objects, interface elements, visual elements, etc. The visual attributes can optionally be based on one or more themes associated with UI 320, such as the football theme and/or the city theme. In FIG. 3B, UI 320 and page 322 include a football theme and a city theme. The football and city themes are depicted in the page 322 via visual elements 304A-E and optionally via additional visual elements 324A-N (collectively referred to as “visual elements 324” hereinafter). The visual elements 304A-E can include artwork, images, content, hidden references or clues, animations, content, interface elements, and/or visual attributes associated with the football and city themes. Some or all of the visual elements 324 can optionally include, depict, or convey aspects of the football theme and/or the city theme. In some cases, some or all of the visual elements 324 can include hidden messages, such as hidden references to one or more respective content items (e.g., movies, TV shows, etc.).

For example, the visual elements 324 can be part of the city theme and/or the football theme implemented by UI 320. The visual elements that are part of the city theme can include city elements such as city buildings, city bridges, city structures, a cityscape, a city landmark, etc. The visual elements that are part of the football theme can include football-related elements such as football artwork, images, content, colors, logos, etc. In some cases, any of the visual elements 324 can include a reference from a content item, such as a movie or TV show, and can represent a hidden message (or clue) associated with the content item. For example, visual element 324A depicts a bridge from a movie and is part of the city theme, visual element 324B depicts a building from a movie and is part of the city theme, visual element 324C depicts a Ferris wheel from a movie and is part of the city theme, visual element 324D depicts a sinking boat from a movie and is part of the city theme, visual element 324E depicts a volcano from a movie and is part of the city theme, visual element 324F depicts a lamp post from a movie and is part of the city theme, visual element 324G depicts a graphic from a movie and is part of the city theme, visual element 324N depicts a football logo and is part of the football theme, visual elements 304A-C depict football-related items and are part of the football theme, visual element 304D depicts a building from a movie, visual element 304E depicts a barbershop from a movie, and visual element 304N depicts a display with football content.

The visual elements (e.g., the bridge depicted by visual element 324A, the building depicted by visual element 324B, the Ferris wheel depicted by visual element 324C, the boat depicted by visual element 324D, the volcano depicted by visual element 324E, the lamp post depicted by visual element 324F, the graphic depicted by visual element 324G, the building depicted by visual element 304D, the barbershop depicted by visual element 304E) can include references to respective content items (e.g., movies, TV shows, etc.) that represent hidden messages (or clues) associated with the respective content items. The hidden messages can engage user(s) 140 and help provide a more immersive and/or delightful experience for user(s) 140. For example, user(s) 140 can try to find the hidden messages as a challenge or game, as part of an experience such as a scavenger hunt or any other activity, game, or experience. If hidden messages (or clues) in UI 320 are gamified and user(s) 140 finds the hidden messages (or a subset thereof) and identifies the sources/references of such hidden messages, user(s) 140 can provide an input via UI 320 identifying the hidden messages and obtain a benefit for accurately identifying the hidden messages (e.g., all hidden messages or a threshold number or percentage) such as an add-on to the user avatar 310, a content credit, free content, a subscription or upgrade, a promotion, a recognition of user(s) 140 with respect to other users, a recognition of user(s) 140 or inclusion of a representation of user(s) 140 in other user interfaces and/or themes (and/or within the city theme or the football theme depicted by UI 320), a discount or coupon, points, an option to select or suggest a theme or content included in user interfaces presented to other users, and/or any other reward or benefit.

For example, UI 320 can include a prompt 360 challenging user(s) 140 to find all the hidden movie references in UI 320. User(s) 140 can provide an input identifying any hidden references found by user(s) 140. In some cases, user(s) 140 can select the prompt 360 to input the hidden movie references found by user(s) 140. In some cases, a hidden message or clue (e.g., a hidden reference to a content item) can be placed somewhere within UI 320 to drive the user to explore that portion of UI 320 and/or any content or features associated with that portion of UI 320. For example, a hidden message or clue can be placed or hidden on, within, or adjacent to a content item that the media platform associated with UI 320 wants to promote to user(s) 140, a content section that the media platform wants to drive user(s) 140 to explore, a feature such as a control/setting or functionality that the media platform wants user(s) 140 to explore or learn, etc. This way, hidden messages can be used to steer user(s) 140 to or incentivize user(s) 140 to learn and/or explore UI content, features, functionalities, controls/settings, content sections, etc.

UI 320 can include an interactive section 326. In this example, the interactive section 326 includes a display depicted by interface element 304N that is used to show content related to a theme, such as content related to the football theme. The content can include, for example, a video, a video game, an image, a content experience, an XR experience, an activity, a link to content or a content experience, etc. In some cases, user(s) 140 can select the display depicted by the visual element 304N to watch football content. The display depicted by interface element 304N can optionally display other content. For example, the display depicted by interface element 304N can display a message notifying user(s) 140 that UI 320 includes a scavenger hunt with hidden movie references or identifying user(s) 140 as the winner of the scavenger hunt. In some cases, the display depicted by the interface element 304N can include a customized user avatar 365 depicting a representation of user(s) 140.

In some cases, the football theme can be carried over from UI 300 and/or backdrop 306 in FIG. 3A to the page 322. The football theme can be selected based on one or more signals, such as a temporal signal, a context, an event, a trend, preference, a location, a rule or filter, a user profile, a user history, content statistics, a promotion or campaign, a user input, a weight(s), a priority, a calendar, social media data, news data, etc. The page 322 can optionally include or depict any other content. For example, the page 322 can include an advertisement 328 associated with a product/service, brand, business, content, entity, sponsor, etc. The page 322 can include a content section 330 that includes content items 332A-N (collectively “332” hereinafter) such as movies, TV shows, channels, media applications, video games, videos, advertisements, podcasts, images, audio or music items, audiobooks, etc. In some examples, the content items 332 can include content items from a category, such as recommended content, recently-accessed content, content of a certain genre, content from a producer, content of a certain type, content of a certain popularity or rating, personalized associated, etc.

In some examples, the content section 330 can highlight, prioritize, promote, and/or include content related to a theme(s) associated with the page 322. For example, if the page 322 includes a football theme, the content section 330 can highlight, prioritize, and/or promote content related to football. The content section 330 can additionally or alternatively include other content, content categories, topics, libraries, etc. The page 322 can optionally include a menu 340. Menu 340 can include menu items 342A-N, such as a navigation menu, a menu for certain content and/or content categories, a settings menu, a search menu, a display menu, a tools menu, etc.

In some cases, UI 320 can display animated content used to increase a user appeal, steer user(s) 140 to certain items (e.g., content, spaces, features, tools, menus, etc.), incentivize user(s) 140 to explore certain items, help the user discover certain items, and/or teach user(s) 140 certain features. The animated content can relate to a theme of UI 320 or can be separate from a theme of UI 320. For example, in FIG. 3B, UI 320 depicts an animation of football 335. The animation of football 335 relates to the football theme. The animation of football 335 can show football 335 moving towards and landing or crashing into an item to promote the item, steer user(s) 140 to the item, drive user(s) 140 to explore or discover the item, or help user(s) 140 understand the item. For example, the football 335 can move across a portion of UI 320 and crash on the display depicted by visual element 304N to bring the attention of user(s) 140 to the content in the display or steer user(s) 140 to such content. As another example, the football 335 can move about a portion of UI 320 and land or crash on menu item 342D to steer user(s) 140 to the menu item 342D in order to promote the menu item 342D, drive user(s) 140 to explore the menu item 342D, or drive user(s) 140 to select the menu item 342D to teach user(s) 140 a feature(s) accessible through the menu item 342D or how to use or configure the menu item 342D. UI 320 can include user avatar 310, which can optionally be customized to depict visual attributes based on a theme, content, and/or experience associated with UI 320.

FIG. 4 illustrates another example user interface (UI) 400 configured with a theme. UI 400 can display a page 402 used to display content associated with a content platform. The content platform can be associated with or include a software application(s), infrastructure(s), and/or environment associated with one or more content services, TVs (and/or TV platforms, operating systems, applications, environments, etc.), media players, content servers, entertainment systems, streaming services, content providers, media channels, set-top boxes, online media services or platforms, media receivers, broadcast receivers, linear content services/channels, digital media devices, and/or any other content application, source, service, and/or software. User(s) 140 can use UI 400 to consume (e.g., view/watch, access, play/replay, stream, display/render, etc.), navigate, interact with, and/or engage with any content, content experience, and/or features associated with the page 402 and the content platform.

The page 402 can include a section 406 of content. The content can include static content, dynamic content, animated content, image/video content, theme-based content, video game content, interactive content, visual elements, interface elements, and/or any other content. The page 402 can include a background 414. The background 414 can include features such as one or more images, videos, colors, patterns, interface elements, items, visual effects, attributes, animations, content references, screensavers, etc. For example, background 414 can include a backdrop, image, artwork, color or color pattern, graphics, animation(s), pattern(s), logo(s), visual element(s), visual effect(s), content, and/or any other feature.

UI 400, page 402 and/or background 414 can include, depict, and/or be customized based on a theme(s) selected based on a topic(s). The topic(s) can be determined based on one or more signals. In some examples, UI 400 and/or background 414 can be configured based on a same or different theme(s) (e.g., can implement a same or different theme(s) or aspects thereof). In FIG. 4, the theme(s) includes a city theme and a Met Gala theme. The city theme is at least partly implemented and/or depicted via visual elements 412. The visual elements 412 can depict features from a city, such as city buildings and other city elements (e.g., other elements of one or more specific cities and/or one or more general cities), and thus convey and/or form part of the city theme. The theme(s) can optionally include or depict one or more other themes. The Met Gala theme includes a theme selected based on a topic associated with a content item (e.g., TV show, movie, video game, etc.) and/or event about, related to, and/or associated with a Met Gala, such as a Met Gala show. The Met Gala theme in this example is at least partly implemented via visual elements 408A-N (collectively “visual elements 408” hereinafter).

The visual elements 408 depict features of, from, and/or associated with the Met Gala topic and/or event, and thus form part of the Met Gala theme. The features of, from, and/or associated with the Met Gala topic and/or event depicted by the visual elements 408 can include, depict, and/or represent one or more content items, colors, interface elements, visualizations, visualization effects, background elements, animations, attributes, items, graphics, objects, characters, images, renderings, buildings, artwork, and/or details associated with the Met Gala topic/event/theme. Thus, the visual elements 408 can be part of and/or configured according to the Met Gala theme. For example, the visual elements 408A-N can depict, convey, and/or represent one or more buildings, dresses, symbols, messages, graphics, backgrounds, characters, attributes, colors, symbols, visualizations, visual effects, interface elements, promotions, content items, details, and/or artwork associated with the Met Gala topic, event, and/or TV show.

In FIG. 4, the visual elements 408A-C depict or represent buildings from or associated with a Met Gala TV show, visual elements 408D-E depict or represent dresses from or associated with the Met Gala TV show (e.g., Met Gala dresses and/or dresses selected for the Met Gala theme), and visual element 408N displays the message “Met Gala”, which is used to promote the Met Gala topic and/or TV show and/or indicate that the building depicted or represented by the visual element 408B is a Met Gala building, a building from or associated with the Met Gala TV show, or a building named Met Gala. Any of the buildings depicted or represented by the visual elements 408A-C can be used to depict one or more features associated with any of the themes of UI 400. For example, the building depicted by visual element 408A includes a content item 450 promoting dresses associated with the Met Gala topic and/or theme, such as Met Gala dresses promoted for sale, and the building depicted by visual element 408B includes the visual element 408N associated with the Met Gala theme, which displays the “Met Gala” message, and an interface element 410 associated with the Met Gala theme. The interface element 410 can include a visual element, static element, interactive element, dynamic element, theme-based element, navigation element, input element, object, link, and/or any other element associated with the Met Gala theme.

In FIG. 4, the interface element 410 includes an input or interactive element that user(s) 140 can select or activate to submit a vote associated with the Met Gala theme, such as a vote for a content item, character, dress, object, participant, TV show, TV episode, personality, movie, feature, promotion, activity, scene, and/or item associated with the Met Gala theme. For example, user(s) 140 can select the interface element 410 to vote on clothing (e.g., a dress, an outfit, etc.), a participant, a character, an object, an activity (e.g., a challenge), a participant question, a participant challenge, or an episode of a Met Gala TV show associated with the Met Gala theme (and/or any other associated content).

User(s) 140 can select the interface element 410 (and/or another interface element on UI 400) to access, load/initiate, play, or interact with content and/or a content experience associated with the Met Gala theme. For example, the interface element 410 can include an interactive/selectable element (e.g., a button, link, anchor, control, etc.) that user(s) 140 can use to (e.g., via an input selecting or activating the interface element 410) to play or stream a content item associated with the Met Gala theme (e.g., a Met Gala content item such as a Met Gala movie, TV show, video game, etc.), purchase a product (e.g., a dress, ticket, subscription, content, object, etc.) associated with the Met Gala theme (e.g., a Met Gala product), access Met Gala content, access information about a Met Gala event or content (e.g., Met Gala products, episodes, participants, statistics, history, etc.), access an activity or interaction related to the Met Gala theme (e.g., a bet, game, content experience, etc.), display a visual rendering associated with the Met Gala theme, perform a transaction associated with the Met Gala theme, etc.

In some cases, any of the buildings depicted or represented by the visual elements 408A-C can additionally or alternatively include, promote, initiate, trigger, and/or convey other content, features, and/or themes. For example, the building depicted or represented by the visual element 408C can include a navigation element 415. User(s) 140 can use the navigation element 415 (e.g., by selecting or activating the navigation element 415) to navigate to another destination, which may or may not include or relate to a theme(s) of UI 400, such as another interface, space, scene, experience, screen, location, content, etc. In the example shown in FIG. 4, when the navigation element 415 is selected or activated, UI 400 can transition to a destination that includes, represents, mimics, mirrors, depicts, and/or conveys a city theme (e.g., the city theme of UI 400, a different city theme, a version of the city theme of UI 400 such as a modified or updated version, and/or a similar city theme). The destination can include another interface, space, scene, experience, screen, page, and/or rendering, such as a page depicting or representing a content city associated with a content platform (e.g., a content platform associated with UI 400).

As previously noted, the Met Gala theme of UI 400 can be determined and/or selected based on a Met Gala topic. In some examples, the Met Gala theme of UI 400 can be selected or implemented based on a determination that the Met Gala topic is a relevant topic (e.g., temporally relevant, contextually relevant, relevant to user(s) 140, relevant to an event, relevant to preference of user(s) 140 (or a preference of a user group, a business, a sponsor, or a content platform associated with UI 400), relevant to a content release date or event, relevant to a business or sponsor, relevant to a content platform associated with UI 400, relevant to a cue or condition, relevant to a trend or statistic, relevant to a content or an advertisement campaign, relevant to a promotion, relevant to a region or culture, etc.), a prioritized or promoted topic, a preferred topic (e.g., preferred by user(s) 140, a user group, a business, a sponsor, a content platform associated with UI 400, etc.), a sponsored topic, a topic matching a rule or criterion, etc.

In some cases, the Met Gala topic can be associated with a Met Gala content item (e.g., TV show, movie, etc.) or event determined to be relevant (e.g., have a threshold relevance to user(s) 140, a user group, a business or sponsor, a content platform, an event, a date, a condition, a campaign, a trend, a cue, a region or culture, a promotion, a context, a location, etc.) or selected as the basis for a theme of UI 400. For example, the Met Gala topic can be selected based on a determination that the Met Gala content item or event has a threshold relevance when UI 400 is presented (e.g., contextually relevant, temporally relevant, thematically relevant, etc.), is a promoted content item or event when UI 400 is displayed, has a threshold priority when UI 400 is displayed, is trending when UI 400 is displayed (e.g., is associated with a threshold trend metric), is preferred by user(s) 140 when UI 400 is displayed (and/or by a group, business or sponsor, content platform, etc.), matches one or more preferences (e.g., a user preference, business preference, sponsor preference, group preference, etc.), is associated with a content statistic, is associated with a popularity metric, etc.

For example, the Met Gala Show or event can include a show or event released and/or promoted when UI 400 is displayed (and/or within a period that includes a day when UI 400 is displayed, within a period prior to UI 400 being displayed, within a period after UI 400 is displayed, etc.). As another example, the Met Gala topic used to select the Met Gala theme can be determined or selected based on a determination that the Met Gala event or content item is a trending event or content item, scheduled to occur or be released/televised on a day when UI 400 is presented (or within a time frame relative to when UI 400 is presented), a promoted event, an event of interest to user(s) 140 (and/or to a group of users including user(s) 140, a business or sponsor, a content platform, etc.), is temporally relevant, is geographically relevant (e.g., taking place in a same region, such as a same city or state, as the location of user(s) 140 and/or a device used to display UI 400), is contextually relevant, is selected to be highlighted, etc.

UI 400 can additionally or alternatively include any other visual elements. Any of the visual elements of UI 400 can represent and/or provide a reference (e.g., hidden message or clue) to a respective content item (e.g., movie, TV show or episode, video game, etc.) and/or a feature associated with the respective content item (e.g., an object, character, building, scene, logo, symbol, vehicle, landmark, structure, graphic, activity, device, location, content, or any other feature from, depicted in, corresponding to, and/or related to the respective content item). For example, a visual element of UI 400 can be configured to depict or represent a reference to a content item and/or feature associated with the content item.

Each visual element may or may not be part of or configured based on a theme(s) of UI 400. For example, UI 400 in FIG. 4 includes visual elements 324A-D and 404A-N. Any of the visual elements 324A-D and 404A-N can include, depict, and/or convey a feature of a theme(s) of UI 400, such as a content, graphic, image, interface element, background, color(s), artwork, animation, object, character, logo, message, scene, structure, landmark, visualization, visual effect, visual content, and/or any other feature that depicts, conveys, and/or is part of any portion or aspect of the city and/or Met Gala theme of UI 400. Any of the visual elements 324A-D and/or visual elements 404A-N may depict, include, and/or represent a reference to a feature (e.g., object, character, building, structure, landmark, content or item from a scene, symbol, graphic, etc.) associated with a content (e.g., movie, TV show, video game, etc.), such as a content item from a platform associated with UI 400, a content item being released, or any other content item.

In some cases, the reference to the feature associated with the content item can represent a hidden message or clue associated with the content item. The reference to the feature can optionally be based on a theme(s), such as the theme(s) of UI 400. Accordingly, any of the visual elements 324A-D and/or 404A-N can be associated with a theme(s), such as the city theme and/or Met Gala theme of UI 400. In FIG. 4, the visual elements 324A-C and 404B-D are associated with the city theme of UI 400. Each visual element depicts theme-based content, such as content depicting or representing a city element (e.g., a city building, scene, landmark, background, object, image, infrastructure item, road, sign, structure, name, etc.). To illustrate, visual element 324A depicts a city bridge, visual element 324B depicts a city building, visual element 324C depicts a Ferris wheel, visual element 404B depicts a volcano in a city, visual element 404C depicts the Eiffel tower from Paris, and visual element 404D depicts another city bridge. Thus, the visual elements 324A-C and 404B-D in this example can be part of and/or help convey/implement the city theme.

As previously noted, a visual element can additionally or alternatively represent a content item reference (e.g., a hidden message or clue from a content item) that depicts or includes a feature(s) included in, depicted in, and/or correlated to the content item. For example, the visual elements 404A-N depict references to features (e.g., objects, characters, buildings, structures, landmarks, content or items from a scene(s), symbols, graphics, etc.) from one or more respective content items and can optionally represent hidden messages or clues associated with the one or more respective content items. In FIG. 4, visual element 404A depicts a character from a movie and thus represents a reference to that movie, visual element 404B depicts a volcano from a movie and thus represents a reference to that movie, visual element 404C depicts a representation of the Eiffel Tower from a movie and thus represents a reference to that movie, visual element 404D depicts a bridge from a movie and thus represents a reference to that movie, and visual element 404N depicts a spaceship from a TV show and thus represents a reference to that TV show.

In some cases, the topic(s) used to determine or select the theme(s) associated with UI 400 and/or background 414 can be based on a topic(s), such as a topic(s) related to, describing, representing, indicating, matching (or having a threshold similarity to), selected based on, and/or otherwise associated with an event, content, sport, category, context, rule, content category, social media data (e.g., posts, subscriptions, connections, messages, activity, trends, statistics, content, inputs, communications, profiles, etc.), genre, action or activity, location, venue and/or landmark, campaign, sponsor, product, brand, calendar, date or season, relevance metric (e.g., a score representing or measuring a temporal relevance, contextual relevance, user and/or group relevance, content consumption or statistical relevance, relevance to a business preference and/or subject, a combination thereof, etc.), input, user and/or group profile, content statistic, content history, scene or environment, preference, request, promotion, a combination thereof, and/or any other factor. The topic(s) associated with the theme(s) of UI 400 can be based on a signal(s).

The signal(s) can include, describe, or identify a context, event, calendar data, preferences, weight, rule, factor selected by an AI/ML model, filter, temporal cue, profile (e.g., user, group, content, and/or device profile), history (e.g., content history, session history, input history, preference and/or recommendation history, user history, group/household history, social media history, business/platform history, event history, regional/cultural history, etc.), cue (e.g., topical cue indicating topic trend, metric, weight, relevance, priority, rank, promotion/highlight score, etc.), campaign (e.g., content campaign, topic/theme-based campaign, regional campaign, promotion campaign, etc.), date/time, timeframe (e.g., period, month, week, day, hours, year, season, etc.), cultural or regional data (e.g., trend, preference, norm/tradition, language, event, etc.), trend and/or popularity data (e.g., a trend/popularity score or statistic associated with a topic, event, content, pattern, context, date, etc.), weight(s), scene or environment (e.g., current and/or previous), input (e.g., user/group input, input or decision of/from a business or platform associated with UI 400, etc.), interaction (e.g., user/group interaction, device interaction, content interaction, etc.), user/content session information, statistic (e.g., user/group statistic, device statistic, content statistic, etc.), user/group attribute (e.g., demographics, social media connections, content and/or social media subscriptions, content “likes”, “dislikes”, content feedback, etc.), activity (e.g., associated with a user, group, content, device, etc.), topic and/or content attribute, etc.

In some cases, UI 400, page 402, background 414, and/or the theme(s) of UI 400, page 402, and/or background 414 can be customized for or based on user(s) 140, another user, a household or group of users, a device, a group of devices, a context, a preference, an event, a condition, a rule or filter, a weight, a user input, a business preference, a business decision, a trend, a content pattern, historical data, social media data, an activity, etc. In some examples, the background 414, page 402, and/or theme(s) can be based on a configuration of UI 400, a date and/or context in which UI 400 is presented, a characteristic or profile of user(s) 140 associated with UI 400, the device used to display UI 400, a content platform(s) or service(s) associated with UI 400, etc. In some examples, the background 414 and/or theme(s) can change or can be implemented (e.g., can remain the same or maintain a common attribute(s) or threshold similarity) across spaces (e.g., screens, interfaces, windows, pages, sections, etc.), sessions, etc. For example, the background 414 and/or theme(s) can remain the same or thematically consistent throughout a content or navigation experience, across interfaces/spaces, etc.

UI 400 can include content section 420. Content section 420 can include content items 424A-N (and/or links to content items or categories), such as movies, TV shows, TV channels, applications, video games, podcasts, audiobooks, videos, content catalogs, promoted content, advertisements, content categories, etc. In some cases, one or more of the content items 424A-N in content section 420 can be associated with (e.g., can relate to, can depict, can be selected based on, etc.) the Met Gala theme, such as a video of a current or previous Met Gala event, a Met Gala movie (and/or any characters, clothing articles, brands, or items associated with a Met Gala movie), a live stream or broadcast of a Met Gala event, a TV channel showing or scheduled to show Met Gala content, a documentary of a Met Gala event, a highlight reel from Met Gala events, videos of participants in one or more Met Gala events, etc.

In some cases, content section 420 may highlight, promote, or prioritize content associated with the Met Gala theme, but may also or instead include other content. The content section 420 can optionally include a navigation element 422 that user(s) 140 can use (e.g., select or activate) to navigate content in content section 420 and/or access or navigate to other spaces (e.g., sections, pages, portions, interfaces, etc.). For example, the navigation element 422 can include a selectable element which, when selected, causes UI 400 to expand content section 420 to display other content items, sections, portions, pages, etc.

In some cases, content section 420 can include or represent a bottom sheet. The bottom sheet can show content anchored to a bottom of the screen of UI 400. User(s) 140 can select or activate the navigation element 422 to expand or enlarge the bottom sheet to display content, navigate to content in the bottom sheet, increase a size or prominence of the bottom sheet relative to other portions of UI 400, load an enlarged or expanded view of the bottom sheet, load an additional portion of the bottom sheet, or otherwise load a page associated with the bottom sheet containing content associated with the bottom sheet (e.g., content items that are not visible within UI 400 until user(s) 140 selects or activates the navigation element 422).

In some cases, UI 400 can include an animation(s). The animation(s) can be used to entertain users, provide an immersive experience, and/or promote/teach or draw attention to certain content, features, functionalities, etc. For example, in FIG. 4, UI 400 displays an animated arm 432 surfaced from a portion of UI 400, such as a border, and can extend to a region of UI 400 and can remain static for a period or disappear (e.g., can be removed, can move out of the screen, etc.) based on a trigger, such as a timeout, a time period, an input, an interaction, etc. As shown, the animated arm 432 is depicted holding a character 434. The character 434 is also holding a message 430 promoting a new episode of a reality show 438. The message 430 can identify the new episode of the reality show 438, and can optionally include a playback control 440 that user(s) 140 can select to play or stream the new episode of the reality show 438 and/or any other information associated with the reality show 438 and/or the new episode.

The animated arm 432, the character 434, the message 430, and the reality show 438 are illustrative examples provided for explanation purposes. In other examples, UI 400 can display a different animated or static graphic (e.g., a body part, object, animal, logo or symbol, character, pattern, vehicle, image, avatar, creature, system, etc.), which can hold the character 434 or provide a different graphic (e.g., different character, an object, an animal, a vehicle, an image, a creature, a logo, a system, a person, etc.) and/or can include a different message or any other content (e.g., a video, a game, an XR experience, an image, a video game, a prompt, a content experience, etc.).

For example, in FIG. 4, UI 400 also depicts an animated character 454 associated with the Met Gala theme. In some cases, the animated character 454 can include a participant in a Met Gala event, a Met Gala model, a visual depiction of user(s) 140 customized to include an attribute(s) associated with the Met Gala theme (e.g., a dress or outfit, etc.), etc. In this example, the animated character 454 includes a dress depicted by the visual elements 408D-E associated with the Met Gala theme. This way, the animated character 454 can be relevant to the Met Gala theme and/or depict an aspect thereof. The animated character 454 in this example is surfaced from the dress depicted by the visual element 408D and moves within UI 400 towards content item 450. The animated character 454 can be placed on/near the content item 450 or crash against the content item 450 to draw the attention of user(s) 140 to the content item 450 or otherwise highlight/promote the content item 450. In this example, the content item 450 includes a button or link to content associated with promoted dresses, such as an advertisement of promoted dresses, an illustration of promoted dresses, a virtual fitting of promoted dresses, a page of promoted dresses available for purchase, a page of virtual dresses promoted as interface or avatar add-ons, a content depicting promoted dresses, an activity or experience associated with promoted dresses, etc.

UI 400 can optionally display a user avatar 460 configured, customized, and/or generated for user(s) 140. The user avatar 460 can depict user(s) 140 or a representation of user(s) 140. The user avatar 460 can optionally be customized based on a theme(s) associated with UI 400. In FIG. 4, user avatar 460 is customized based on the Met Gala theme to include a dress, such as a Met Gala dress, and optionally depict a hairstyle selected based on the Met Gala theme.

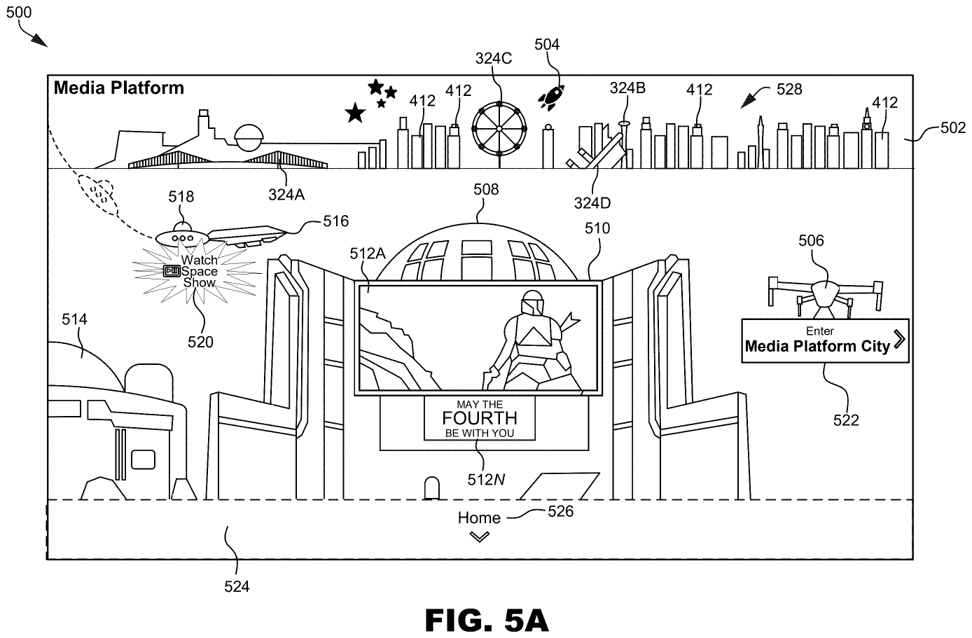

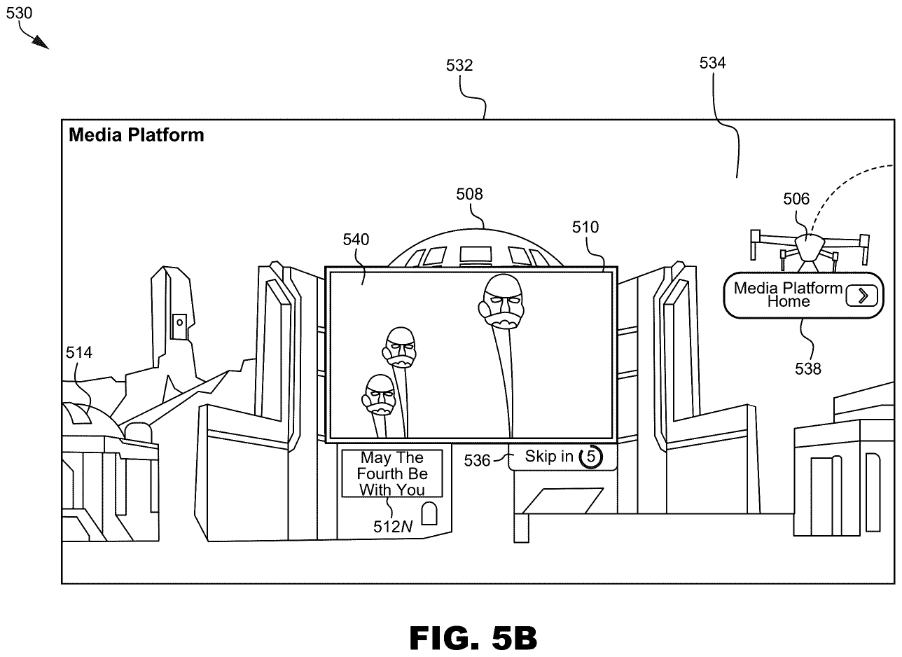

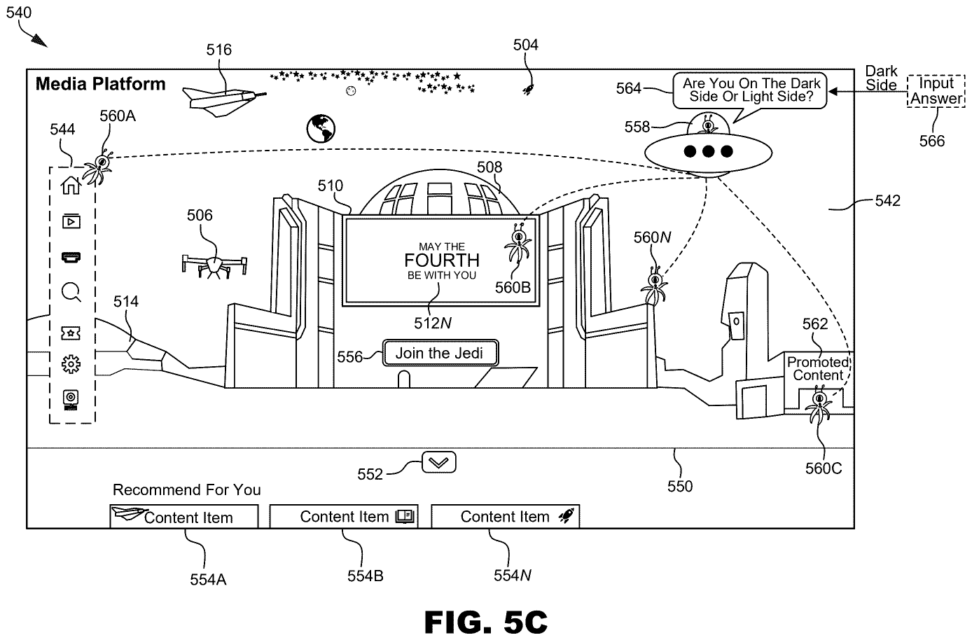

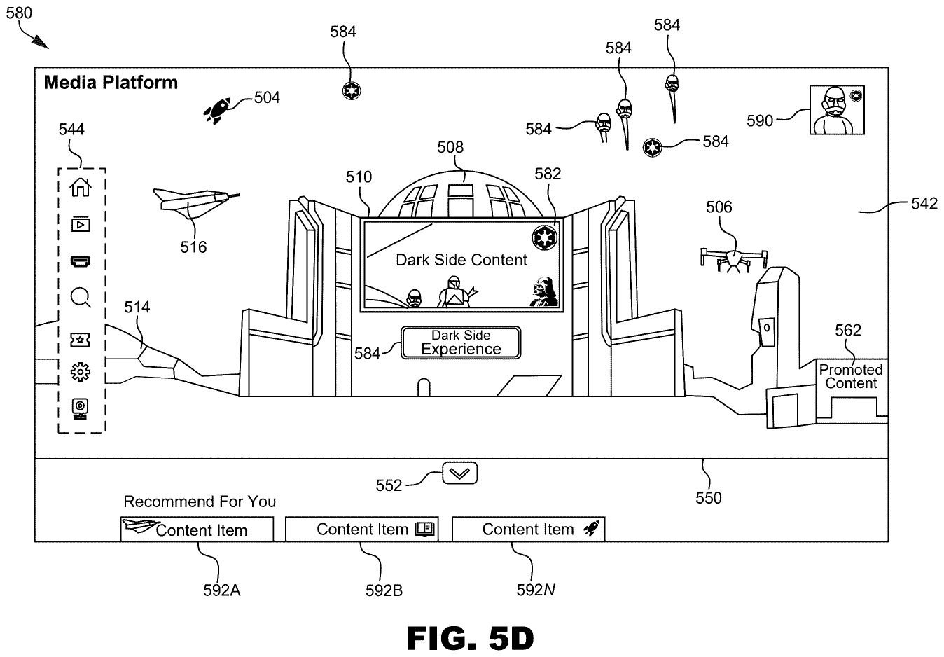

FIG. 5A illustrates another example user interface (UI) 500 configured to provide customized themes and/or content experiences. UI 500 can include a graphical user interface (GUI) of a content platform, device, operating system, media application, streaming service, media library, media channel, media entertainment system, video game system, set-top box, media broadcast player or receiver, TV platform, etc.

In some cases, UI 500 can provide an entry point to content, a content experience, a content platform, a channel, a service, and/or the like. UI 500 can be customized based on a theme(s). The theme(s) can be selected based on a signal(s) such as a context signal, preferences (e.g., from a user, household, group, business, platform, sponsor, etc.), an event signal, a statistic signal, a temporal signal, a relevance signal (e.g., a topic, event, location, context, activity, and/or feature that is relevant to a date, time, period, context, user preference, statistic, trend, content, etc.), a data signal (e.g., statistics, historical data, input data, a data pattern, user data, content information, event data, context data, temporal data, profile data, preference data, etc.), a signal associated with an interaction or behavior (e.g., user interaction, trending interaction, user input, user response and/or reaction, content access and/or navigation pattern, purchasing pattern, content behavior, etc.), and/or any other signal.

In FIG. 5A, UI 500 is customized based on a theme associated with a “May The Fourth Be With You” topic or event (e.g., a “May The Fourth Be With You” theme). “May The Fourth Be With You” is or represents an event (e.g., a cultural or popular event) that is associated with and celebrates a space show (e.g., a space movie, TV show, video game, media franchise, and/or other media content). The event is celebrated on May 4^{th} by people such as fans of the space show, to commemorate and/or celebrate the space show. The theme can be selected based on one or more signals, such as signals indicating that “May The Fourth Be With You” is a relevant topic with respect to a date/day/time/period when UI 500 is presented, relevant to a context associated with user(s) 140 and/or media device(s) 104, a relevant or trending event, a preferred event (e.g., based on a user/group preference, business/platform preference, sponsor preference, etc.), and/or a topic or event selected or promoted based on selection data (e.g., a user (and/or group) profile, a user and/or business input or profile, a user or group preference, a business or platform preference, etc.), a condition, an activity, a content item, a rule, a calendar, a statistic, social media data, etc.

For example, UI 500 can be displayed to user(s) 140 (and any other users) on May 4^{th} and customized to include a “May The Fourth Be With You” theme. The “May The Fourth Be With You” theme can depict or include space-related features (e.g., content, attributes, interface elements, styles, designs, visual elements, graphics, artwork a background, an experience, etc.) and/or features associated with “May The Fourth Be With You”. In some cases, the theme can be selected based on a determination that “May The Fourth Be With You” is a trending or relevant topic or event on May 4^{th}. Thus, on May 4^{th}, UI 500 can be customized to include the theme associated with “May The Fourth Be With You”. In some examples, the theme of UI 500 can be selected based on one or more signals identifying a decision of a business/platform associated with UI 500 to promote the “May The Fourth Be With You” topic or event when UI 500 is presented, a respective weight associated with one or more topic candidates including the theme of UI 500, a content history of user(s) 140 or a group, a user or group preference, a rule, a calendar, a profile, a content history, content statistic, a trend, social media data, etc.

In some cases, the theme can be implemented on May 4^{th} based on a relevance, popularity, and/or history of the topic or event (e.g., “May The Fourth Be With You”) associated with the theme on that day. The theme can include or depict features (e.g., an appearance, content, style, color, color scheme, object, experience, animation, attribute, background, etc.) associated with or customized for or based on the “May The Fourth Be With You” topic or event. For example, the theme can depict one or more content items, experiences, attributes, graphics, artwork, background, objects, characters, animations, etc., related to a space show associated with “May The Fourth Be With You” based on a relevance of the “May The Fourth Be With You” event on May 4^{th} and/or the space show associated with such event. When user(s) 140 accesses UI 500 (e.g., via media device(s) 104) on May 4^{th}, UI 500 is displayed and customized as shown in FIG. 5A to include, incorporate, and/or depict a theme associated with “May The Fourth Be With You” and/or the associated space show. This way, UI 500 can provide a content and experience that relates to a relevant event and/or dynamically or selectively correlates to or conveys a theme.

UI 500 can include a background 502 and visual elements 504-522 related to the “May The Fourth Be With You” theme. The visual elements 504-522 can include one or more images, colors, patterns, attributes, objects, color schemes, content experiences, characters, content items, information, styles, shapes, designs, characteristics, buildings, artwork, videos, features, interface elements, animations, background attributes, interface attributes, details, and/or other features based on the “May The Fourth Be With You” theme. For example, in FIG. 5A, visual elements 504 and 516 depict or represent spaceships, visual element 506 depicts or represents a flying vehicle, visual elements 508 and 514 depict or represent space or alien city structures (e.g., buildings, infrastructure, objects, and/or other visuals thematically relevant to the theme), and visual element 510 depicts or represents a display showing content 512A-512N from or associated with a “May The Fourth Be With You” theme and/or a space show theme associated with “May The Fourth Be With You”. In this example, the content 512A can include any content (e.g., an image, video, animation, graphic, game, etc.) and the content 512N can include a message associated with “May The Fourth Be With You”. Thus, the visual elements 504-522 can implement a theme and create an experience that relates to the theme. The visual elements 504-522 can immerse user(s) 140 in an experience that relates to or is reminiscent of “May The Fourth Be With You” and/or the associated space show.

The background 502 can be selected, customized, and/or configured based on a theme(s). The theme(s) of the background 502 can include the “May The Fourth Be With You” theme associated with UI 500 and/or another theme. In FIG. 5A, the background 502 depicts a city theme. The city theme includes, depicts, and/or conveys a cityscape 528. The city scape 528 can include one or more structures, objects, attributes, elements, scenes, experiences, content items, and/or any other attributes of or associated with a city or urban area, such as a real city or urban area, a city or urban area included in one or more content items (e.g., movies, TV shows, video games, animations, images, graphics, media channels, etc.), a city or urban area from or depicted/included in “May The Fourth Be With You” content (and/or related content), etc. For example, the cityscape 528 can include a cityscape or scene from a digital content item (e.g., a movie, TV show, video game, animation, video, image, etc.), a cityscape or scene from a physical content item (e.g., a painting, drawing, print or photograph, city landscape, etc.), a cityscape or scene from a real city or urban area, and/or physical aspects of a real city or urban area.

A theme(s) of UI 500 and/or background 502 can change across spaces (e.g., screens, interfaces, windows, screens, pages, sections, etc.) and/or experiences, or can remain the same or maintain one or more theme features (e.g., with or without any variations or additional aspects) across spaces and/or experiences to maintain a level of thematic and/or visual consistency throughout spaces and/or experiences and provide a common or related appearance and/or attribute across spaces and/or experiences.

In some cases, the content 512A shown on the display depicted or represented by the visual element 510 can include interactive content. For example, the content 512A can include a link to content, an experience, a game, a movie, a TV show, a livestream, a podcast, a video, interactive content, a video game, an activity, and/or any other content or feature. To illustrate, the content 512A can include a link to a movie, video, game, product, or activity of the space show associated with the “May The Fourth Be With You” theme. When user(s) 140 clicks on or selects the content 512A, the link can trigger/activate the movie (e.g., initiate playback), the video (e.g., initiate playback), the video game (e.g., start a video game session), a transaction associated with a product, the activity, the content item, etc.

In some examples, UI 500 can include other interface sections, content, spaces, features, and/or elements. For example, in FIG. 5A, UI 500 includes a navigation element 522 that user(s) 140 can use/select to navigate to another interface space (e.g., page, section, window, category, library, screen, interface or interface region, etc.), such as a page or experience depicting a media platform city or implementing a media platform city theme. When the navigation element 522 is selected or activated, UI 500 can transition or navigate to another user interface or page, which can include, depict, or implement the media platform city theme. The navigation element 522 can be placed on any location of UI 500 and optionally animated. In this example, the navigation element 522 depicts a sign with a message indicating that the navigation element 522 can be used to enter the user interface or page depicting or implementing the media platform city or associated theme. The sign in this example is held by the flying vehicle depicted by visual element 506. The visual element 506 can optionally move (e.g., fly) within UI 500 and carry the navigation element 522 as it moves to provide animation, draw the attention of user(s) 140, delight user(s) 140, etc.

UI 500 can optionally include a content section 524. The content section 524 can include content items (and/or associated links) or categories (and/or associated links) available through UI 500, such as movies, TV shows, channels, media platforms/applications/services, video games, podcasts, audiobooks, videos, content catalogs, etc. For example, the content section 524 can include content items related to “May The Fourth Be With You” and/or an associated space show. The content section 524 can additionally or alternatively include other content items. The content section 524 can optionally include an interface element 526 used to navigate content in content section 524, expand content section 524 to show additional content, scroll content section 524, and/or access other spaces (e.g., sections, pages, frames, windows, interfaces, regions, etc.).

For example, the interface element 526 can be selected to expand the content section 524 to display content such as recommended content, previously-accessed content, promoted content, content related to the theme of UI 500, a content experience or activity, etc. In some cases, the content section 524 can include or represent a bottom sheet used to show content anchored to a bottom of the screen of UI 500. User(s) 140 can select or activate the navigation element 522 to expand or enlarge the bottom sheet to display content, navigate to content in the bottom sheet, increase a size or prominence of the bottom sheet relative to other portions of UI 500, load an enlarged or expanded view of the bottom sheet, load an additional portion of the bottom sheet, or otherwise load a page associated with the bottom sheet (e.g., depicting content items that are not visible within UI 500 until user(s) 140 selects or activates the navigation element 522).

In some cases, content section 524 can include or be part of a page of a content platform associated with UI 500. User(s) 140 can select the interface element 526 to navigate to, expand, display, or access the home page. For example, UI 500 can represent a page displayed when media device(s) 104 loads a media platform associated with UI 500. The page can include or depict a theme as shown in FIG. 5A. The theme can provide a content experience(s) to user(s) 140 before user(s) 140 navigates to another space (e.g., another page or interface) such UI 530 shown in FIG. 5B or UI 540 shown in FIG. 5C.

In some examples, UI 500 can depict an animation used to provide an experience to user(s) 140, steer user(s) 140 to a specific feature(s) (e.g., a content, content space, setting, menu, control, functionality, option, section, graphic, object, advertisement, link, experience, interface element, page, etc.), help user(s) 140 discover a specific feature (e.g., a specific content item, setting, menu, functionality, object, link, advertisement, clue, message, interface element, experience, etc.), teach user(s) 140 how to use a specific configuration/control feature (e.g., a menu, setting, control input, control or configuration parameter, etc.) and/or functionality, help user(s) 140 explore UI 500, etc. For example, in FIG. 5A, UI 500 depicts an animated spaceship 518 crashing into the spaceship depicted by visual element 516. The crash between the animated spaceship 518 and the spaceship depicted by the visual element 516 can trigger UI 500 to depict a visual element 520 with a message promoting content. The visual element 520 can include a link or interactive element (e.g., a button, a control, etc.) configured to load, navigate, initiate, play, interact with, and/or access the promoted content. User(s) 140 can access the promoted content by selecting or activating such link or interactive element depicted by the visual element 520 shown in response to the crash.

The animated spaceship 518 and animated experience provided by the animated spaceship 518 can be selected based on a theme (e.g., the “May The Fourth Be With You” theme) of UI 500 and convey aspects of the theme and/or relate to the theme. In some cases, the content promoted by the visual element 520 can be selected based on the theme and/or include content associated with the theme, such as a space movie, show, video game, documentary, experience, XR scene or environment, page, content, etc. The visual element 520 can additionally or alternatively promote any other content and/or can depict any other content, experience, animation, link, interface element, message, output, and/or any other feature.

For example, in FIG. 5A, the visual element 520 appears as, depicts, and/or represents an explosion (and/or aspects thereof) resulting from the crash between the spaceship depicted by visual element 516 and the animated spaceship 518. The visual element 520 can depict the explosion using features that convey an explosion from a crash, such as a shockwave, smoke, fire, debris, a message (e.g., “Boom”, “Bang”, “Crash”, “Explosion”, etc.), a structure or object collapsing (e.g., the spaceship depicted by the visual element 516 and/or the animated spaceship 518 collapsing), damage to a structure and/or object associated with the crash (e.g., the spaceship depicted and/or the animated spaceship 518), a shape representing or conveying an explosion (e.g., a shape that conveys the energy and/or radial nature of an explosion such as a sunburst shape, a starburst shape, a shape of a smoke cloud, etc.), a color(s) and/or texture(s) determined to convey an explosion (e.g., a color(s) and/or texture(s) used to simulate the visual intensity of an explosion such as any colors and textures having a threshold contrast and/or brightness), motion and/or speed used to capture the dynamic nature of an explosion (e.g., certain lines, streaks, patterns such as swirling patterns and/or any motion pattern, imagery depicting or representing an explosion, etc.), etc. The object depict that depicts the content of the visual element 520, such as the promoted content and optionally any content link or control elements such as a playback or selection element.

In some cases, the crash can include sound triggered by the crash, such as a crashing sound. Media device(s) 104 associated with UI 500 can output the sound via one or more speaker devices.

FIG. 5B illustrates another example user interface (UI) 530 customized based on a selected theme. UI 530 is configured to provide an experience for user(s) 140. For example, UI 530 can provide a content experience for user(s) 140 displayed before or after user(s) 140 navigates or accesses another page or interface of a content platform (e.g., a streaming platform, TV platform, media platform, online content service, media player, set-top box platform, media receiver, video game console platform, etc.) associated with UI 530 that displays and provides access to content (e.g., movies, TV shows, channels, media applications or associated portals, video games, podcasts, content catalogs/collections/libraries, content sections, content features, etc.) and/or content experiences associated with the content platform.

UI 530 can be customized based on a theme(s) associated with a topic(s). In this example, the theme(s) of UI 530 is related to, associated with, and/or customized based on astronomical space (e.g., the three-dimensional (3D) cosmic expanse also known as the universe), the “May The Fourth Be With You” topic discussed in FIG. 5A, and/or features (e.g., attributes, content, artwork, etc.) associated with the “May The Fourth Be With You” topic and/or an associated space show. As part of or based on such theme(s), UI 530 can depict a scene or environment associated with the theme, such as a space city 532 and/or any features representing, depicting, and/or associated with space city 532. The space city 532 (and associated features such as content, attributes, experiences, interface elements, settings, etc.) can be used to implement, depict, and/or convey the theme(s) of UI 530. The space city 532 can provide a customized, thematic experience for user(s) 140 that depicts, conveys, and/or is associated with the theme(s) of UI 530.

In some cases, the theme(s) associated with the space city 532 can be selected based on and/or continued from the theme(s) of UI 500. For example, if user(s) 140 navigates from UI 500 to UI 530 (or vice versa), the user interfaces displayed to user(s) 140 when user(s) 140 navigates from UI 500 to UI 530 (or vice versa) can maintain or persist a same theme(s) with or without any variations/adjustments in the presentation, features (e.g., content, attributes, settings, experiences, interface elements, designs, styles, configurations, customizations, etc.), and/or any other aspects of the theme(s). The theme(s) of UI 500 and UI 530 is/are an example(s) theme(s) provided for illustration and explanation purposes. One of ordinary skill in the art will recognize from the disclosure that the user interfaces can implement or include other themes. For example, while the example user interfaces shown in FIG. 5A and FIG. 5B include a same or consistent theme(s) (with or without any modifications/adjustments), in other examples, UIs 500 and 530 can implement a different theme(s) regardless of whether UI 530 is accessed, navigated, or transitioned from UI 500 (or vice versa) or a different user interface, or whether UI 500 and UI 530 are displayed on a same or different day and/or on or as part of a same or different session.

The space city 532 in UI 530 can include a background 534, visual elements 506-514, and visual elements 536-538. The background 534, visual elements 506-514, and visual elements 536-538 (or a subset thereof) can be based on, associated with, part of, customized for, and/or depict the theme(s) associated with UI 530 (and/or aspects thereof), which in FIG. 5B includes a theme(s) associated with astronomical space, “May The Fourth Be With You”, and/or a space show associated with “May The Fourth Be With You”. The space city 532 can optionally include any other visual elements which may or may not relate to the theme(s) of UI 530 or the space city 532. The background 534, visual elements 506-514, and visual elements 536-538 (or a subset thereof) can display features (e.g., attributes, experiences, settings, behaviors, designs, styles, content, etc.) and provide/create an appearance of a city in space, related to “May The Fourth Be With You” and/or the space show associated with “May The Fourth Be With You”.

For example, the background 534 can include a visual feature(s) (e.g., a color(s), color scheme(s), visual pattern(s), message(s), animation(s), visual experience(s), visual style(s) and/or stylization(s), graphic(s), interface element(s), wallpaper, content, etc.) related to the theme(s) of UI 530, such as a wallpaper/backdrop or screensaver depicting a representation of space (or space features) and/or structures, characters, vehicles, objects, celestial bodies, interstellar or intergalactic elements, planets or planet systems, aliens or alien characters, alien objects, alien worlds, cosmic environments, and/or astronomic features depicted in, related to, associated with, similar to (e.g., having a threshold similarity, a same attribute(s), attributes having a threshold similarity, etc.), and/or created based on a space content or theme such as a space show, movie, video game, media franchise, documentary, animation, rendition, and/or video or theme associated with “May The Fourth Be With You” and/or space.

In FIG. 5B, the screen depicted by the visual element 510 displays a video 540 related to the theme(s) of UI 530, such as a space or “May The Fourth Be With You” related movie, show, animation, advertisement, game, etc. For example, when UI 530 is displayed, the screen depicted by the visual element 510 can show/play the video 540 related to the theme(s) (e.g., “May The Fourth Be With You”). The space city 532 can optionally include an interface element 536 for providing user input. For example, the interface element 536 can include a link, button, control, or interactive/selectable element that user(s) 140 can select or activate to initiate or control a behavior (e.g., playback, etc.) of the video 540 in the screen depicted by the visual element 510. In FIG. 5B, the interface element 536 includes a button that user(s) 140 can select to skip the video 540 or a portion of the video 540, such as an advertisement.

In some examples, UI 530 and/or space city 532 can include one or more animations used to delight user(s) 140, draw an attention of user(s) 140, steer user(s) 140 to a specific feature(s), promote a specific feature(s), help user(s) 140 navigate a specific feature(s) (and/or UI 530), help user(s) 140 discover a specific feature(s), encourage user(s) 140 to explore a specific feature(s), teach user(s) 140 a specific feature(s) such as a setting or functionality, and/or otherwise promote anything in UI 530 and/or assist or delight user(s) 140. For example, in FIG. 5B, the flying vehicle depicted by the visual element 506 can provide an animation to promote or draw an attention of user(s) 140 to the navigation element 538 in order to steer user(s) 140 to the destination associated with navigation element 538 or help or encourage user(s) 140 to explore other interface spaces, such as the destination associated with navigation element 538.

As shown, the flying vehicle depicted by the visual element 506 can fly within UI 530. For example, the flying vehicle can appear from outside of the screen (e.g., can fly into UI 530 from outside of UI 530) and move within UI 530 while it carries navigation element 538. The flying vehicle can fly around UI 530 carrying navigation element 538 or park in an area within UI 530 and hold navigation element 538 from the parked location. In some cases, the flying vehicle can throw or drop navigation element 538 somewhere in UI 530 and optionally fly away. If the flying vehicle drops navigation element 538, UI 530 can depict an animation showing the navigation element 538 falling and optionally crashing into an object, a ground level, or anything in UI 530. UI 530 can optionally animate such crash. In some cases, the crash can trigger a rendering of another object/content or animation. For example, the crash can cause another object or content item, such as a promoted page or movie, to appear from the crash in an animated fashion. In some cases, the crash can trigger a sound such as a crashing sound. Media device(s) 104 can output the sound via one or more speakers, such as a speaker of media device(s) 104 and/or a speaker communicatively coupled to media device(s) 104 via a physical/wired and/or wireless connection.

The space city 532 can include a navigation element 538 that user(s) 140 can select or activate to access a page, interface, section, screen, any other destination, a content category page or interface, etc. User(s) 140 can select the navigation element 538 to leave the space city 532 and UI 530 and access another user interface or screen, such as UI 540 shown in FIG. 5C.

While visual element 510 depicts a screen that displays a video 540, in other examples, the visual element 510 and/or the space city 532 can provide, depict, and/or include any other feature (e.g., content, attribute, object, animation, interface element, game, activity, experience, graphic, image, visual element, etc.) in addition to or instead of the visual element 510 and/or the space city 532. The video experience associated with the theme(s) of the space city 532 and visual element 510 in FIG. 5B is one illustrative example experience provided for illustration and explanation purposes. In other cases, the screen depicted by visual element 510 in space city 532 can include a video game, an interactive or immersive experience related to the theme(s) associated with UI 530 (or any other topic/theme), etc. Moreover, the features and theme(s) shown in FIGS. 5A and 5B are non-limiting illustrative examples. One of ordinary skill in the art will recognize from the disclosure that UI 500 and/or UI 530 can include any other feature(s), theme(s), background(s), customization(s), etc., in addition to or instead of those shown in FIGS. 5A and 5B.

FIG. 5C illustrates another example of user interface (UI) 540 customized based on one or more themes. UI 540 can be customized based on (e.g., to implement) a theme(s) associated with a topic selected based on one or more signals. In some examples, UI 540 can also include a background 542 (e.g., backdrop, wallpaper, screensaver, etc.), which may or may not be part of the theme(s) and/or a different theme(s). In FIG. 5C, the background 542 is also customized based on the theme(s) associated with UI 540 and/or is part of the theme(s) associated with UI 540. For example, the background 542 can implement or depict “May The Fourth Be With You” theme (and/or an associated space or space show theme), as previously described.

In some cases, the background 542 can additionally or alternatively relate to one or more additional themes. For example, the background 542 can depict characteristics associated with (e.g., corresponding to, attributed to, relating to, designed by, used by, etc.) a content platform associated with UI 540 (and/or a brand, service, and/or entity associated with the content platform) such as a color(s), logo(s), pattern(s), design(s), aesthetic feature(s), advertisement(s), content, etc., associated with the content platform.

The UIs 500, 530, and 540 can implement a same them (with or without variations) or different themes. In the examples shown in FIGS. 5A-C, the “May The Fourth Be With You” theme is a continuous theme implemented across UI 500, UI 530, and UI 540. In some examples, the themes of UIs 500, 530, and 540 can remain the same during a session(s), time period(s) (e.g., day, week, hour, another unit of time, a range of any unit of time, etc.), and/or experience(s) based on a match, similarity, relevance, and/or attributes of the topic(s) associated with the themes of UIs 500, 530, and 540 (e.g., the topic(s) used to select the themes of UIs 500, 530, and 540).

While the theme(s) of UI 540 is the same (with some variations, adjustments, and/or customizations) as a respective theme implemented by UI 500 and UI 530, in other examples, UI 540 (or UI 500 and/or UI 530) can implement a different theme (in addition to or instead of a theme implemented by UI 500 and/or UI 530). For example, UI 540 may implement a different theme than UI 500 and/or UI 530 in addition to or instead of any theme implemented by UI 500 and/or UI 530. In some cases, the background 542 of UI 540 can include or be part of a different theme than another theme of UI 540, a theme(s) of UI 500, and/or a theme(s) of UI 530.

The theme associated with UI 540 and background 542 can be based on a topic(s) selected based on one or more signals. The background 542 can include one or more features associated with the theme of the background 542 (e.g., the “May The Fourth Be With You” theme), such as a color(s), a color scheme(s), a visual pattern(s), a design(s) and/or style(s), an appearance(s), a content(s), an experience(s), an animation(s), a visual attribute(s), an image(s), a wallpaper, a characteristic(s), etc. The one or more features can be used to implement, convey, and/or depict the theme associated with the background 542.

UI 540 can include visual elements 504-516 and 556-564 selected or configured based on the theme of UI 540 (e.g., “May The Fourth Be With You”). The visual elements 504-516 and 556-564 can depict/convey the theme (or aspects thereof) of UI 540 and/or can include or depict features associated with the theme of UI 540 (e.g., features selected for and/or conveying aspects of the “May The Fourth Be With You” theme). For example, the visual elements 504-516 and 556-564 can depict content, interface elements, animations, images, colors, objects, visual attributes, characters, hidden messages or clues (e.g., content references, etc.), color schemes, videos, graphics, and/or any other features associated with the theme of UI 540 (e.g., the “May The Fourth Be With You” theme), such as artwork and/or imagery depicting a space scene, a spaceship, a space city or station, a space structure, space aliens or creations, space animations, space content, space colors, and/or any other space or “May The Fourth Be With You” imagery or artwork.

To illustrate, visual element 504 depicts a rocket flying to space, visual element 506 depicts a flying aircraft, visual elements 508 and 514 depict space buildings (e.g., space theater, home, center, dome, stadium, hospital, hotel, and/or any space structure), visual element 510 depicts a screen (also referred to as the “screen 510”) showing a visual element 512N with a message associated with “May The Fourth Be With You”, visual element 556 depicts a control element that displays a message associated with “May The Fourth Be With You” and/or a title of content associated with a space show and/or “May The Fourth Be With You” and optionally accessible via visual element 556 (e.g., loaded, played, initiated, and/or rendered in response to an input selecting or activating visual element 556 or a link or component thereof), and visual elements 558-564 depict and/or are part of an animation in UI 540 that is associated with the UI theme.

In some examples, visual element 556 can include an interactive element (also referred to as “interactive element 556”). When interactive element 546 is selected or activated, UI 540 can update a content in the screen 510 to display other content associated with the interactive element 556, such as content associated with the theme of UI 540 (e.g., “May The Fourth Be With You”). Such content can include, for example, a relevant movie, video, video game, message, audio, immersive experience, interactive content, feature, etc. In some examples, when selected or activated, interactive element 546 can trigger the screen 510 to display certain content and/or change the content it displays, such as content related to a theme of UI 540.

As another example, when user(s) 140 selects or activates the interactive element 546, UI 540 can render an experience that appears as if user(s) 140 is entering the space building depicted by the visual element 508 to access a user interface or interface space depicting a scene inside of the space building where user(s) 140 can participate in or obtain a content experience associated with the Jedi (e.g., based on the interactive element 546 relating to the Jedi) and/or the message or content depicted by the screen 510 (e.g., “May The Fourth Be With You”). In some examples, the scene inside of the space building can include content and/or an environment based on the type of space building and/or theme associated with UI 540. For example, if the space building represents or depicts a space theater, the scene inside of the space building can include, depict, and/or represent a space theater showing content (or where user(s) 140 can view/access content) related to “May The Fourth Be With You”, such as a related movie or show. As another example, if the space building represents or depicts a space colosseum, the scene inside of the space building can include, depict, and/or represent a space colosseum showing content (or where user(s) 140 can view/access content) depicting a fight scene or competition involving relevant characters from a content/franchise associated with the theme of UI 540 (e.g., “May The Fourth Be With You”).

The visual elements on the UI 540 (or a subset thereof) can provide an animation, depict an animation, or be part of an animation. For example, the visual element 558 in UI 540 depicts an alien spaceship, the visual elements 560A-N (collectively “visual elements 560” hereinafter) depict alien creatures (also referred to as “alien creatures 560” herein), and the visual element 564 depicts an interaction (e.g., a prompt, message, question, survey, communication, chat, etc.) from an alien creature in the alien spaceship depicted by the visual element 558 (also referred to as “alien spaceship 558” herein). The animation associated with the visual elements 558-564 depicts the alien spaceship 558 flying around UI 540 or appearing within a view of UI 540 (e.g., appearing to fly into UI 540 from outside of UI 540) and dropping the alien creatures 560 (e.g., dropping the alien creatures 560 while or after the alien spaceship 558 stops/parks within UI 540 or as/while the alien spaceship 558 moves or continues to move about UI 540). Upon being dropped or released by the alien spaceship 558, the alien creatures 560 can fly, drop, land, move, hide, park, travel, or go to respective destinations on UI 540.

In FIG. 5C, the alien creature associated with the visual element 560A (also referred to as “alien creature 560A” herein) is depicted sitting on a toolbar 544 in UI 540 after being dropped/released from or exiting alien spaceship 558. The toolbar 544 can include, depict, or represent a menu toolbar with menu items. The menu items can include, for example and without limitation, a control menu for navigating to a certain destination such as a home page, a menu for accessing certain content (e.g., videos, music, movies, TV shows, podcasts, documentaries, audiobooks, images, animations, video games, promoted or promotional content, etc.), a display menu for configuring display settings (e.g., a display output setting or port, a rendering setting, a graphics setting, a visual attribute or parameter, a framerate, a resolution, an aspect ratio, etc.), a search tool, a menu for accessing a certain type of content (e.g., content of a certain content category, content of a certain genre, content associated with a certain type of content experience, video content, image content, audio, video game content, interactive content, animated content, customized content, interactive content, movies, TV shows, podcasts, VR/AR content experiences, and/or any other content), a menu for accessing a source of content or content associated with a feature (e.g., content from or with a topic, group, provider, producer, application, platform, channel, collection, franchise, server, region, language, setting, etc.), a settings menu (e.g., content settings, device settings, interface settings, audio settings, video settings, language settings, display settings, etc.), an input or output (e.g., HDMI, etc.) source or setting, a controls menu for accessing certain controls (e.g., controls for a camera, microphone, display, content, interface, application, device, platform, etc.), and/or any other menu or menu item.

UI 540 can show alien creature 560A going to toolbar 544 and/or sitting (or being positioned) on toolbar 544. Such animation can be used to engage user(s) 140, delight user(s) 140, provide an immersive experience, draw an attention of user(s) 140 to the toolbar 544 (or an item thereof), promote toolbar 544 (or an item thereof), help user(s) 140 explore or discover/learn toolbar 544 (or an item thereof), and/or as part of an animated experience used to guide user(s) 140 through toolbar 544 (or any item thereof), demonstrate a use or functionality of toolbar 544 (or any item thereof), teach user(s) 140 how to use toolbar 544 (or any item/feature thereof), provide a clue to user(s) 140 as part of an interactive or immersive game or activity, and/or provide an animated tutorial associated with toolbar 544, and/or any other purpose.

After being dropped/released from or exiting alien spaceship 558, the alien creatures 560B-N in FIG. 5C are depicted going to and/or positioned at respective locations of, within, or within a proximity to the space building depicted by visual element 508 (also referred to as “space building 508” or “alien building 508” herein). The alien creatures 560B-N can go to the respective locations associated with space building 508 to provide an animated experience for user(s) 140; help user(s) 140 discover, understand, or learn any features (e.g., content, functionalities, experiences, settings, etc.) available/accessible or depicted/provided at, from, or near (e.g., within a proximity, adjacent to, etc.) the respective locations associated with the space building 508; teach or guide the user(s) to access or use certain features accessible/available from, at, or near the respective locations associated with the space building 508; provide a clue(s) associated with a game or activity; incentivize user(s) 140 to access any feature or explore a portion of UI 540 associated with the respective locations of the alien creatures 560B-N; demonstrate to user(s) 140 certain feature(s) associated with the respective locations of the alien creatures 560B-N; and/or any other purpose.

For example, the alien creature 560B (also referred to as “alien creature 560B” herein) is shown on the screen 510. The alien creature 560B can drop or exit from the alien spaceship 558 to the screen 510 on the space building 508, and can be positioned on the screen 510 to draw attention to the screen 510 or content available via (or depicted/playing on) the screen 510, draw attention to the message depicted by the visual element 512N on the screen 510, incentivize or encourage user(s) 140 to watch or play content on or via the screen 510, interact with the screen 510 or content on the screen 510, help user(s) 140 discover content at or from the screen 510, etc.

The alien creature 560C (also referred to as “alien creature 560C” herein) is shown on a portion of the space building 508 that includes/displays promoted content 562. The alien creature 560C can be positioned by promoted content 562 to steer user(s) 140 to the promoted content 562, promote or highlight the promoted content 562, draw attention to the promoted content 562, incentivize or encourage user(s) 140 to consume or access the promoted content 562, help user(s) 140 discover or explore the promoted content 562, guide user(s) 140 to the promoted content 562, teach user(s) 140 how to access or anything else about the promoted content 562, and/or any other purpose. The promoted content 562 can include any content such as, for example, a movie, a movie category or collection, a TV show, a TV show category or collection, a media application, a media channel, a video game, a video game category or collection, an advertisement, an interactive experience, an activity, an announcement, a page or interface, a brand, etc.

The visual element 564 in UI 540 can be part of the animation associated with the alien spaceship 558 and alien creatures 560. For example, the visual element 564 in FIG. 5C displays a message (also referred to as “message 564” herein) from alien spaceship 558. The message 564 can be part of a prompt, chat, question, survey, activity, game, experience, contest, challenge, promotion, campaign, tutorial, instruction, or any other message. The message 564 may or may not be part of, relevant to, or based on the theme(s) associated with UI 540. For example, the message 564 in FIG. 5C asks user(s) 140 if user(s) 140 is on the “dark side” or “light side”, which are references to a space content/franchise associated with “May The Fourth Be With You”. In particular, the “dark side” refers to an evil or bad side (e.g., an evil or bad character, empire, show, etc.) from such space content/franchise and the “light side” refers to a good/righteous side or a side fighting against the bad side in such space content/franchise.

The question can be part of an immersive experience. For example, if user(s) 140 provides an input answer 566, input answer 566 can be used to trigger an experience, interact with a content or feature, further customize or personalize UI 540, customize/personalize or configure a content recommended/promoted or provided by UI 540, customize/personalize or configure a user profile associated with user(s) 140, customize or configure a user avatar associated with user(s) 140, etc.

In some cases, UI 540 can include a content section 550. The content section 550 can include an interface element 552 that user(s) 140 can select or activate to expand the content section 550 to display content (or more content) or increase the content section 550. The content in the content section 550 can relate to the theme of UI 540 (e.g., “May The Fourth Be With You” and/or associated content such as a space show franchise), and/or any other topic. The content section 550 can include tiles 554A-N (collectively “tiles 554” hereinafter) representing content items. User(s) 140 can use the tiles 554 (or respective links, controls, and/or interactive portions thereof) to access and/or interact with any of the content items associated with the tiles 554, watch/play or stream any of the content items (e.g., via any corresponding tiles from the tiles 554), navigate to any of the content items associated with the tiles 554, select any of the content items associated with the tiles 554, interact with any of the tiles 554 (and/or any corresponding content items), etc. The tiles 554 can represent or correspond to any type of content items (or combination/mix of content items) such as, for example, movies, TV shows, podcasts, livestreams, videos, video games, animations, software applications, channels, advertisements, sponsored content, audiobooks, music, content from a content history of user(s) 140, XR content, etc.

In some cases, the tiles 554 can include content items from one or more categories such as, for example, a recommended content category, a new release category, a live category, a genre or content category (e.g., action, comedy, horror, sports, reality TV, drama, documentaries, animation, etc.), a content type (e.g., movies, TV shows, video games, etc.), a category for a target audience (e.g., family, children, adults, etc.), a ratings category, a country category, a language category, a theme-based category (e.g., “May The Fourth Be With You”, a holiday category, a vacation category, a beach setting category, a racing cars category, a horseback riding category, a nature category, etc.), a science category, a news category, a topic category, an experience or experience type category, etc. In some examples, the tiles 554 (or a subset thereof) can be organized, categorized, arranged, sorted, and/or grouped according to one or more factors, such as one or more factors associated with the corresponding content items, the theme of UI 540, user(s) 140, a user preference or profile, a user avatar, a user input, a context, etc.

For example, the tiles 554 can be organized, categorized, sorted, and/or grouped according to a genre, year, content type, content source, channel, language, country, topic, actor or character associated with the content, content metadata (e.g., length, tag, ratings, title, etc.), history, statistics, relevance to a theme of UI 540, content activity, promoted content or a promotion campaign, a content release date, a content award, a cost, a format, content settings, a compatibility with a device presenting UI 540, a relevance (e.g., relevance to user(s) 140, a group of users, a household of user(s) 140, a geographic location, a country or culture, a season, a context, an activity and/or context of user(s) 140, an event, a trend, a topic, etc.), and/or any other factor.

FIG. 5D illustrate another example user interface (UI) 580 customized based on a theme(s). UI 580 can represent UI 530 in FIG. 5C with one or more updates, a version of UI 530 such as an updated version, a user interface navigated or transitioned from (and/or displayed after) UI 530, or a user interface generated based on (or partly based on) UI 530. For example, UI 580 can include a user interface presented to user(s) 140 after UI 530 in FIG. 5C and/or in response to one or more user inputs provided to UI 530. In some cases, UI 580 can include, represent or provide an example of a user interface displayed after UI 530 in FIG. 5C, UI 530 updated based on one or more user inputs (and/or any other data), or a version of UI 530 further customized and/or modified based at least partly on input answer 566 provided by user(s) 140 in response to the message 564.

For example, the message 564 in FIG. 5C asks user(s) 140 whether user(s) 140 is on the “dark side” or the “light side”. Input answer 566 from user(s) 140 indicates, in the example in FIG. 5C, that user(s) 140 is on the “dark side” or responded that user(s) 140 is on the “dark side”. Input answer 566 can be used to update or modify the user interface or any aspect of the user interface. In FIG. 5D, UI 580 is customized based on the same theme(s) as UI 530 in FIG. 5C, and includes some (or all) of the features (e.g., theme elements, content, configuration, visual attributes, etc.) of UI 530 in FIG. 5C but is further customized and/or modified based on input answer 566.

To illustrate, UI 580 in FIG. 5D includes the same theme(s) as UI 530 in FIG. 5C, which in this example includes a theme pertaining to “May The Fourth Be With You” (and/or an associated space content/franchise). The screen 510 in space building 508 depicts content 582 associated with, selected based on (or for), and/or customized for or based on “the dark side”, such as a video (e.g., a movie, TV show, video clip, etc.), audio, music, video game, animation, and/or any other content associated with “the dark side” from “May The Fourth Be With You” (and/or an associated space content/franchise) and/or associated with or depicting a character(s), scene(s), empire(s), and/or any other aspect(s) associated with the “the dark side” from “May The Fourth Be With You” and/or the space content/franchise associated with “May The Fourth Be With You”.

UI 580 can additionally or alternatively include any other customization or modification implemented based on input answer 566. For example, in FIG. 5D, UI 580 depicts an interface element 584 selected and/or rendered based on input answer 566 specifying the “dark side”. User(s) 140 can select or activate the interface element 584 to access or initiate an experience associated with the “dark side”, such as a video game, animation, movie, stream, channel, application, activity, content, and/or feature associated with the “dark side” (e.g., associated with a scene(s), character(s), location(s), landmark(s), activity, content, empire, and/or any other aspect of the “dark side”). In some cases, the experience accessed or initiated from the interface element 584 can be depicted within or by the screen 510 on space building 508, an interface page/window/etc., a portion of UI 580, and/or any other interface or interface space/portion.

The background 542 of UI 580 (and/or the theme(s) of UI 580) depicts visual elements 584 associated with the “dark side” from the space content/franchise associated with “May The Fourth Be With You”. The visual elements 584 can depict, for example, any character(s), scene(s), symbol(s), color(s), graphic(s), structure(s), object(s), artwork(s), vehicle(s), visual element(s), and/or any other feature(s) associated with the “dark side” or conveying a “dark side” theme.

In some examples, input answer 566 can also be used to update and/or customize a content provided or recommended in UI 580, such as content associated with the “dark side” from the space content/franchise corresponding to the “May The Fourth Be With You” theme, an experience provided by UI 580, a user avatar depicted in UI 580, etc. For example, in FIG. 5D, UI 580 displays a user avatar 590 associated with user(s) 140. The user avatar 590 can depict user(s) 140 (or a representation of user(s) 140), a graphic representing or depicting user(s) 140 such as an avatar graphic, and/or a photo of user(s) 140 (with or without modifications). The user avatar 590 can be customized based on input answer 566 (e.g., to appear to be from the “dark side”, incorporate any feature(s) of the “dark side”, etc.). For example, user avatar 590 can include a photo or representation of user(s) 140 where user(s) 140 is depicted with a helmet from characters from the “dark side” in a space-related movie franchise.

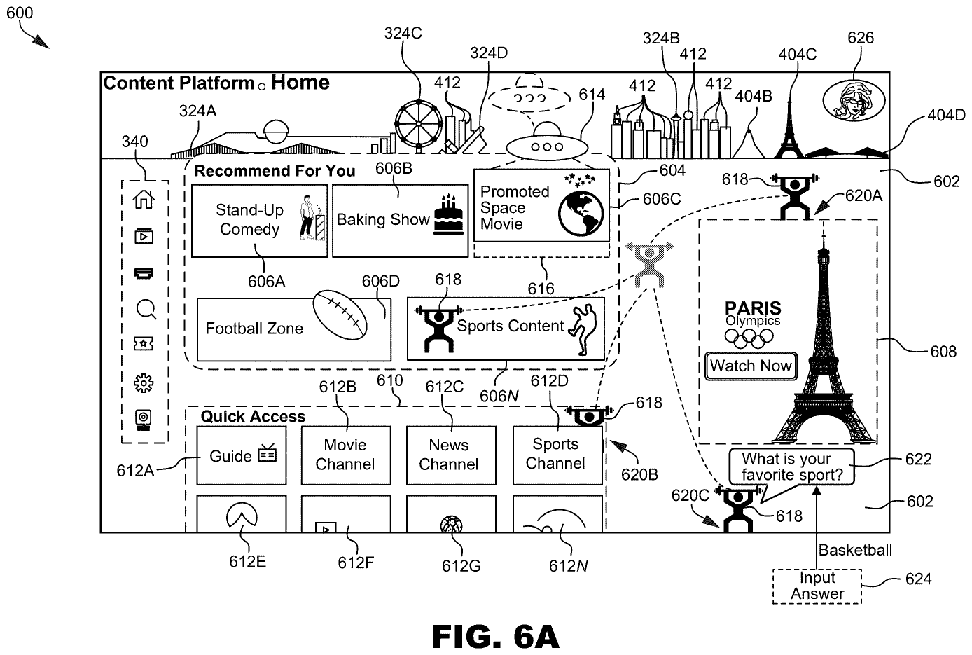

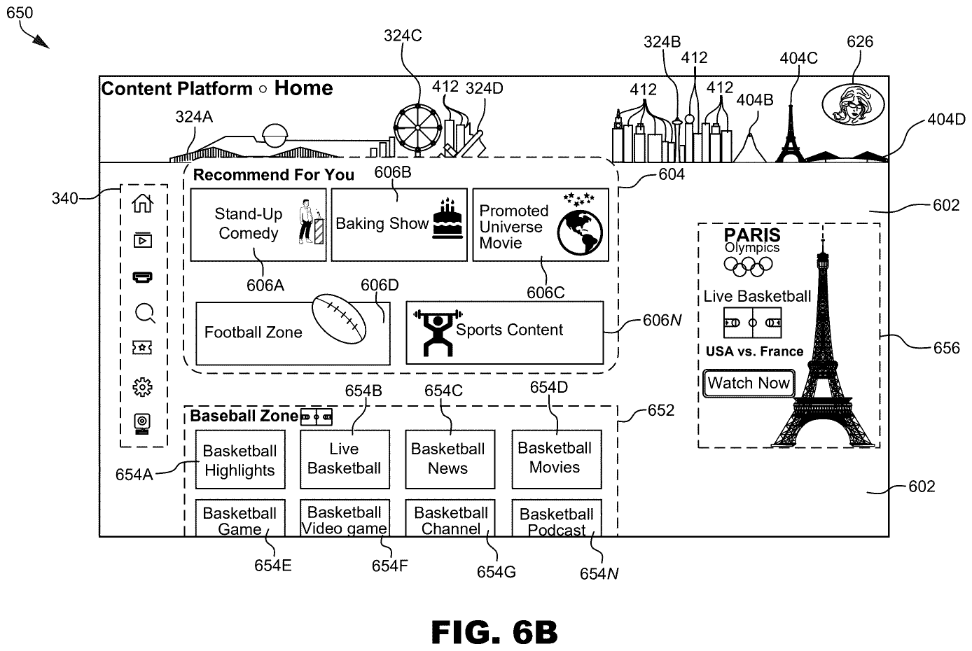

FIG. 6A illustrates another example of a user interface (UI) 600 customized according to a theme(s) and configured to provide immersive experiences. In this example, the UI 600 includes a background 602, a content section 604, promoted content 608, a content section 610, and the menu 340. The background 602 can include background features such as background content, attributes, designs, objects, styles, etc. For example, the background 602 can include one or more images, colors, color schemes, patterns, attributes, objects, characters, content items, artwork, messages, logos, styles, shapes, designs, content item references (e.g., hidden messages or clues, etc.), visual elements, visualizations, visual effects, animations, interface elements, details, artwork, imagery, visual content, screensavers or backdrops, etc.

UI 600 can include, depict, implement, and/or can be customized and/or configured based on a theme(s). The background 602 can be configured or customized based on or according to a theme(s), such as a theme(s) of UI 600 and/or a different theme(s). For example, the background 602 can include one or more elements of a theme, such as one or more colors, attributes, content, artwork, imagery, color schemes, designs, styles, visual effects, visual elements, animations, and/or any other features of a theme of UI 600 (and/or a different theme). In FIG. 6A, the theme(s) of UI 600 and background 602 includes a city theme.

In some cases, the theme (or aspects thereof) of the UI 600 and/or background 602 (e.g., the city theme) can be depicted, implemented, and/or configured using one or more visual elements, such as one or more colors, images, content items, animations, objects, graphics, artwork, interface elements, and/or any other theme elements/features. In FIG. 6A, the visual elements 324A-C, 412, and 404B-D depicted in the UI 600 and background 602 are associated with the city theme. For example, the visual elements 324A-C, 412, and 404B-D can include, implement, provide, depict, convey, and/or incorporate the city theme (and/or aspects thereof), features of the city theme, and/or a look and/or experience associated with the city theme.

To illustrate, the visual elements 324A-C and 404B-D depict things associated with cities (and/or one or more specific cities), such as city bridges, buildings, structures (e.g., parks, benches, roads, garages, etc.), landmarks, cityscapes, scenes, vehicles, a Ferris Wheel, a volcano, etc. Any of the visual element in UI 600 can optionally include or represent a reference to a respective content item. The reference can include or depict a feature (e.g., object, character, message, scene, landscape, landmark, activity, event, animal, graphic, building, structure, animation, content, etc.) associated with the respective content item (e.g., depicted in or within the respective content item, included in or within the respective content item, corresponding or correlated to the respective content item, etc.). In some examples, the reference can include or represent a hidden message or clue associated with the respective content item, such as a reference to something in the respective content item that is added to UI 600 as a hidden message or clue to entertain user(s) 140 (e.g., by testing the ability of user(s) 140 to recognize the visual element as a reference to the respective content item or associate the visual element with the respective content item, by providing the visual element as part of a game or activity such as a scavenger hunt or a trivia challenge, etc.).

A visual element configured as a reference, hidden message, or clue associated with a content item can include and/or depict anything from the content item such as, for example, an object, character, scene, graphic, content item, building, structure, shape, animal, person, vehicle, logo, landmark, infrastructure, animation, element, symbol, pattern, device, and/or any other item associated with the content item. Some or all of the users who view the visual element may be able to associate the visual element with the content item and recognize the visual element as a reference to the content item. Such users can recognize the reference to the content item as part of an immersive/engaging experience with UI 600, as part of a game or activity provided by UI 600 (e.g., a scavenger hunt, a challenge, a trivia game, a questionnaire, a competition with other users, a test of the user's knowledge about the content item, etc.), as part of a challenge that allows users who successfully identify the reference associated with the visual element (and/or a certain number of references associated with a certain number of visual elements) to win benefits (e.g., points, credits, subscriptions, add-on features, discounts, opportunities to be promoted on UI 600 and/or other user interfaces, etc.) for identifying the reference (and/or the number of references), as part of any activity or event, and/or to simply entertain user(s) 140.

In some cases, a visual element (or multiple visual elements) in UI 600 can be associated with a theme(s), content, campaign, and/or promotion associated with UI 600. For example, in FIG. 6A, UI 600 includes promoted content 608 and the visual element 404C depicts the Eiffel Tower from Paris (or a representation thereof). The promoted content 608 in this example includes content related to the Paris Olympics, such as a video, stream, and/or recording of the Paris Olympics (or one or more events of the Paris Olympics. Like the Paris Olympics, the Eiffel Tower is also in Paris and thus similarly relates to Paris. Accordingly, the visual element 404C depicting the Eiffel Tower is also associated with or related to the promoted content 608 depicted in UI 600.

The background 602 (and/or a feature(s) of the background 602 such as a color, pattern, attribute, object, character, content, style, shape, visual effect, screensaver, visual element, interface element, design, animation, characteristic, detail, aesthetics, appearance, etc.) can be predetermined for UI 600 or selected when UI 600 is launched (e.g., dynamically or in real-time).

The content section 604 can include content of or accessible from UI 600. In FIG. 6A, the content section 604 includes content items 606A-N such as movies, TV shows, TV channel feeds, podcasts, video games, etc. The content items 606A-N can optionally be depicted and/or organized in tiles in the content section 604. The content in the content section 604 may or may not be associated with the theme(s) of UI 600. For example, the content can include content selected for or based on the theme(s) of UI 600.

The content in content section 604 can include prioritized content (e.g., prioritized by user(s) 140, a group, the content platform associated with UI 600, a business, a sponsor, etc.), preferred content (e.g., content preferred by or matching a preference of user(s) 140, a user group, a business, the content platform, a sponsor, etc.), sponsored content, promoted content, content associated with a user or group activity and/or statistic (e.g., content having a threshold statistic such as popularity or view/play counts, content previously started by a user or group of users, content selected based on a watch history of a user or group of users, content designated as a favorite or added to a list of content to watch by a user or group of users, etc.), trending content, recommended content (e.g., recommended to a user or group, etc.), contextually-relevant content, content matching a selection criteria, content associated with a weight or bias, etc.

For example, the content items 606A-N (collectively “content items 606” hereinafter) in the content section 604 can include content selected for user(s) 140, content associated with a category (e.g., a new release category, a movies category, a TV shows category, a video games category, a genre category, a ratings category, etc.), content recommended for/to user(s) 140 (and/or a group including user(s) 140), content recommended or suggested by UI management system 130 (and/or by a content platform associated with UI 600), content having a threshold popularity, content having a trend score, content having a threshold relevance to one or more signals/cues, content initiated by user(s) 140 in a current or previous session (e.g., content that user(s) 140 started watching but did not complete), and/or any other content items.

The promoted content 608 can include a content item(s) selected for promotion via UI 600, such as an advertisement, a movie or TV show, etc. The promoted content 608 can additionally or alternatively include content associated with or selected based on a theme of UI 600, content associated with or selected based on a topic or event, a contextually-relevant content (e.g., content having a threshold relevance to a context), content personalized for and/or targeting user(s) 140, and/or any other content. In some cases, the promoted content 608 can include content determined based on a context of user(s) 140 (e.g., content having a threshold relevance to a context associated with user(s) 140), a date (e.g., temporally-relevant content) when UI 600 is displayed, a calendar, a topic (e.g., a topic associated with a previous, current, and/or scheduled event, activity, promotion, trend, etc.), a location associated with user(s) 140 and/or media device(s) 104 (e.g., the device used to display UI 600), and/or any other signal or combination of signals.

For example, if UI 600 is displayed during the Olympics, the promoted content 608 can include a video, channel, page, advertisement, feed, animation, video game, and/or any other content of or associated with the Olympics (or an Olympic event or competition). If UI 600 is presented on election day in the United States, the promoted content 608 presented to users in the United States on election day (and/or within a time period relative to election day) can include a video, channel, feed, page, animation, advertisement, and/or any other content related to the election. If a topic is trending on social media, the promoted content 608 presented while the topic is trending can include content associated with or related to the trending topic.

The content section 610 can also include content items 612A-N (collectively “content items 612” hereinafter). In FIG. 6A, the content section 610 includes a channels section. As such, the content items 612 in the content section 610 can include content channels, such as TV channels, movie channels, media streaming application channels, etc. For example, the content items 612 can include any channels that user(s) 140 has access to, is subscribed to, has an account for, has accessed in a current or previous session, has watched, has added to a favorites list, has added to the content section 610, has interacted with, has requested, has a likelihood of interest in, etc.

UI 600 can optionally include the menu 340. The menu 340 can include menu items such as toolbars or toolbar items, controls, options, content categories, links, etc. For example, the menu 340 can include, without limitation, a search tool, an input (e.g., HDMI, etc.) source setting, a settings menu, a home menu, a movies menu, a TV shows menu, a video camera menu, an input menu, an output menu, a display option, and/or any other menu item. In some cases, the UI 600 can include a user avatar 626. The user avatar 626 can include a picture of user(s) 140 (with or without modification), an AI-generated image of user(s) 140, an image of user(s) 140 generated based on photos of user(s) 140 (e.g., uploaded by user(s) 140, retrieved from a library of user(s) 140 that includes the one or more photos, accessed from a source selected by and/or given access by user(s) 140, etc.), and/or any other visual representation of user(s) 140.

UI 600 can optionally display animations. The animations may or may not relate to any theme of UI 600. The animations can provide an immersive experience for user(s) 140, entertain user(s) 140, help user(s) 140 explore or discover content and/or features on UI 600, educate user(s) 140 about a feature(s) and/or associated functionality, promote content and/or features to user(s) 140, interact with user(s) 140, etc. For example, UI 600 in FIG. 6A includes an animation used to bring the attention of user(s) 140 to content item 606C promoted in UI 600. The promoted content item 606C can include a movie, TV show, advertisement, video game, or any other content. The animation used to bring attention to the content item 606C may or may not relate to the content item 606C and/or a theme of the content item 606C.

For example, in FIG. 6A, the content item 606C being promoted includes a promoted space movie. The animation used to bring attention to the content item 606C includes a spaceship 614. Here, the spaceship 614 can appear in UI 600 while carrying the content item 606C. The spaceship 614 can move while carrying the content item 606C towards a content placement location 616 (e.g., a content slot, tile, destination, space, container, holder, etc.) within UI 600. The content placement location 616 in FIG. 6A is a location within the content section 604 for placing/presenting the content item 606C. When the spaceship 614 is above the content placement location 616, the spaceship 614 can release the content item 606C in order to drop the content item 606C on the content placement location 616. The content item 606C can fall from the spaceship 614 and land on the content placement location 616. The content item 606C can then be displayed at the content placement location 616 within the content section 604.

UI 600 in FIG. 6A displays another animation. The other animation can be part of an activity, such as a game (e.g., a scavenger hunt, a search game, etc.), and/or can be used to entertain user(s) 140, draw the attention of user(s) 140 to something in UI 600, and/or interact with user(s) 140. For example, the content item 606N in content section 604 is a sports content item and depicts an athlete 618. As part of the animation, the athlete 618 can appear to jump or climb out of the content item 606N and move to another portion/region of UI 600. In some examples, the athlete 618 can move to a location 620A on top of the promoted content item 608 and appear to sit or stand on the promoted content item 608. This way, the athlete 618 and the animation of the athlete 618 can draw an attention of user(s) 140 to promoted content item 608, which may help highlight or promote that content item and/or draw user(s) 140 to access that content item.

In another example, athlete 618 can jump or climb out of content item 606N and move to location 620B in UI 600 to draw the attention of user(s) 140 to location 620B. Here, the location 620B is behind content item 612D. The athlete 618 can hide behind the content item 612D to draw the attention of user(s) 140 to the content item 612D (e.g., to promote or highlight the content item 612D, etc.), drive user(s) 140 to the content item 612D, entertain user(s) 140, or as part of a game or activity such as a scavenger hunt.

In another example, the athlete 618 can jump or climb out of the content item 606N and move to location 620C in UI 600. At location 620C, UI 600 can present a prompt 622 from the athlete 618 asking a question to user(s) 140. In some examples, the question can be part of an activity, such as a game, provided to user(s) 140, and/or an experience provided to user(s) 140. The question can additionally or alternatively be used to seek information from user(s) 140. Such information can be used to enhance a content experience of user(s) 140, recommend content to user(s) 140, customize the content depicted and/or provided via UI 600, modify or customize UI 600 (or any aspect thereof) for user(s) 140, customize the user avatar 626, select a user profile associated with user(s) 140, customize what content and/or features are provided to user(s) 140 on UI 600, customize a theme of UI 600, test user(s) 140 as part of a game or challenge, etc.

In FIG. 6A, prompt 622 includes a question asking user(s) 140 what is the favorite sport of user(s) 140. User(s) 140 can provide an answer to the question. UI management system 130 can optionally use the answer from user(s) 140 to customize an experience of user(s) 140, gather information from user(s) 140, interact with user(s) 140, customize UI 600 (and/or any aspect thereof such as a content thereof, the user avatar 626, etc.), customize another page or user interface presented to user(s) 140, etc. For example, user(s) 140 can provide input answer 624 in response to the question in the prompt 622. In this example, input answer 624 indicates that basketball is the favorite sport of user(s) 140.

UI management system 130 can use input answer 624 to modify or customize any aspect of UI 600, customize another user interface, customize a content experience for user(s) 140, etc., as previously explained. For example, with reference to FIG. 6B, UI management system 130 can use input answer 624 to provide a UI 650 personalized to user(s) 140. The personalized UI 650 in FIG. 6B can include or represent a version of UI 600 shown in FIG. 6A that is personalized to user(s) 140 based on input answer 624.

As shown, UI 650 replaces content section 610 in FIG. 6A, which includes quick access content items, with content section 652 in FIG. 6B. The content section 652 is named “Basketball Zone” in FIG. 6B because it includes content items 654A-N (collectively “content items 654” hereinafter) from a basketball category. The content items 654 can include, for example, basketball movies, shows, news, games, video highlights, video games, documentaries, channels, media applications, podcasts, XR experiences, and/or any other content items associated with basketball.

For example, in FIG. 6B, the content item 654A includes a basketball highlights video and/or a tile that user(s) 140 can use to access basketball highlight videos, content item 654B includes a live basketball stream or a tile that user(s) 140 can use to access live basketball streams, the content item 654C includes a basketball news feed and/or a tile that user(s) 140 can use to access basketball news feeds, the content item 654D includes a basketball movie and/or a tile that user(s) 140 can use to access basketball movies, the content item 654E includes a video of a basketball game, the content item 654F includes a basketball video game, the content item 654G includes a basketball channel (e.g., a channel that includes basketball content such as news, live streams, videos such as movies and TV shows, etc.), and the content item 654N includes a basketball podcast. As shown, the content items 654 are tailored to include basketball content based on input answer 624 indicating that user(s) 140 favorite sport is basketball.

Input answer 624 from user(s) 140 can additionally or alternatively be used to personalize other aspects of UI 650. For example, in FIG. 6B, UI 650 includes another promoted content item 656. Like promoted content item 608 in UI 600 shown in FIG. 6A, the promoted content item 656 in UI 650 also relates to the Paris Olympics. However, the promoted content item 656 in FIG. 6B is personalized based on input answer 624 to include basketball content. As shown, in this example, the promoted content item 656 includes a live basketball game from the Paris Olympics being promoted to user(s) 140 such that the promoted content item 656 is more specifically tailored to include basketball content from the Olympics, instead of more generally relating to the Olympics.

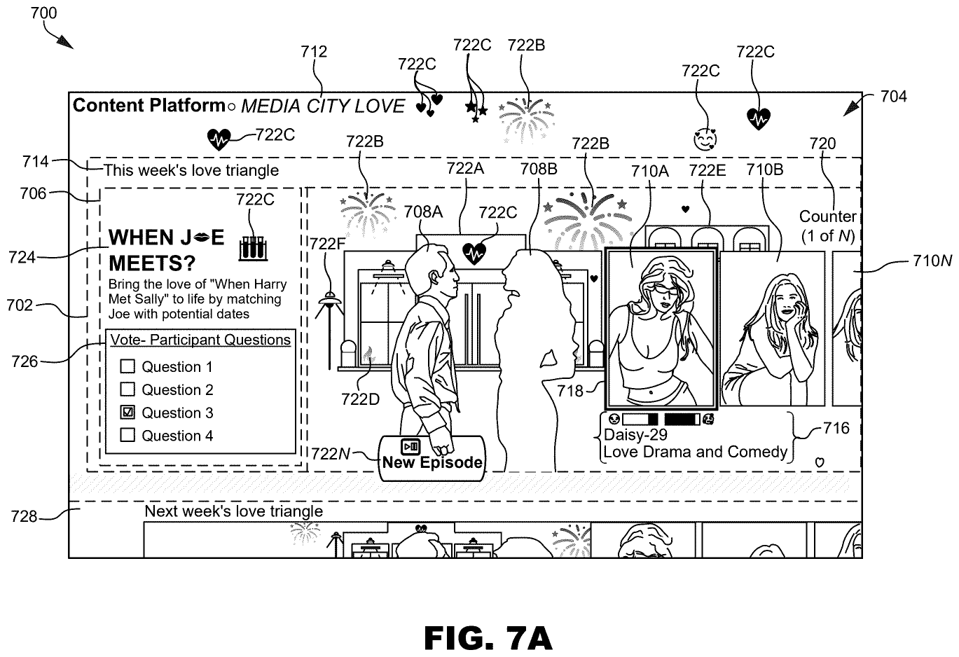

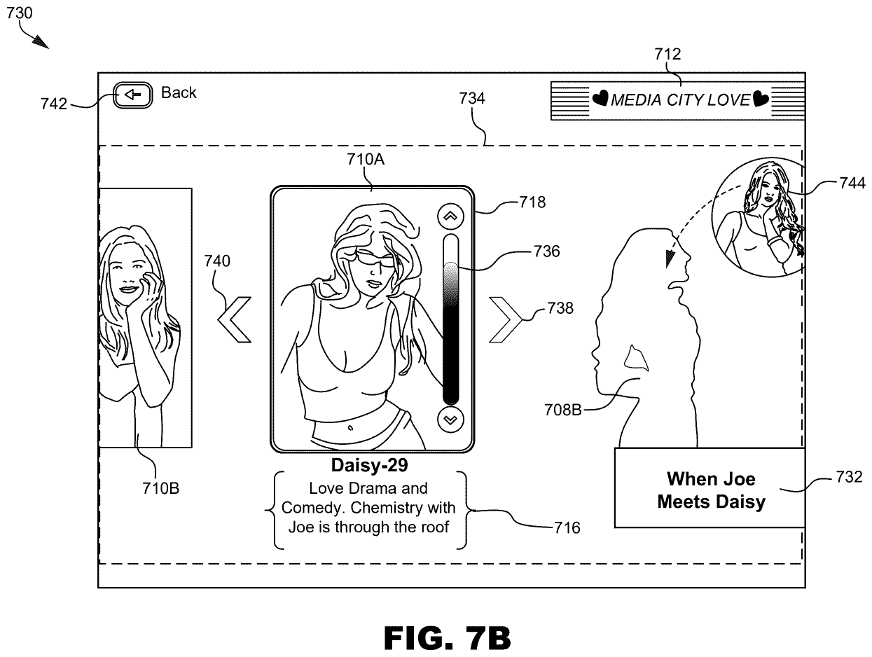

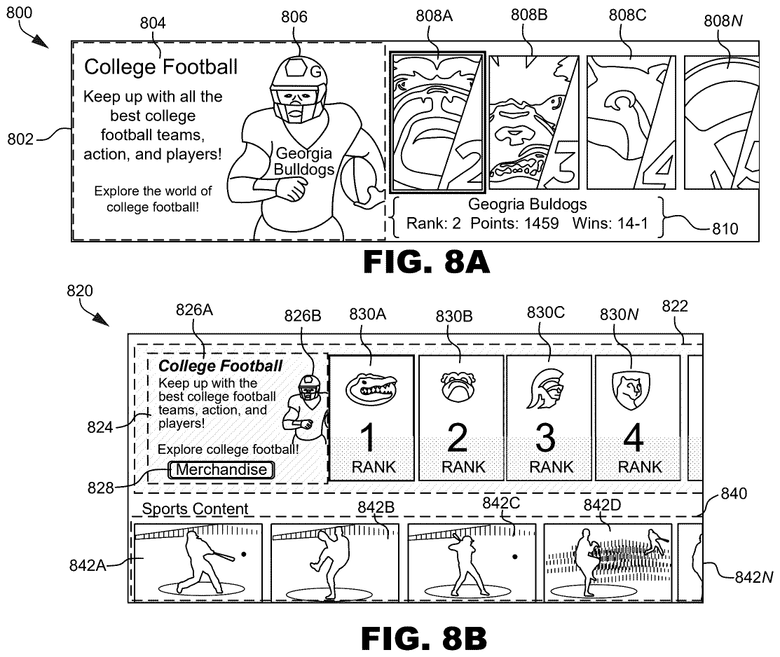

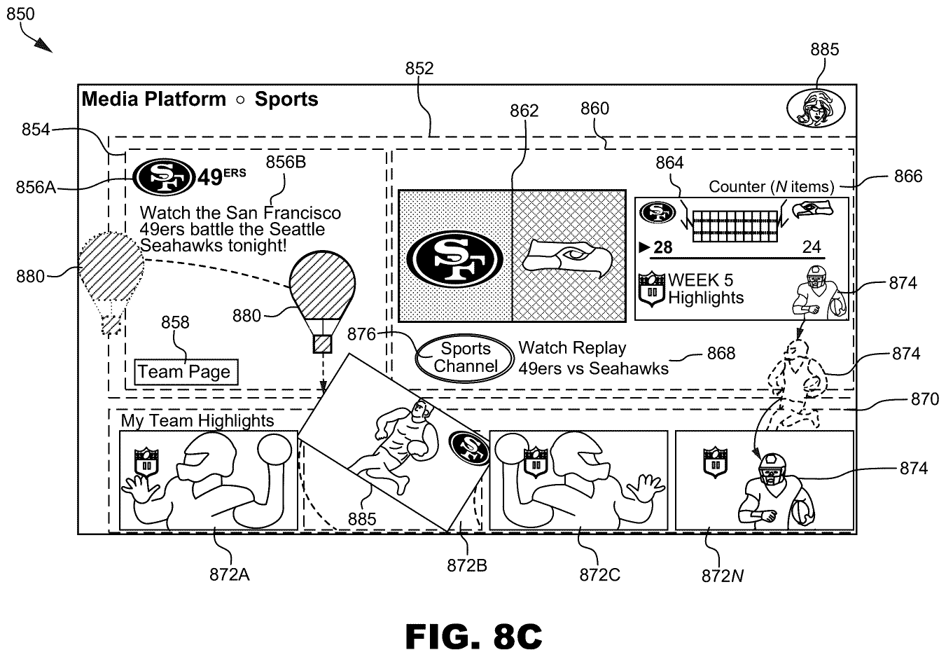

Input answer 624 can additionally or alternatively be used to customize other aspects of UI 650, such as the background 602 of UI 650, the theme(s) of UI 650, the content section 604, the user avatar 626, and/or any other aspect of UI 650. The user interfaces described herein can organize, display, arrange, and/or provide content, graphics, and/or UI elements (e.g., tiles, cards, buttons, controls, badges, sheets, sliders, menus, overlays, tabs, popups, textboxes, carousels, knobs, tooltips, input elements, links, boxes, scrollbars, contextual menus, pickers or selectors, checkboxes, dropdowns, navigation elements, snackbars, toggles, etc.) any UI element, design, and/or configuration. In some cases, a user interface described herein can organize, display, arrange, and/or provide content, graphics, and/or UI elements (e.g., tiles, cards, etc.) within a UI row or column (e.g., frameless or with frames/borders), a UI container such as a UI banner or UI section container that includes content and/or UI elements (e.g., tiles, cards, etc.), an interface page, a window or inline frame (iframe), and/or any other UI element, design, and/or arrangement. For example, a user interface can organize, display, and/or provide content and/or UI elements such as tiles and/or cards in one or more rows, columns, or UI containers (e.g., UI banners, UI sections, etc.) customized based on a theme(s), such as the UI containers displayed by the user interfaces illustrated in FIGS. 7A-8C.

A UI container can include a layout and/or container element used to group, organize, arrange, contain, provide, hold, and/or display items (e.g., content, UI and/or page elements, graphics, call-to-action components, etc.) within the user interface such as, for example and without limitation, a frame (e.g., a window, viewport, etc.) with or without a visible border, a section container that groups items into a section (e.g., a sidebar, a footer, a header, etc.), a UI banner with or without a visible border (e.g., frameless or with a visible frame), a grid container that arranges items into a grid layout, a card container configured to display items (e.g., text, graphics, UI elements, content, etc.) within a card-like design (e.g., within a square or rectangle card), a box (e.g., a horizontal box, a vertical box, etc.), a modal container containing or holding a modal window or dialog box, a scroll container with scrolling functionality, a panel container that includes a visual border or frame around items within the panel container, a tile, center container that contains items that are centered within the center container, a split container that divides a space into sections, and/or any other layout and/or container element.

In some cases, a UI container can include a UI banner. A UI banner can include one or more rows or columns of items such as content, animations, text, UI elements (e.g., UI cards, tiles, call-to-action elements, input elements, display elements, etc.), and/or any other features. The UI banner (or any other UI container) can include items, group and/or organize items, convey information, provide a content experience (e.g., an immersive experience such as a game or activity, a call-to-action, etc.), surface information, provide a customized experience, etc. The UI banner (or any other UI container) may or may not include, depict, and/or implement/incorporate a theme(s), such as a theme of the user interface and/or a different theme. In some cases, the UI banner (or any other UI container) can tailor an appearance, content, experience, feature(s), and/or attribute(s) of the UI banner (or the other UI container) or a presentation of items in the UI banner (or the other UI container) based on one or more factors. For example, a UI container (e.g., UI banner) can be tailored to and/or configured based on a user, a group, a theme, an event, a topic, a context, a situation, a season, a date, an activity, a genre, a culture, a cultural event or topic, a location or region, a language, etc. A UI container can be part of a design, structure, appearance, organization, interactive/immersive experience, and/or feature of the user interface.

FIG. 7A illustrates an example of a user interface (UI) 700 customized based on a theme(s) and including a UI container 702. UI 700 includes a UI container 702. In this example, UI container 702 is a UI banner. However, the UI banner is merely one illustrative example UI container provided for explanation purposes. One of ordinary skill in the art will recognize from the disclosure that the UI container 702 can include any other type of layout and/or container element such as, for example and without limitation, a frame or iframe, a section container, a grid container, a card container, a box (e.g., a horizontal box, a vertical box, etc.), a modal container, a scroll container, a panel container, a tile, a split container, etc.

UI 700 can optionally include a text portion 712 and/or background 704. The text portion 712 can display any text content, such as a title of UI 700 (e.g., a title of a page displayed by UI 700), a text description of UI 700 (e.g., a text description of a page displayed by UI 700), a title or description of a theme(s) associated with UI 700 (e.g., associated with a page displayed by UI 700) and/or the UI container 702, a textual message, etc.

UI container 702 can include, depict, host, organize, and/or contain content (e.g., text, visual content, content items, etc.), UI elements (e.g., UI cards, tiles, call-to-action elements, input elements, etc.), a content experience(s), and/or any other feature(s). The UI container 702 can optionally include a title 714. The title 714 can include a title of content in the UI container 702, a title or description of a theme of the UI container 702, a title or description of a content (e.g., TV show, movie, podcast, video game, livestream, etc.) associated with the UI container 702 and/or a theme of UI container 702, a title or description of an episode of a content item associated with the UI container 702 and/or a theme of the UI container 702, and/or any other features of the UI container 702 and/or a theme of the UI container 702. The UI container 702 can include one or more content items (e.g., videos, images, video games, links, interface elements, audio content items, text content items, graphics content, interactive content, animated content, visual content, movies, TV shows, podcasts, etc.), sections, UI elements, spaces, rows, grids, and/or the like.

In FIG. 7A, UI container 702 is a UI banner. The UI banner can have a static or dynamic shape, such as a static or dynamic width and/or height. The banner width can span the width of, or less than the width of, UI 700, and the banner height can span the height of UI 700 (e.g., if the banner width does not span the width of UI 700) or less than the height of UI 700. The banner width is a width of the UI container 702. For example, the banner width can include a distance between a vertical edge (e.g., left or side border) of the UI container 702 extending vertically (e.g., along a y or vertical plane) from a point on a horizontal axis (e.g., an x axis) and an opposite edge of the UI container 702 extending vertically (parallel to the other vertical edge) from a different point on the horizontal axis. The banner height can represent a height of the UI container 702. For example, the banner height can include a distance between a horizontal edge (e.g., top or bottom) of UI container 702 extending horizontally (e.g., along an x or horizontal plane) from a point on a vertical axis (e.g., y axis) and an opposite horizontal edge of UI container 702 extending horizontally (parallel to the other horizontal edge) from a different point on the vertical axis.

The UI container 702 can be placed, arranged, and/or depicted on or across a specific region(s) of UI 700. For example, in some cases, the UI container 702 can be located across a top portion of UI 700 such that a top edge of the UI container 702 (e.g., an edge along an x or horizontal plane) overlaps with a top edge of UI 700 and an opposite edge of the UI container 702 (e.g., a bottom edge of the UI container 702 that is opposite and parallel to the top edge of the UI container 702) is located away from the top edge of the UI container 702, in a direction towards a bottom edge of UI 700, by a distance that is equal to the banner height. In other cases, the UI container 702 can be located across a bottom portion of UI 700 such that a bottom edge of the UI container 702 along an x or horizontal plane overlaps with a bottom edge of UI 700 and a top edge (e.g., opposite/parallel to the bottom edge) of the UI container 702 is located away from the bottom edge of the UI container 702, in a direction towards a top edge of UI 700, by a distance that is equal to the banner height. In other cases, the UI container 702 can be located across another portion of UI 700 such as a middle portion or any other portion where a top edge of UI container 702 is below a top edge of UI 700 and a bottom edge of UI container 702 is above a bottom edge of UI 700.

In some cases, the UI container 702 can be shaped as a column (and/or contain items arranged in a column) and/or located within a column of UI 700. The column can have one edge along a vertical plane (e.g., a y plane) that overlaps with a left or right edge of UI 700 (e.g., along the vertical plane) and an opposite edge that extends towards an opposite edge of UI 700 by a distance that is equal to the banner width. In other cases, the column (or an edge thereof) of UI 700 may not overlap with a left or right edge of UI 700 (e.g., along the vertical plane).

The UI container 702 can be configured according to any size or shape, such as a rectangular, shape, column, row, grid, circular, elliptical, and/or any other shape. While the UI container 702 in FIG. 7A is shaped as a rectangle and includes items arranged in a row, the UI container 702 can have any other shape and/or arrange items in the UI container 702 in any other grouping, arrangement, placement, and/or configuration. For example, the UI container 702 can be configured as (and any items in UI container 702 arranged in) a column, cloud, square, table, grid, circle or ellipse, or any other arrangement, shape, configuration, etc. The row configuration in FIG. 7A is merely one illustrative example provided for explanation purposes. Moreover, one of ordinary skill in the art will recognize from the disclosure that the UI container 702 can include any size (e.g., width, height, etc.), placement, design, and/or configuration not shown in FIG. 7A.

UI 700 and/or UI container 702 can be customized based on a theme(s). The theme(s) can be determined based on a topic(s), which can be selected based on one or more signals. In FIG. 7A, UI 700 and UI container 702 are customized according to a romantic city theme. The romantic city theme is selected based on a topic of and/or that includes a reality TV dating show. The reality TV dating show can include a show involving a dating or matchmaking competition. The reality TV dating show and/or romantic city theme in this example can be based on, have a threshold relevance to, associated with, inspired by, and/or targeted to viewers/fans of a romantic comedy film (e.g., “When Harry Met Sally”). The reality TV dating show includes contestants/participants who compete for a date, relationship, and/or romance with a main character (e.g., a bachelor) named Joe. The show starts with contestants/participants engaging in challenges (e.g., activities) and/or having dates with Joe in the hopes of being picked by Joe. At the end of each round, Joe selects one or more contestants to remain in the show and at least one contestant to be eliminated from the show. The show includes a number of such rounds where contestants/participants are selected to stay or leave (e.g., be eliminated) until a winner is selected.

The show may be selected as the source of the romantic city theme based on a relevance of the show (e.g., a relevance to a day when UI 700 is presented, a relevance to user(s) 140 or a user preference, a relevance of a release date of the show to a date when UI 700 is presented, a relevance to a user group or demographic, a relevance given a trend/popularity metric associated with the show, a relevance given a statistic associated with the show, a relevance to a context associated with user(s) 140, etc.). For example, if the show airs on the day when UI 700 is presented, the show may be identified as a relevant topic on that day. The topic associated with the show can be used to select the romantic city theme.

As another example, if UI management system 130 determines that the reality dating show is a trending topic (e.g., based on a threshold number of views, social media posts/comments, references in other content and/or a public discourse, purchases, subscriptions, votes for contestants, etc.), UI management system 130 may select the show as a topic used to determine a theme for UI 700 and/or UI container 702. UI management system 130 can use such topic to select the romantic city theme. The show is one example of a topic or a content item used as the basis of a topic used to select a theme for UI 700 and/or UI container 702, and the romantic city theme is one example theme implemented by UI 700 and UI container 702. In other examples, UI 700 and/or UI container 702 can implement a different theme, and the selected theme can be based on a different topic (e.g., a different event, content, condition, context, factor, etc.).

The UI container 702 can optionally promote certain content such as the reality TV dating show (or an episode or merchandise thereof), a sponsor content, an advertisement, and/or other content. The configuration and/or design of UI 700 and UI container 702 (e.g., the content, layout, artwork, visual attributes, UI elements, shape, arrangement, content experiences, visual effects, visual elements, colors, color schemes, images/imagery, background, content elements, organization, style, and/or any other features) can be customized based on the romantic city theme, immerse users in the theme, engage users via the theme, etc. In some cases, as part of the romantic city theme, the UI container 702 can include content associated with the reality TV dating show, display information about the show, include interactive content (e.g., a game/activity) associated with the show, depict features (e.g., visual elements, artwork, colors, logos, patterns, designs, attributes, etc.) associated with the show, display a background associated with and/or based on the show, display characters and/or objects associated with the show, include visual content and/or interface elements associated with the show and/or the associated romantic city theme, etc.

To illustrate, if the reality TV dating show is associated with a certain background (e.g., because a content item used to promote the show includes that background, that background resembles a background depicted in the show or a scene of the show, that background matches or has a similarity to a background in an advertisement or other content or event of the show, etc.), UI 700 and/or UI container 702 can depict that background or a background configured based on that background (e.g., a background that has a threshold similarity and/or relevance to that background associated with the show, a background that has a particular color or color scheme of that background associated with the show, etc.). This way, the background used for the theme of the UI container 702 can be based on or have a correlation, relationship, similarity, and/or resemblance to a background associated with the show (e.g., the background of the UI container 702 can relate, convey, resemble, and/or be attributed or associated by users to the show).

As another example, if the show has previously depicted (or is known for depicting) contestants in a school yearbook format with a grid of thumbnails containing pictures of contestants, the UI container 702 may depict contestants (e.g., representations of contestants, content items depicting the contestants and/or representations thereof, etc.) of the show within the UI container 702 in a school yearbook format that includes a grid of thumbnails. This way, the theme of the UI container 702 can include a format/configuration that matches, relates to, resembles, correlates to, has a similarity to, and/or is attributed or associated by users to the show.

In FIG. 7A, UI 700 and UI container 702 include a background 704. The background 704 can optionally be based on, depict, include, and/or implement/incorporate a theme(s). The theme(s) may or may not include a theme(s) of UI 700 and/or UI container 702, such as the romantic city theme. For example, the background 704 can include content, a backdrop or background image, a screensaver, a scene (e.g., a landmark, a building, a house, a cityscape, etc.), one or more visual elements, one or more features (e.g., one or more colors, shapes, patterns, images, designs, color schemes, animations, videos, content items, interface elements, graphics, views, objects, artwork, etc.), a visual attribute(s), animated content, a background style(s), a background design(s), a background content organization/arrangement, content item references (and/or hidden messages or clues), and/or any other features which may or may not depict, include, and/or implement/incorporate the romantic city theme of UI 700 and UI container 702, and/or may or may not be associated with (e.g., from, of, inspired by, related to, based on, corresponding to, etc.) the reality TV dating show associated with the romantic city theme.

To illustrate, the background 704 may depict a house where the reality TV dating show (or any scene or portion thereof) takes place or is filmed, a house where contestants of the show live during the show, something from or depicted in the show (e.g., a house, a scene, an object, a character, a logo, a color scheme, a landmark, a view, a building, a structure, an animal, a vehicle, a view, a graphic, etc.), one or more features (e.g., one or more visual elements, colors, color schemes, attributes, objects, graphics, artwork, images, animations, content items, scenes, etc.) associated with the show, visual elements associated with the show, etc. The one or more features associated with the show can include features from the show, correlated to the show, selected based on the show, and/or designed to invoke or convey a mood, scene, and/or motif (e.g., a dating, romantic, night, and/or any other mood, scene, and/or motif) associated with (e.g., that matches, relates to, corresponds to, has a threshold relevance to, has a threshold similarity to, is based on, conveys, includes, etc.) a mood, scene, and/or motif of the show.

The background 704 can additionally or alternatively include a theme(s) that is different from a theme(s) of UI 700 and/or UI container 702. For example, the background 704 can include a theme(s) that is different from the romantic city theme of UI 700 and UI container 702. The background 704 can implement such theme(s) in addition to or instead of the romantic city theme.

UI 700 and/or UI container 702 can include visual elements 722A-N (collectively “visual elements 722” hereinafter). The visual elements 722 can be part of the theme of UI 700 and/or UI container 702 (e.g., the romantic city theme), selected based on such theme, associated with such theme, configured based on such theme, customized according to such theme, used to implement such theme, and/or configured to depict an aspect of such theme. For example, visual element 722A depicts a building from the reality TV dating show associated with the romantic city theme of UI 700 and UI container 702, the visual elements 722B depict fireworks to convey a romantic mood, the visual elements 722C include romantic emojis (e.g., emojis determined to convey a romantic mood or motif such as heart emojis, star emojis, smiling face emojis, a chemistry emoji, etc.), the visual element 722 depicts a fireplace inside of the building associated with the visual element 722A which provides a romantic mood (e.g., is associated with a mood classified as a romantic mood) and represents a content item reference that relates to the romantic city theme (e.g., is a reference to a fireplace in a movie or TV show and can optionally represent a hidden message or clue associated with that movie or TV show), the visual element 722E depicts a building from a romantic movie and is part of the romantic city theme and represents a reference to the romantic movie (and optionally a hidden message or clue associated with the romantic movie), the visual element 722F depicts a lamp from a romantic city scene in a movie and is part of the romantic city theme (and can optionally represent a hidden message or clue associated with that movie), and visual element 722N depicts an object promoting an episode of the reality TV dating show associated with the romantic city theme.

The visual element 722N can optionally include a link or selectable object that user(s) 140 can select or activate to access and/or watch the episode of the reality TV dating show promoted by the visual element 722N, play/stream the episode, navigate to a destination where user(s) 140 can watch or play/stream the episode, load the episode, purchase the episode, subscribe to the episode (or a channel or application that has the episode and can be used to watch the episode), and/or access information and/or content associated with the episode.

In some cases, the UI container 702 can include one or more sections (e.g., one or more content sections, interface spaces, interface frames, etc.). For example, the UI container 702 can optionally include a section 706 that includes one or more features (e.g., content, UI elements, information, etc.) associated with the UI container 702, the theme of the UI container 702, and/or the reality TV dating show associated with the theme of the UI container 702. In FIG. 7A, the section 706 includes a text portion 724 and a UI element 726. The text portion 724 includes information about the reality TV dating show such as a title of the show, a summary or description of the show, a schedule of the show, information about an episode(s) of the show, information about a status of a competition associated with the show, sponsored content associated with the show, and/or any other content and/or information.

In some cases, the UI element 726 can include content and/or a content experience, such as an interactive content or experience associated with the reality TV dating show (e.g., a game, challenge, survey, prompt, activity, animated interactive experience, XR experience, option to submit a vote associated with the show, etc.). For example, in FIG. 7A, the UI element 726 includes a prompt with a question. The prompt can allow user(s) 140 to vote on a question that the main character (e.g., the bachelor) Joe in the reality TV dating show should ask the remaining participants of the show in a future round or challenge. In other cases, the prompt may additionally or alternatively include other voting options, such as options to vote for remaining participants from the show, options to vote on a predicted or preferred winner of the show, options to vote on activities or challenges for the remaining participants in the show, options to vote on outfits that Joe or any participant(s) can wear in a round or challenge/activity, and/or other voting options.

In some cases, the UI container 702 can include an image 708A of Joe, who is the main character (e.g., the bachelor) from the reality TV dating show. The UI container 702 can optionally include a silhouette 708B depicting an outline of a participant of the show (e.g., a winner of the show or a round, an eliminated participant, a participant with the highest or lowest votes, etc.) or an image of any participant of the show. In some cases, the silhouette 708B may not initially depict a specific person but can be subsequently updated to display (e.g., to be filled in with an image of) a specific person (e.g., a participant, a user, etc.), such as a winner of the show or a winner of a round of the show such that the silhouette 708B initially depicts a representation of an unknown participant (e.g., depicts an outline of a non-specific person) but is later updated to depict a specific participant (e.g., once the participant is known/selected).

In some cases, the silhouette 708B may depict or be updated to depict a user, such as user(s) 140 or a winner of a game associated with UI 700. For example, the silhouette 708B can be updated to depict or be filled with an image of user(s) 140 such as a real picture of user(s) 140, an image of user(s) 140 generated by UI management system 130 (e.g., via an AI/ML model), an image of user(s) 140 customized by UI management system 130, an image of user(s) 140 from an avatar of user(s) 140 or photo album of user(s) 140, or any other representation of user(s) 140.

In some examples, the UI container 702 can include UI elements, such as tiles, cards, navigation elements, interactive elements, section elements, container elements, display elements, input elements, visual elements, and/or any other elements. In FIG. 7A, the UI container 702 includes tiles 710A-N (collectively “tiles 710” hereinafter). The tiles 710 in this example are associated with the reality TV dating show. The tiles 710 include images, thumbnails, or profiles of contestants (e.g., participants) in the show in order to show the contestants who will compete in the show (e.g., contestants competing in a current and/or upcoming round of the show such as contestants who have not been eliminated from the show). The tiles 710 can be static (e.g., not selectable or dynamic), dynamic, or interactive. For example, the tiles 710 (or a portion thereof) can be selectable to retrieve information about an associated contestant, interact with content associated with the associated contestant, provide an input associated with the contestant (e.g., vote for the contestant, submit a request for the contestant, purchase merchandise associated with the contestant, etc.), play/stream content associated with the contestant (e.g., videos with the contestant, highlights or video clips of the contestant, portions of the show that include the contestant, etc.), and/or initiate an activity associated with the contestant.

To illustrate, if user(s) 140 selects the tile 710A corresponding to the contestant named “Daisy”, UI 700, the UI container 702, or the tile 710A can display or load content associated with Daisy (e.g., a page, tile, showcase banner, window, interface, inline frame, video, image, tile content, etc.) such as personal information about Daisy, historical data associated with Daisy, votes received by Daisy from voting users, statistics of Daisy, and/or any information. In another example where the tile 710A is selectable to initiate an interactive experience, if user(s) 140 selects the tile 710A, UI 700, the UI container 702, or the tile 710A can load a game such as a reality game or a game with Daisy as a character (and/or themed according to the reality TV dating show). User(s) 140 can participate in the game as Daisy or control (or request) actions of Daisy in the game. If the tiles 710 are configured to allow users to cast votes for corresponding contestants, user(s) 140 can select the tile 710A to cast a vote for Daisy (or select any other tile to vote for any other contestant) and optionally view information about Daisy such as votes or a percentage of votes received by Daisy (e.g., relative to other contestants).

In some cases, the UI container 702 can display other types of tiles. For example, the UI container 702 can display tiles of content items that user(s) 140 can access, watch, play, and/or interact with via such tiles. To illustrate, the UI container 702 can display tiles of videos, movies, TV shows, live streams or broadcasts, applications, channels, etc., which may or may not relate to the reality TV dating show, any of the contestants of the reality TV dating show, and/or the romantic city theme. The tiles 710 in the UI container 702 can include or correspond to contestants of the reality TV dating show. However, in some cases, the tiles 710 may correspond to other things. For example, the tiles 710 can correspond to content items available to user(s) 140 through the UI 700 and the UI container 702, such as previous episodes of the show, recap or replay videos of episodes from the show, other shows (e.g., other matchmaking reality shows and/or any other type of reality shows), movies and/or TV shows (e.g., movies and/or TV shows related to a theme of the reality TV dating show, such as romance movies and/or TV shows), etc.

The UI container 702 can optionally display metadata associated with any of the tiles 710. The metadata of a tile can be displayed relative to that tile (e.g., under, next to, above, adjacent to, inside/within, etc.). In FIG. 7A, the UI container 702 includes a metadata section 716 below the tile 710A of Daisy. The metadata section 716 can include information about an associated tile/content (e.g., Daisy) and/or any associated information, UI elements, visual elements, etc., such as a voting meter, emojis, symbols, statistics, merchandise, a call-to-action (CTA), etc. In this example, the metadata section 716 includes a name and age of the contestant associated with the tile 710A (Daisy), information about the contestant (e.g., Daisy loves true crime and stand-up), and voting meters or bars indicating how many votes have been cast for and against the contestant. One of ordinary skill in the art will recognize from the disclosure that the metadata section 716 can include other information, in addition to or instead of what is shown in FIG. 7A.

In some cases, each of the tiles 710 can include its own metadata section. In other cases, only a subset of the tiles 710 may include a respective metadata section. The metadata section 716 is displayed for the tile 710A of Daisy because the tile 710A has been selected by user(s) 140, as depicted by the outline 718 (or highlight) around the tile 710A. In other cases, the UI container 702 can include a respective metadata section for the tile corresponding to the contestant with the most votes (or top n number of tiles corresponding to top n number of contestants with the most votes) or the tile(s) corresponding to any other contestant(s) (e.g., a favorite or most popular contestant(s) to user(s) 140 or an audience, a contestant(s) that has been selected to continue to a next round or eliminated from a next round, etc.). In some examples, when user(s) 140 selects a tile, UI 700 can update a presentation of the tile to show that the tile has been selected. For example, in FIG. 7A, tile 710A includes an outline 718 to show that the tile 710A was selected.

In some examples, if the tiles contained/hosted in/by the UI container 702 (e.g., the number of tiles included based on the number of participants or remaining participants in the show) do not fit within the display area of the UI container 702, the UI container 702 can be configured to allow users to scroll to other tiles to see the other tiles and/or change which tiles are shown within the UI container 702. For example, in FIG. 7A, tile 710N does not fit entirely within a current view of UI 700 and is partially truncated. However, the UI container 702 may be scrollable to allow user(s) 140 to scroll through the UI container 702 to bring the rest of the tile 710N (and, optionally, any other tiles that are not shown in FIG. 7A) within view (e.g., within a view of UI 700). In some cases, rather than truncating a tile that does not fit within UI 700 (e.g., instead of showing a partial tile), the UI container 702 may remove the tile from a current view of UI 700 such that user(s) 140 would need to scroll the UI container 702 to see that tile.

In some cases, rather than truncating or excluding any tiles, UI 700 can resize any of the tiles 710 so the tiles 710 fit within a view of UI 700 and tile 710N is not truncated (partially shown). When resizing tiles, the overall size (e.g., the height and/or width) and/or aspect ratio of all or some of the tiles 710 can be increased or decreased. The tiles 710 can have (e.g., be displayed according to) a same size and/or aspect ratio, or different sizes and/or aspect ratios. For example, to highlight or promote a tile(s), the size and/or aspect ratio of the tile(s) can be adjusted (e.g., increased) relative to other tiles to convey/indicate that such tile(s) is highlighted or promoted.

The size and/or aspect ratio of the tiles 710 and/or number of tiles within a view of UI container 702 without requiring a user to scroll UI container 702 can depend on one or more factors. The one or more factors can include, for example, a size of a screen used to display UI 700, a resolution of the screen, a size of UI 700 (e.g., a window size or a height and width of UI 700), user preferences, a resolution of the tiles 710, a layout of the tiles 710 (e.g., landscape, portrait, etc.), an amount of space within the UI container 702 used by other content/elements in the UI container 702 (e.g., text section 706, image 708A, silhouette 708B, etc.), a type of device (and/or device characteristics) used to display UI 700 (e.g., a TV, computer display or monitor, smartphone screen, smart glasses, HMD, smartwatch display, etc.), and/or any other factors.

In some cases, each of the tiles 710 can have a same shape and/or layout. In other cases, the shape and/or layout of the tiles 710 (or some of the tiles 710) can vary. For example, the tiles 710 can all be depicted in a landscape or portrait layout. In other cases, one or more of the tiles 710 can be depicted in a particular layout and one or more other tiles can be depicted in a different layout. To illustrate, tiles 710B and 710N can be depicted in a portrait layout and tile 710A can be depicted in a landscape layout (or vice versa) because tile 710A is selected/highlighted (e.g., to show that tile 710A is selected/highlighted). The size and/or aspect ratio of any of the tiles 710, such as tile 710A, can be additionally or alternatively adjusted (e.g., increased, decreased) to convey information about such tile(s) and/or the other tile(s). For example, the size and/or aspect ratio of tile 710A can be increased relative to other tiles to show that tile 710A is selected/highlighted and/or to promote tile 710A.

In some cases, user(s) 140 can optionally resize any of the tiles 710 or provide sizing information used to resize any of the tiles 710. When resizing tiles, there may be constraints limiting how much a tile can be resized (e.g., reduced or increased in size or aspect ratio). For example, user(s) 140 or the device managing UI 700 (e.g., UI management system 130 and/or the device displaying UI 700) can provide rules specifying/setting a minimum tile size or aspect ratio to prevent tiles from being adjusted to a size below the minimum tile size or aspect ratio (e.g., to avoid tiles being reduced so much that users may have difficulty seeing such tiles or associated details) and/or specifying/setting a maximum tile size or aspect ratio to prevent tiles from being increased in size above the maximum tile size or aspect ratio.

The UI container 702 can optionally include a tile counter 720 that indicates the number of tiles in UI container 702. The tile counter 720 can allow a user determine whether any tiles in the UI container 702 are not visible within a current view of the UI container 702 (e.g., to indicate whether the user needs to scroll the UI container 702 to see other tiles). For example, if the tile counter 720 indicates there are eight tiles in the UI container 702 and only three tiles are shown in a current view of the UI container 702 (e.g., tile 710A, tile 710B, and partial tile 710N), a user can determine that there are five other tiles in the UI container 702 that are not currently shown/visible in the UI container 702 (e.g., that are not within the currently visible portion of the UI container 702). The other five tiles may not be visible because the eight tiles do not fit within the portion of the UI container 702 that is visible within a current view of the UI container 702, for example. In such cases, UI management system 130, user(s) 140, or the device displaying UI 700 can determine whether to resize any tiles (or all tiles) so more tiles (or all tiles) fit and are visible within a view of the UI container 702 without scrolling the UI container 702.

For example, UI management system 130 can compare the user interface space available within the UI container 702 for placing tiles and/or the screen size of UI 700 with the number of tiles in the UI container 702 and/or the total size of the tiles in the UI container 702, to determine whether the tiles can be resized to fit within a visible portion of the UI container 702. In some cases, UI management system 130 can take into account a minimum tile size defined (if any) to determine whether the tiles fit within the visible portion of the UI container 702 without reducing the size of tiles below the minimum tile size. If UI management system 130 determines that all tiles do not fit within the visible portion of the UI container 702 without reducing the size of tiles below a minimum size, UI management system 130 can determine whether to reduce the overall size of tiles enough to fit all tiles within the visible portion of the UI container 702 (e.g., even if any tiles are reduced below the minimum tile size) or whether to reduce a subset of the tiles in a way that does not violate the minimum tile size requirement but increases the number of tiles that can fit (e.g., are visible) within a view of the UI container 702.

UI management system 130 (or user(s) 140) can weigh whether to show all tiles within the visible portion of the UI container 702 (e.g., without requiring user(s) 140 to scroll the UI container 702), which may require the tiles to be smaller than if some of the tiles are excluded or truncated, or show larger tiles, which may prevent all tiles from fitting within a visible portion of the UI container 702 (and thus require user(s) 140 to scroll to see one or more of the tiles). For example, if UI management system 130 (or user(s) 140) prioritizes showing all tiles within a visible portion of the UI container 702 to avoid requiring user(s) 140 to scroll the UI container 702 over showing larger tiles and consequently requiring user(s) 140 to scroll the UI container 702 to see some of the tiles, UI management system 130 (or user(s) 140) can reduce the overall size of the tiles to allow all tiles to be displayed within a visible portion of the UI container 702 and avoid requiring user(s) 140 to scroll the UI container 702.

Alternatively, if UI management system 130 (or user(s) 140) prioritizes showing larger tiles or avoiding reducing the size of the tiles (or the size of any tile) below a certain size (e.g., even if that size is larger than the minimum tile size) over trying to fit all tiles within the visible portion of the UI container 702, UI management system 130 (or the user) can select to display a subset of tiles according to a larger tile size (e.g., for each tile or the overall subset of tiles) and place one or more remaining tiles outside of the visible portion of the UI container 702 such that user(s) 140 would need to scroll the UI container 702 to see the one or more remaining tiles (e.g., to place them within the visible portion of the UI container 702).

In some cases, the tiles 710 can be configured, modified, or tailored based on the theme of the UI container 702. For example, the tiles 710 in FIG. 7A depict participants of the reality dating show associated with the theme of UI container 702. The participants can be depicted with a background associated with the theme of the UI container 702. In other examples, user(s) 140 can revise the tiles 710 and/or the content depicted by the tiles 710 (e.g., participants). For example, user(s) 140 can specify how a participant of depicted in a tile should be shown or modified. UI 700 can modify the depiction of the participant associated with that tile to show the participant as specified by user(s) 140. To illustrate, if user(s) 140 specifies a dark or light theme for the tiles 710, UI 700 can depict the participants in the tiles 710 according to a dark or light theme. If user(s) 140 specifies that the participant associated with the tile 710A be shown with an outfit from a previous episode, UI 700 can update the tile 710A to show the participant with such outfit.

In some cases, UI container 702 can include other features (e.g., content, visual elements, interface elements, objects, etc.) that are not shown in FIG. 7A. For example, UI container 702 can include one or more UI elements that allow user(s) 140 to provide an input(s), such as a CTA (e.g., a button, link, control, etc.) that user(s) 140 can select to initiate an action such as a purchase of merchandise related to the reality TV dating show, an element with a link to something such as a content, website (e.g., a website of the reality show, a sponsor, associated merchandise, etc.), application (e.g., an application related to the show, a dating application, a social media application, or any other application), channel, and/or anything else.

In FIG. 7A, the UI container 702 (e.g., the UI banner) is depicted without visible borders (e.g., frameless or borderless). However, in other examples, the UI banner can include one or more visible borders (e.g., can be framed with one or more borders).

UI 700 can optionally include other content sections. For example, UI 700 can include content section 728. Content section 728 is depicted outside of the UI container 702 (e.g., below the UI container 702 or at any other location within UI 700 and relative to the UI container 702). The content section 728 can include content, UI elements, visual elements, and/or any other features that may or may not be associated with the reality show or implement the romantic city theme. For example, the content section 728 can include content items related to the reality TV dating show (e.g., previous episodes, previous seasons, highlight videos, recap videos, preview videos or trailers, contestant videos, other images of one or more contestants, other images of Joe, etc.), related to other reality shows, related to a similar or relevant theme or genre (e.g., romance movies or shows, romance theme, etc.), unrelated to the show and/or theme (and/or to reality shows or romance), and/or any other content. The content section 728 can additionally or alternatively include other UI elements such as other tiles (e.g., of other contestants, other reality shows, other content, etc.), other content experiences, other graphics, other objects, other UI containers, etc.

In some examples, the content section 728 may include content, UI elements, visual elements, UI elements, objects, a section, a background, etc., related to the reality TV dating show and/or the UI container 702. For example, in FIG. 7A, the content section 728 includes a preview or representation related to a next episode of the reality TV dating show. Here, the content section 728 includes the image 708A of Joe, the silhouette 708B, and another UI container with UI elements (e.g., tiles) depicting certain contestants (e.g., other contestants, other arrangement of contestants, one or more contestants highlighted or promoted in a next episode of the show, etc.). The content section 728 can retain the theme of the UI container 702, a version of the theme, and/or a different theme. For example, the content section 728 can include or retain the theme (and/or any aspects thereof) of the UI container 702 or a version of the theme. To illustrate, if some or all of the items in the content section 728 relate to a next episode of the reality TV dating show and the next episode has a certain theme (e.g., an activity for the contestants of the show, an event depicted or promoted in the show, etc.), the content section 728 can implement a theme relevant to the reality TV dating show and similar to the theme of the UI container 702 but modified to include one or more aspects of the theme associated with the next episode.

In an illustrative example, if the content section 728 relates to a next episode of the reality TV dating show and a contestant in the show reveals a health condition in the next episode, the revelation of the health condition can be used to promote awareness to such condition. As such, the content section 728 can incorporate aspects of the theme of the show similar to the UI container 702 and/or aspects related to a theme of awareness to such condition.

UI 700 (or any portion of UI 700) can optionally be personalized for a user. For example, UI 700 can fill in the silhouette 708B with an image of user(s) 140 and show the image 708A of Joe along with an image of user(s) 140 depicted within the silhouette 708B. In some cases, user(s) 140 can grant an application associated with UI 700 access to a picture(s) of user(s) 140. The application can access the picture(s) to obtain an image of user(s) 140 to place over (e.g., fit within, filled into, etc.) the silhouette 708B (e.g., with or without modifications) to show user(s) 140 with Joe. UI 700 can optionally adjust the silhouette 708B to match the image of user(s) 140 (and/or the outline or contour of the image) or vice versa. In some cases, user(s) 140 can select an image and place it over the silhouette 708B. UI 700 can optionally adjust the silhouette 708B based on the image. In some cases, user(s) 140 can grant the application access to a camera device to capture an image of user(s) 140 to place over the silhouette 708B. In other cases, the application can use a generative AI/ML model to generate or modify an image of user(s) 140 that the application can place on the silhouette 708B to fill the silhouette 708B with the generated image of user(s) 140.

FIG. 7B illustrates an example user interface 730 depicting another UI container 734. In this example, the UI container 734 includes a UI banner. However, the UI container can include any other type of UI container. Moreover, in FIG. 7B, the UI banner depicted by the UI container 734 does not have visible borders (e.g., frameless). However, in other examples, the UI banner can include one or more visible borders (e.g., can be framed with one or more borders).

In some cases, UI 730 can be displayed in response to an interaction with UI 700 shown in FIG. 7A, such as in response to user(s) 140 selecting a tile included in the UI container 702. For example, when user(s) 140 selects the tile 710A corresponding to Daisy, the selection of the tile 710A can trigger UI 730 to be loaded/displayed. UI 730 in this example displays a scenario 732 generated based on the contestant associated with the selected tile (e.g., tile 710A), which in this case is Daisy. As shown, the scenario 732 can includes a scenario (e.g., theme, context, situation, etc.) titled “When Joe Meets Daisy”, which highlights the contestant Daisy associated with the tile 710A within the context of the reality TV dating show with Joe as the main character or bachelor.

The UI container 734 can include a UI banner generated for the scenario 732. As shown, in this example, the tile 710A associated with Daisy is highlighted, as indicated by the outline 718 around the tile 710A, and the metadata section 716 associated with the tile 710A has been expanded to include more information about Daisy (e.g., an indication of the chemistry between Daisy and Joe). The UI container 734 partially shows the tile 710B but does not show other tiles in this example, as it is focused on Daisy.

The tile 710A includes an object 736 representing a score for Daisy. The score can represent a chemistry between Daisy and Joe, a number of votes associated with Daisy, a probability that Daisy will win the contest or a next round, or any other metric. In some examples, the score can represent a number of votes that Daisy has received from users voting on contestants (e.g., voting on contestants favored to be selected by Joe to continue to the next round). In some cases, the object 736 can allow user(s) 140 to vote for or against Daisy. For example, the object 736 can include an arrow pointing up in relation to the object 736 to indicate that user(s) 140 can vote in favor of Daisy by selecting the up arrow to increase the votes for Daisy, and optionally an arrow pointing down in relation to the object 736 to indicate that user(s) 140 can vote against Daisy by selecting the down arrow. The object 736 can additionally or alternatively include any other UI element. For example, the object 736 can include a button that user(s) 140 can select to provide an input or specify how user(s) 140 wants to vote.

The UI container 734 can include one or more navigation elements, such as navigation elements 738 and 740 that user(s) 140 can select or activate to navigate or scroll through tiles in the UI container 734. For example, the navigation element 738 in FIG. 7B can allow user(s) 140 to scroll (e.g., by selecting or activating the navigation element 738) the UI container 734 in one direction (e.g., to scroll to another tile) and navigation element 740 can allow user(s) 140 to scroll the UI container 734 (e.g., scroll to another tile) in a different direction. UI 730 can include a back button 742 that allows user(s) 140 to navigate back to UI 700 shown in FIG. 7A (e.g., by selecting or activating the back button 742).

In some cases, UI 730 can depict an image 744 within the silhouette 708B. UI 730 can load the silhouette 708B with the image 744 or show the image 744 being added to the silhouette 708B (e.g., show the silhouette 708B being filled with the image 744). In some examples, UI 730 can depict an animation showing the image 744 being added to the silhouette 708B (e.g., showing the silhouette 708B being filled with the image 744). For example, UI 730 can display an animation that shows the image 744 appearing in UI 730 or entering UI 730 from outside of UI 730 (e.g., show a visual effect that depicts the image 744 entering the view of UI 730 from an edge/border of UI 730 such as the right border/edge of UI 730 as shown in FIG. 7B) and progressively filling the silhouette 708B or molding into a shape of the silhouette 708B and filling the shape of the silhouette 708B (or the silhouette 708B molding into a shape of the image 744 or both molding into a common shape).

The image 744 can include an image of a participant in the reality TV dating show, an image of user(s) 140, or an image of any other person. UI 730 can display an animation where the image 744 of user(s) 140 is moved into the silhouette 708B such that the silhouette 708B is filled with the image 744 to depict user(s) 140 (e.g., the image 744) within the silhouette 708B. In some cases, the image 744 of user(s) 140 can include a user avatar, an image used to generate a user avatar, an image depicted by a user avatar, a real picture of user(s) 140, an image of user(s) 140 generated based on a real picture of user(s) 140, an image of user(s) 140 generated or modified by an AI/ML model, or any other image used to depict user(s) 140 or a representation of user(s) 140 within the silhouette 708B. In some cases, the contour of the silhouette 708B can be matched or adjusted to the contour of the image 744 (or vice versa) so the image 744 and silhouette 708B are aligned/overlapped to show the person (e.g., user(s) 140, contestant, etc.) depicted in the image 744 within the silhouette 708B.

The silhouette 708B can alternatively be filled with an image of another person, such as a contestant in the show or another user. In some cases, the image of the other user can include, for example, an image of a winner of a challenge associated with UI 730 or UI 700, such as a scavenger hunt competition or a trivia challenge, or a user selected to be promoted within UI 730 (e.g., a user with a highest score in an activity, a user with a highest votes, a user with a most number of watched content items within a period of time, a user with a highest watch/play count of content items available through a content platform associated with UIs 700 and 730, a user with a certain number of credits associated with the content platform, a paid user, a random user of the content platform, a user selected from a pool of users who submitted requests to be added, a user who answered the highest number of questions related to the reality TV dating show correctly, a user being celebrated the day when UI 730 is displayed such as a user who won a contest or a user who got engaged within a specific time period, etc.).

FIG. 8A illustrates an example UI container 800 customized to include a combination of themes, according to some examples of the present disclosure. In this example, the UI container 800 includes a UI banner with tiles 808A-N (collectively “tiles 808” hereinafter), and the theme of the UI container 800 includes a college football theme and a college football team theme. Moreover, the UI container 800 includes a themed space 802 adjacent to the tiles 808. The themed space 802 includes the college football theme and the college football team theme. The tiles 808 correspond to respective college football teams and depict visual content corresponding to the respective college football teams, such as team logos, team names, team mascots, team colors, etc. The themed-space 802l can include content associated with college football and/or a particular college football team, such as a team favored by user(s) 140, a team that is ranked in first place, a team that is scheduled to play, a team associated with a selected tile, any other team.

The content of the themed space 802 and the tiles 808 can convey a theme(s), such as the college football theme of the UI container 802. The college football theme can be based on a college football topic. The college football topic can be selected based on one or more signals. In some examples, the college football topic (and thus the college football theme) can be selected based on a relevance of college football to user(s) 140, a relevance of college football given a current context and/or a time period (e.g., date, week, season, etc.) when the UI container 800 is displayed, a user preference, a trending metric associated with college football, a user watch history indicating a trend or uptick associated with college football, social media data (e.g., post counts, keyword/topic references, content likes, etc.), etc. For example, if the UI container 800 is included in a user interface (not shown) displayed during college football season, on a day in which a college football game(s) is/are scheduled, on a day that college football is trending, etc., college football can be selected as the topic of the theme of the UI container 800 given the relevance of college football when the user interface is displayed. The college football theme can highlight or promote college football and/or align the theme (and related content) of the UI container 800 to an event, trend, context, culturally-relevant situation, preference, etc.

In some cases, the college football theme can be a theme personalized for user(s) 140. For example, the college football theme can additionally or alternatively be selected based on information indicating that user(s) 140 is a college football fan, is interested in college football (e.g., from a user profile, a user input, a user preference, etc.), enjoys/prefers college football content (e.g., based on a watch history, social media data and/or connections, user preferences, etc.), has discussed college football on social media, follows college football content and/or a college football entity or person (e.g., a college football team, coach, player, etc.) on a platform(s) such as a social media platform, has a history of watching college football or doing something that shows interest in college football, etc. Such information can be obtained from a user preference(s), a user input(s), a user profile(s), user activity (e.g., a content viewing/watching history, a purchase history and/or transaction(s), content likes, content subscriptions, etc.), user statistics, inferred user preferences (e.g., inferred from a user demographic, user characteristics, a user location, a user context, etc.), etc. If the information instead indicates (or is used to infer) that user(s) 140 does not like college football, the UI container 800 may implement a different theme even if college football is otherwise a selected and/or relevant theme (e.g., even during college football season or a day when college football is trending or culturally relevant).

The content in the themed space 802 can include college football content or content associated with college football (and, optionally, other content). For example, the themed space 802 can include text section 804 with text information about college football (and/or a college football team, game, schedule, coach, player, institution, statistic, history, etc.). The themed space 802 in FIG. 8A also includes an image 806 of a college football player. In other examples, the themed space 802 can additionally or alternatively include any other image related to college football, any other type of content and/or UI elements, etc. The UI container 800, including the themed space 802, can include a background. The background can relate to a theme(s) of the UI container 800, such as the college football theme. Thus, the background can depict visual elements associated with the college football theme, such as college football team graphics (e.g., colors, logos, symbols, flags, etc.), college football artwork, college football imagery, etc.

In some cases, the background can include one or more additional themes for further customization. For example, in FIG. 8A, the background also includes a college football team theme. To illustrate, the UI container 800 and/or the background of the UI container 800 can depict content and/or features associated with the Georgia Bulldogs, which is the college football team associated with tile 808A. The content and/or features depicted based on the Georgia Bulldogs theme can include, for example and without limitation, the team colors of the Georgia Bulldogs (e.g., red and white), an image 806 depicting a Georgia Bulldogs player, artwork associated with the Georgia Bulldogs, a mascot of the Georgia Bulldogs, etc. The background colors and the image 806 of the Georgia Bulldogs player can convey a Georgia Bulldogs theme.

The Georgia Bulldogs theme can be selected based a Georgia Bulldogs topic associated with user(s) 140. The Georgia Bulldogs topic can be selected based on one or more signals, such as a signal(s) indicating a current relevance of the Georgia Bulldogs (e.g., the Georgia Bulldogs have a game on the day the UI container 800 is displayed, the Georgia Bulldogs are trending, the Georgia Bulldogs have a certain ranking, the Georgia Bulldogs may be favored to win the college football championship, etc.), a user preference, etc. For example, the Georgia Bulldogs theme can be selected for user(s) 140 to further tailor the UI container 800 to user(s) 140. Here, the Georgia Bulldogs topic used to select the Georgia Bulldogs theme can be selected for user(s) 140 based on a user preference (e.g., user(s) 140 is a fan of the Georgia Bulldogs), a viewing history of user(s) 140, a request from user(s) 140 (e.g., an input requesting a Georgia Bulldogs theme or indicating a preference for a Georgia Bulldogs theme), a current ranking of the Georgia Bulldogs, social media data associated with the user, etc.

To illustrate, the tiles 808 correspond to college football teams and are ordered according to their college football rankings (e.g., to show the rankings of the college football teams). As shown, the tiles 808 are arranged in a sequence that is based on the respective rankings of the respective college football teams corresponding to the tiles 808. Since the Georgia Bulldogs are ranked highest from the teams associated with the tiles 808, the tile 808A of the Georgia Bulldogs is sorted first (before the other tiles). The ranking of the Georgia Bulldogs can also be used to select a Georgia Bulldogs theme as the college football team theme of the UI container 800. If the Georgia Bulldogs drop in the rankings, the tiles 808 in the UI container 800 can be reordered to reflect the change in rankings and the UI container 800 may be optionally updated to replace the Georgia Bulldogs theme with a theme of the college football team that overtakes the Georgia Bulldogs in the rankings. Alternatively, if the Georgia Bulldogs are trending/relevant even after dropping in the rankings or if user(s) 140 has an interest in or affinity for the Georgia Bulldogs, the UI container 800 may retain the Georgia Bulldogs theme despite the Georgia Bulldogs dropping in the rankings.

The tiles 808 can include features (e.g., artwork, UI elements, images, colors, color schemes, animations, objects, content, backgrounds, visual elements, etc.) related to their respective football teams, such as team logos or mascots, to correlate the tiles 808 with respective college football teams. In some cases, each of the tiles 808 can display the respective ranking of its corresponding team, and the tiles 808 can be arranged in an order based on rankings to depict or match the rankings of the teams corresponding to the tiles 808. In some examples, user(s) 140 can select any of the tiles 808 to interact with such tile(s) and/or access associated information, content, content experiences, activities, etc. For example, if user(s) 140 wants to access information about Penn State Nittany Lions, which correspond to tile 808C and are ranked 4^{th} in this example, user(s) 140 can select the tile 808C to access such information. When user(s) 140 selects the tile 808C, the UI container 800 (or an associated user interface) can load content associated with the Penn State Nittany Lions, such as a team page, one or more tiles with Penn State content (e.g., a video of Penn State games or highlights, a movie or show about Penn State, an interview with coach James Franklin, an image of the Penn State football stadium, an image of Happy Valley, etc.), a game or activity involving Penn State, Penn State football statistics, etc.

UI container 800 and/or any of the tiles 808 can optionally include metadata associated with any of the teams associated with any of the tiles 808, such as information about such team(s). For example, the UI container 800 includes a metadata section 810 depicted below the tile 808A associated with the Georgia Bulldogs. The metadata section 810 includes information and/or statistics about the Georgia Bulldogs.

As previously noted, UI container 800 can be implemented in a user interface, such as UI 320 in FIG. 3B, UI 400 in FIG. 4, UI 500 in FIG. 5A, UI 540 in FIG. 5C, UI 600 in FIG. 6A, UI 700 in FIG. 7A, UI 730 in FIG. 7B, UI 820 in FIG. 8B, UI 850 in FIG. 8C, etc. In some cases, the user interface implementing the UI container 800 can include any themes of the UI container 800 and/or any other themes, such as any similar themes, any relevant themes, and/or any other themes.

FIG. 8B illustrates an example user interface 820 that includes an example UI container 822 customized with a combination of themes. Like the UI container 800 in FIG. 8A, the UI container 822 includes a UI banner and implements multiple themes. In FIG. 8B, the UI container 822 includes a college football theme and a college football team theme.

The UI container 822 in this example includes tiles 830A-N (collectively “tiles 830” hereinafter) and a content space 824 used to display other items in addition to the tiles. The content space 824 can implement one or more themes based on a topic(s). The topic(s) can be selected based on one or more signals. The one or more signals can include a trending metric or statistic of the topic(s) (e.g., a metric determined based on one or more social media posts, content viewership statistics/metrics, purchasing habits and/or statistics of users, a frequency in which the topic(s) is mentioned or discussed in one or more mediums such as the media, user or group preferences, business preferences, paid sponsorship, an increased or threshold availability or promotion of the topic by a content provider, a temporal relationship between a time period when the UI container 822 is displayed and the topic(s) (e.g., a temporal relationship between a release date or schedule of content or products associated with the topic(s) and a time period when the UI container 822 is displayed, a trend or popularity of the topic(s) is higher on that time period than other time periods, statistics of the topic(s) on that time period, popularity of the topic(s) on that time period, user trends with respect to the topic(s) on that time period, etc.), a relationship between the topic(s) and a location associated with user(s) 140 and/or a device used to display the UI container 822 (e.g., based on a particular significance/popularity or history of the topic(s) with respect to that location, a specific relationship between the topic(s) and location, etc.), a context associated with user(s) 140 and/or the device used to display the UI container 822 (e.g., a relationship between the context and the topic, a relevance metric between the topic and the context, etc.), and/or any other signals.

For example, if the UI container 822 is displayed on a day when college football games are scheduled, a college football topic can be determined to have a threshold relevance on that day and selected as the topic for selecting a theme. UI management system 130 can then select the college football theme based on the college football topic selected based on the threshold relevance of the topic to that day. If a particular college football team is scheduled to play or is trending on that day, the college football team can be selected as a topic used to identify a theme (e.g., a college football team theme) for the UI container 822. In FIG. 8B, the themes of the UI container 822 are thus selected based on a college football topic and a college football team topic. Thus, the UI container 822 can include a college football theme (e.g., based on the college football topic) and a team theme (e.g., based on the college football team topic).

The content space 824 in this example includes text 826A. The text 826A can include information about college football, a college football team, a college football schedule, etc. The content space 824 can also include artwork 826B associated with the theme(s) of the UI container 822, such as the college football theme and the college football team theme. In this example, the artwork 826B includes an image of a player of the college football team and a background color associated with the college football team. The content space 824 may additionally or alternatively display other content. For example, in FIG. 8B, the content space 824 includes a UI element 828. In this example, the UI element 828 includes a CTA, such as a button, link, or other UI element that user(s) 140 can select or activate to access or interact with content associated with college football and/or the college football team associated with the team theme, purchase merchandise related to college football and/or the college football team, play a video or video game associated with college football or the college football team, etc. In some cases, the UI element 828 can include a link to certain content or a destination, or can be configured to trigger an action, such as loading or initiating a video, video game, activity, interaction, channel, application, etc.

The tiles 830 in the UI container 822 can be configured in any arrangement. For example, in FIG. 8B, the tiles 830 are arranged as a row of tiles corresponding to respective college football teams. The content in the content space 824 and the tiles 830 can relate to college football and a college football team and thus convey a college football theme and a college football team theme.

The tiles 830 can be ordered within the row of tiles according to a sorting scheme. For example, the tiles 830 can be ordered within the row of tiles according to the rankings of the college football teams (e.g., to show the rankings of such college football teams) corresponding to the tiles 830. In this example, the tiles 830 can be arranged in a sequence that is based on the rankings of the college football teams corresponding to the tiles 830. For example, as reflected in the order of the tiles 830, the Florida Gators associated with tile 830A are ranked first, the Georgia Bulldogs associated with tile 830B are ranked second, the University of Southern California (USC) trojans associated with tile 830C are ranked third, and the Pennsylvania State University (PSU) Nittany Lions associated with tile 830N are ranked fourth. Thus, tile 830A is first in the row of tiles, tile 830B is second (e.g., next to tile 830A) in the row of tiles, tile 830C is third (e.g., next to the 830B) in the row of tiles, and tile 830N is fourth (e.g., next to tile 830C) in the row of tiles.

Thus, in some cases, the order of the tiles 830 can reflect the rankings of the college football teams associated with the tiles 830. For example, the order of the tile 830A visually indicates that its corresponding team (Florida Gators) is ranked first, the order of the tile 830B visually indicates that its corresponding team (Georgia Bulldogs) is ranked second, the order of the tile 830C visually indicates that its corresponding team (USC Trojans) is ranked third, and the order of the tile 830N visually indicates that its corresponding team (PSU Nittany Lions) is ranked fourth. This way, user(s) 140 can identify the rankings of the college football teams corresponding to the tiles 830 based on the order/arrangement of the tiles 830. Even in examples where the tiles 830 do not visually specify the rankings of their corresponding teams, user(s) 140 may nevertheless potentially ascertain the rankings of the corresponding teams based on the order of the tiles 830 within the sequence of the row of tiles.

In some cases, the UI container 822 may include a metadata section for any of the tiles 830. The metadata section associated with a tile can display information associated with that tile and/or a content of the tile. The UI container 822 can include a metadata section below, above, next/adjacent to, within, or in association with any tile (e.g., one tile, multiple tiles, all tiles, etc.). For example, UI container 822 may include a metadata section with information about the Florida Gators. The metadata section can be positioned near the tile 830A (e.g., below, above, adjacent to, etc.) associated with the Florida Gators. The metadata section associated with the tile 830A and Florida Gators can be included because the Florida Gators are ranked first, the tile 830A is highlighted, the Florida Gators are playing on the day that (or within a time period when) UI 820 is displayed, user(s) 140 has a preference for or is a fan of the Florida Gators (e.g., as indicated by user data or preferences), user(s) 140 requested such information for the Florida Gators or tile 830A (e.g., via a user input), or any other reason.

The metadata section displayed on UI container 822 can dynamically change in response to one or more events or triggers. For example, if UI container 822 includes a metadata section associated with tile 830A because tile 830A is highlighted by user(s) 140 and user(s) 140 subsequently provides an input configured to trigger another tile to be highlighted, UI container 822 can be updated to include a metadata section associated with that other tile (or the metadata section can be updated to provide information about the team corresponding to the other tile), which can include information about the team corresponding to that tile. When the UI container 822 is updated to include the metadata section associated with the other tile, the UI container 822 may or may not remove the metadata section associated with the previous tile.

UI 820 can include any other sections. For example, in FIG. 8B, UI 820 also includes content section 840. Content section 840 can include other content items and/or UI elements linked to (e.g., used to view or access) other content items such as videos, movies, TV shows, livestreams, TV broadcasts, podcasts, highlight reels, recap videos, promoted content, media applications, media channels, and/or any other content. In some cases, the content section 840 can include UI elements containing content and/or used to access certain content, experiences, features, etc. For example, the content section 840 can include tiles 842A-N (collectively “tiles 842” hereinafter) associated with content items. The tiles 842 can be arranged in any configuration.

The tiles 842 can be linked to and provide access to associated content. For example, in FIG. 8B, the tiles 842 include or provide a link to sports content. The sports content includes baseball videos. User(s) 140 can select any of the tiles 842 to watch/play a corresponding content item. The tiles 842 can depict frames (e.g., keyframes) or thumbnails of a scene, view, poster, and/or content from the corresponding content items, which allows user(s) 140 to see what the tiles 842 pertain to. The tiles 842 may depict other visual information or content (e.g., in addition to or instead of the frames or thumbnails) associated with the content of tiles 842. For example, tiles 842 can depict titles and/or descriptions of corresponding content to identify the content (e.g., baseball clips) associated with tiles 842.

The content associated with the tiles 842 in the content section 840 shown in FIG. 8B may include sports content based on a relevance or relationship of the theme(s) of UI 820 and the sports content. For example, UI 820 includes a college football theme, as previously explained. Since the college football theme is more broadly a sports theme, the content associated with the tiles 842 relate to the college football theme in that both the college football theme and the sports content are broadly sports themes or related to a sports theme. In other cases, the content associated with the tiles 842 can include content that is part of or more specifically related to the college football theme and/or content associated with any other theme. In FIG. 8B, the tiles 842 in content section 840 and the associated content items relate to baseball. However, the tiles 842 in the content section 840 and the content items associated with the tiles 842 may or may not relate to a theme of the UI container 822, such as a specific theme (e.g., a college football and/or college football team theme) and/or a more general theme of the UI container 822 (e.g., sports in general).

For example, the tiles 842 (or any portion thereof) in content section 840 and the content items associated with the tiles 842 (or any portion thereof) can relate to college football and/or any of the college football teams associated with the tiles 830. However, the tiles 842 (or any portion thereof) in content section 840 and the content items associated with the tiles 842 (or any portion thereof) can relate to any other theme. To illustrate, the tiles 842 and content items associated with the tiles 842 can relate to sports in general or a particular sport(s) (e.g., football). This way, the tiles 842 and content items can relate to a general and/or specific theme. In FIG. 8B, the tiles 842 relate to sports and are associated with sports content such as baseball content. Since UI container 822 relates to a sport (college football) and tiles 842 relate to sports, UI 820, including UI container 822 and the content section 840, includes an overall sports theme.

In other examples, the tiles 842 and the content items associated with the tiles 842 can relate to any other themes. For example, the tiles 842 can relate to movies (and/or any other type of content item) associated with a different sport, such as soccer, boxing, basketball, etc. In other cases, the tiles 842 can relate to movies (and/or any other type of content item) associated with any other topic, such as action movies, comedy shows, dramas, animated movies, etc.

FIG. 8C illustrates another example user interface 850 (UI 850) customized based on a combination of themes and including UI containers. In this example, UI 850 includes UI container 852 and UI container 870. The UI container 852 and the UI container 870 include a football theme. The UI container 852 also a football team theme, which in this example includes a San Francisco 49ers theme. The team theme can be based on information indicating that user(s) 140 has a threshold interest in the San Francisco 49ers, such as a user profile, a user input, a watch history of user(s) 140, social media data associated with user(s) 140 (e.g., social media posts, likes, connections, subscriptions, etc.). The team theme can be used to further personalize the UI container 852 (and UI 850) for user(s) 140.

The UI container 852 in this example includes a UI banner. Moreover, the UI container 852 includes a section 854 with team content that is based on the San Francisco 49ers theme. For example, the section 854 includes imagery 856A related to the San Francisco 49ers, such as a team logo, text content 856B providing information about the San Francisco 49ers, and a UI element 858. The UI element 858 can include a CTA. For example, UI element 858 can include a link to a team page of the San Francisco 49ers. User(s) 140 can select the link to access the team page.

The UI container 852 also includes a section 860 with UI elements and content associated with the San Francisco 49ers. As shown, the section 860 includes a tile 862 promoting a game between the San Francisco 49ers and another team, and a tile 864 that provides a summary of the game and details about the teams and game. In some cases, the tile 862 can be selected or activated to watch a video associated with the game, such as a highlights or replay video. The section 860 can include a counter 866 specifying the number of tiles in the section 860, as previously explained.

The counter 866 can indicate whether the section 860 of the UI container 852 includes any tiles that are not visible in the current view of UI 850. User(s) 140 can identify any number of remaining tiles based on the tiles 862-864 that are visible and the number of tiles indicated in the counter 866. The remaining tiles may not be visible in the UI container 852 because, for example, the UI container 852 cannot fit all the tiles or can only fit the tiles if some or all of the tiles are resized to a size that is smaller than a minimum tile size defined. In such cases, the UI container 852 may be scrollable to allow user(s) 140 to scroll through tiles to view and/or access other tiles.

For example, user(s) 140 can scroll UI container 852 (or the tiles in UI container 852) in any direction to view/access any tiles that are not visible within a current view of the UI container 852 but would become visible upon scrolling in that direction. As user(s) 140 scrolls (e.g., via a scrolling input) through tiles in the UI container 852, UI 850 can display a scrolling effect where tiles in the UI container 852 appear to move or rotate based on a scrolling direction, and tiles that were not visible prior to the scrolling may be moved into focus (e.g., become visible). In other words, when user(s) 140 scrolls in a direction, UI 850 can update a view of the UI container 852 or load a subsequent view of the UI container 852 to show one or more tiles move from the scrolling direction and become visible within the UI container 852. In some examples, the scrolling effect can include an animation that depicts any visible tiles moving away from the scrolling direction (e.g., moving towards an opposite direction) and depicts one or more tiles that were not previously visible (e.g., because the one or more tiles were previously outside of a visible portion of the UI container 852) moving into focus.

In some cases, when user(s) 140 scrolls the UI container 852 to shift the tiles shown in the view of the UI container 852 by a tile, UI 850 can load or update a view of the UI container 852 that shifts the row of tiles by a tile based on the scrolling direction. When shifting the row of tiles, UI 850 can move an end tile (e.g., previously located at an end of the UI container 852 that is opposite to the scrolling direction) out of view (unless that tile fits within the view as in cases where the scrolling has reached an end of the row or is near the end of the row) and move another tile (e.g., a tile that before the scrolling was located at an end of the UI container 852 towards the scrolling direction) within view. Alternatively, when user(s) 140 scrolls the tiles in the UI container 852, UI 850 can update or load a view of the UI container 852 that replaces one or more tiles that were visible before the scrolling with one or more tiles that were not visible before the scrolling and were located adjacent to the visible area of the UI container 852 in the scrolling direction. In some cases, the UI container 852 can be configured to behave like a carousel when user(s) 140 scrolls the UI container 852 such that the tiles in the UI container 852 appear to move and rotate as UI 850 displays a scrolling effect.

The section 860 in this example also includes a UI element 876 that user(s) 140 can select or activate to watch the game (e.g., watch a replay of the game), and information 868 about the UI element 876 and/or the content available via the UI element 876. In this example, the game has already completed so the tile 864 and UI element 876 relate to a completed game and an associated replay of the game. In other examples, if the game has not been played, the UI element 876 can identify a source (e.g., channel) that will stream or televise the game, and the information 868 can provide information about the upcoming game and/or the UI element 876, such as a date/time when the game is scheduled, a description of the source of the game associated with the UI element 876, and/or any other information. In some cases, the UI element 876 can include a link to the channel, stream, broadcast, or signal that will provide the game, which user(s) 140 can select or activate to watch the game. The information 868 can specify when the game is scheduled so user(s) 140 knows when to select or activate the UI element 876 to watch the game. In such examples where the game has not completed, the tile 864 can include information about the game, information about another game, or a link or button to watch another game.

The UI container 870 also includes a UI banner. The UI banner in this example is titled “My Team Highlights” and provides highlight content of the San Francisco 49ers. UI container 870 in this example includes tiles 872A-N (collectively “tiles 872” hereinafter) corresponding to highlight videos of the team. The tiles 872 can depict details about the highlight videos associated with the tiles 872. In some examples, the tiles 872 can include or depict keyframes from the highlight videos associated with the tiles 872, images or thumbnails associated with the highlight videos, image posters associated with the highlight videos, and/or any other information that can visually identify the highlight videos corresponding to the tiles 872, respectively. The theme and content of the UI container 870 are merely illustrative examples provided for explanation purposes. In other examples, the UI container 870 can include any other theme and/or content, which may or may not relate to the theme and/or content associated with the UI container 852.

In some cases, UI 850 can depict a user avatar 885 of user(s) 140, which may or may not be customized based on a theme(s) of UI 850. For example, since UI 850 includes a football theme, user avatar 885 can be customized to add a football helmet or jersey to the user depicted in user avatar 885. In some examples, the topic(s) used to select the theme(s) can be determined based on a threshold relevance of the topic(s), a context, a user, a community, a device, an event, an environment, a condition (e.g., release date, event outcome, announcement, etc.), and/or related in other ways. In some cases, a theme of UI container 852 and/or UI container 870 can vary by location such that devices in different locations may display versions of UI 850 with different themes. Users in a location may have a higher interest in or a higher likelihood of being interested in a particular theme. Accordingly, location information of a user or associated device can serve as a signal used to determine a theme(s) for UI 850 (and/or UI container 852 and/or 870).

For example, if UI 850 is displayed by media device(s) 104 when media device(s) 104 is in San Francisco, the location of media device(s) 104 can suggest a preference for or relevance of the San Francisco 49ers given that San Francisco may have a higher concentration of San Francisco 49ers fans and the San Francisco 49ers team is the home team at that location. Similarly, if media device(s) 104 is located within a region that has a threshold number or proportion of San Francisco 49ers fans or consumers, the location of media device(s) 104 can be used to select a San Francisco 49ers theme for user interfaces and UI containers displayed at media device(s) 104 while media device(s) 104 is in that region, since the location of media device(s) 104 can indicate a likelihood that user(s) 140 associated with media device(s) 104 is interested in San Francisco 49ers content.

In another example, if the location of media device(s) 104 has changed from San Francisco to a new location, such as Paris, the new location can be used to select a new theme, such as a Paris theme, that may be more relevant to user(s) 140 associated with media device(s) 104 than the San Francisco 49erstheme (e.g., or any other San Francisco theme) as the new theme (e.g., Paris) is more temporally/contextually relevant to the new location of media device(s) 104 than the San Francisco 49erstheme. Thus, when media device(s) 104 is located in Paris, the UI container 852 and/or the UI container 870 may incorporate a theme related to Paris. For example, the UI container 852 and/or the UI container 870 may include a background that shows the Eiffel Tower and/or colors associated with Paris (or France), and the tiles 862-864 or the tiles 872 may include or correspond to content items associated with Paris, such as movies based in Paris, videos of the Paris Saint-Germain soccer team, and/or videos about or including a famous Parisian or landmark.

The number of UI containers shown in FIG. 8C is an illustrative example provided for explanation purposes. In other examples, UI 850 may include more or less UI containers than shown in FIG. 8C. While the tiles in the UI container 870 are depicted in a row pattern or arrangement, the tiles can be arranged within the UI container 870 in any other pattern or arrangement. For example, the tiles in a UI container can be arranged in a column, grid, cloud, circular, or any other shape or arrangement. Moreover, tiles in a UI container can have the same or different sizes, shapes, alignments, aspect ratios, resolutions, layouts, and/or any other configuration or attributes. To illustrate, the tiles in a UI container can have different sizes, layouts (e.g., landscape, portrait, etc.), resolutions, and/or shapes to convey different information about the tiles, highlight or promote certain tiles, fit the tiles within a user interface space, vary the visual configuration, etc.

In some examples, UI 850 can include one or more animations to enhance the user experience. For example, tile 864 in UI container 852 depicts football player 874. In an animation, football player 874 can appear to leave or exit tile 864 (e.g., jump and/or run out of tile 864) and run to a destination. In this example, the destination is tile 872N. Thus, football player 874 can appear to run to tile 872N to entertain user(s) 140, draw the attention of user(s) 140 to that tile, promote that tile, encourage user(s) 140 to view or play the content of that tile, help user(s) 140 discover that tile, etc. In some cases, football player 874 can run to tile 872N and stay by tile 872N, perform an activity by tile 872N such as jump on top of tile 872N or catch a football above tile 872N, hide behind tile 872N, or jump into tile 872N and appear to enter tile 872N.

For example, if tile 872N includes a link to a video about football player 874, football player 874 can jump out of tile 864, run towards tile 872N and jump into tile 872N such that football player 874 is subsequently depicted in tile 872N. This animation can draw the attention of user(s) 140 to tile 872N and visually indicate or suggest that tile 872N corresponds to a video about or including football player 874 available via tile 872N. In another animation, balloon 880 can appear in UI 850 and float towards a tile slot for tile 872B while carrying tile 885. When the balloon 880 reaches the tile slot, it can drop the tile 885 so it falls into the tile slot. The tile 885 can be aligned with the tile slot and replace the tile 872B. The tile 885 can depict content and optionally include a link to content. For example, the tile 885 can include a link to a content item, such as a promoted video, an advertisement, an episode associated with tile 872B, a video game, etc. If user(s) 140 completes watching a video associated with tile 872B, the balloon 880 can appear and drop tile 885 to replace tile 872B associated with the video that user(s) 140 watched, with tile 885 corresponding to a different video.

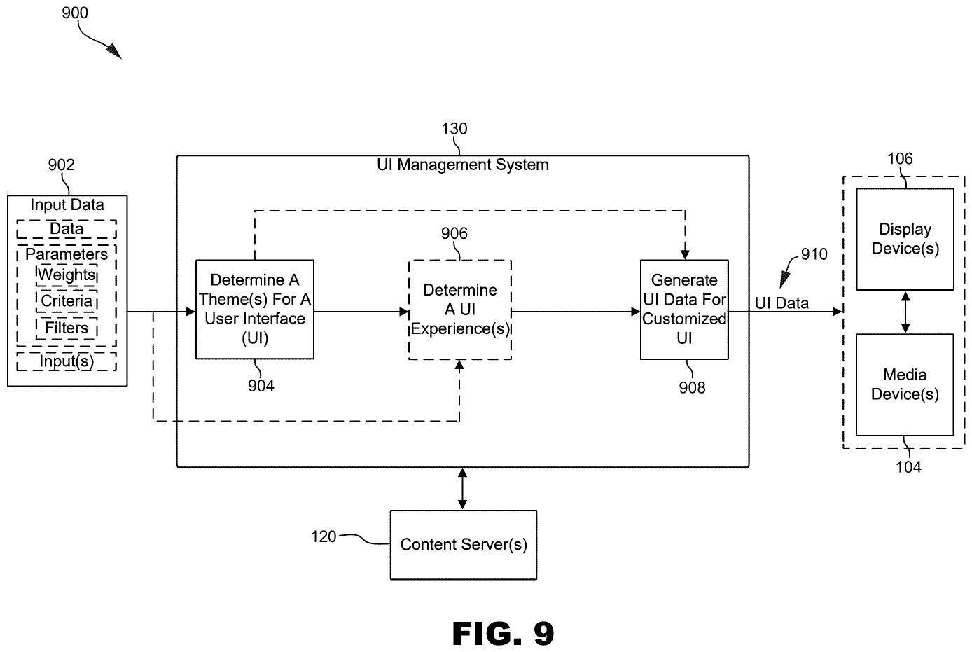

FIG. 9 is a diagram illustrating an example system process 900 for customizing user interfaces. The user interface can be displayed by a user device, such as media device(s) 104 or display device(s) 106. The user interface can provide user(s) 140 a content experience. For example, the user interface can allow user(s) 140 to access content, browse and/or navigate content, search content, interact with content, watch or play content, manage content, engage with content, etc.

UI management system 130 can determine configuration parameters of a user interface (e.g., one or more themes, structures, appearances, artwork, behaviors, attributes, content items, UI elements, visual elements, UI containers, animations, configurations, menu items, styles, visual effects, input elements, controls, personalization parameters, promotions, features, etc.), configure the user interface, generate the user interface, trigger and/or instruct media device(s) 104 to display/render and/or generate the user interface, customize the user interface, generate data that media device(s) 104 can use to display/render and/or generate the user interface, etc.

The user interface can be customized as previously described. For example, one or more aspects of the user interface (e.g., a theme, design, behavior, artwork, look/appearance, structure, arrangement, organization, attribute, configuration, visual effect, and/or characteristic) can be customized based on, or to include or convey a theme(s). The theme(s) can be selected based on a topic(s). The topic(s) can be selected based on one or more signals. UI management system 130 can be implemented by media device(s) 104 (e.g., see FIG. 2) or a remote server(s), such as system server(s) 126. For example, UI management system 130 can run locally (e.g., at the edge) on the device used to display the user interface, and can locally configure the user interface, and/or can run remotely (e.g., at system server(s) 126) and remotely configure the user interface or generate data used to configure, present, and/or render the user interface.

In some cases, UI management system 130 can be distributed or include instances running on different devices. For example, UI management system 130 can be distributed across edge (e.g., media device(s) 104) and remote locations (e.g., system server(s) 126) and can run one or more portions remotely (e.g., at system server(s) 126) and one or more portions locally (e.g., at media device(s) 104). In some examples, UI management system 130 can include an instance running remotely (e.g., system server(s) 126) and an instance running locally (e.g., media device(s) 104). The remote and local instances can perform respective tasks/operations or one of the instances (e.g., the remote or local instance) can function as a primary instance configured to perform the operations described herein while the other instance can serve as a backup or load balancing system to assist and/or provide redundance for the primary instance.

In other cases, UI management system 130 can be distributed across devices on a backend (e.g., system server(s) 126) or distributed across edge devices (e.g., media device(s) 104, display device(s) 106, etc.). For example, UI management system 130 can be distributed across devices or resources on a cloud network. As another example, UI management system 130 can be distributed across edge devices, such as media device(s) 104, display device(s) 106, one or more IoT devices, and/or any other local device(s).

UI management system 130 can obtain input data 902 and use it to determine how to configure the user interface. For example, UI management system 130 can use input data 902 to determine a theme(s) for the user interface, an animation(s) for the user interface, a content of the user interface, a content experience provided by the user interface, UI configuration parameters, a UI background, a customize or personalized organization of items in the user interface, UI containers to include (and/or a configuration thereof) in the user interface, visual elements for the user interface, UI elements of the user interface, a behavior of the user interface, etc.

UI management system 130 can obtain input data 902 from such as content server(s) 120, media device(s) 104, display device(s) 106, a social media platform/network, users, an AI/ML model (e.g., an AI/ML prediction model, a large language model (LLM), an object detection model, a recognition model, a generative AI model, etc.), a content platform (and/or associated business), the Internet, a news media, a database, a channel/program guide, a device(s), a sponsor, a content provider, a sensor(s) (e.g., image sensor, ambient light sensor, humidity sensor, temperature sensor, gyroscope, accelerometer, touch sensor, load/weight sensor, motion sensor, proximity sensor, magnetometer, inertial measurement unit, capacitive sensor, etc.), rules, templates, parameters, weights, filters, a blacklist, etc. For example, UI management system 130 can obtain input data 902 from user(s) 140, media device(s) 104, content server(s) 120, the Internet, an AI/ML model, a database, an events store, a content platform, an input(s) and/or decision(s) from a business or platform, a sensor(s), etc.

Input data 902 can include a signal(s) that UI management system 130 can use to select a topic(s) used to select a theme(s) and/or determine how to configure the user interface. For example, input data 902 can include a signal(s) indicating any events, content items, conditions, subjects, activities, and/or other topics that have threshold temporal, relevance, priority, preference, trend, popularity, contextual, and/or user scores, priorities, weights, relationships, rankings, metrics, etc. In some examples, input data 902 can include content statistics, parameters (e.g., weights, filters, values, etc.), UI criteria, a blacklist, filters, inputs, a preference/weight or decision from a business or platform, event data, content information, user data, context information, preferences, activity, social media data (e.g., posts, statistics, trends, connections, subscriptions, patterns, content, activity, etc.), campaign information, event information, etc.

The topic(s) can be used to select a theme(s) for the user interface, as previously described. The theme(s) can be used to configure any aspects of the user interface, such as one or more structures, designs, UI elements (e.g., input elements, navigation elements, buttons, toggles, menus, controls, etc.), visual elements, UI containers (e.g., UI banners, boxes, rows, columns, tiles, cards, sheets, etc.), imagery, attributes, behaviors, characteristics, artwork, and/or other features. For example, the signal(s) in input data 902 can include information used to identify a topic(s) for a theme(s), such as a theme(s) that is relevant to user(s) 140, a context, a date(s), a location(s), a preference(s) and/or interest(s), a trend, an event(s), etc. In some cases, input data 902 can include information about content at content server(s) 120. For example, input data 902 can identify content at content server(s) 120 (and/or scheduled to be available at content server(s) 120), a programming guide, content statistics (e.g., content views and/or viewing/consumption statistics, content ratings, streaming statistics of any content, trending or popularity metrics/statics of any content, information about user interactions with any content, playback statistics of any content, etc.), social media data, content metadata (e.g., genres, actors, topics, metrics, descriptions, subtitles or closed captions, scenes, contexts, activities, events, language information, location or region/country information, titles, characters, release dates, programming schedules, content producers or companies, themes, content tags, etc.), and/or any other information.

At step 904, UI management system 130 can determine, based on input data 902, a theme(s) for a customized user interface (UI). The UI can be customized for user(s) 140, a group of users including user(s) 140, all users of a content platform associated with the UI, or any other user or number of users. UI management system 130 can analyze input data 902 and select a topic(s) of the theme(s) based on input data 902, and determine the theme(s) based on the topic(s) of the theme(s). For example, UI management system 130 can analyze context information, event information, activity information, temporal information, user information, content information, social media data, trends, popularity or ratings information, and/or any other information in input data 902 to select a topic(s) for the theme(s).

UI management system 130 can use the topic(s) to select the theme(s). For example, if the topic includes a comedy sitcom, UI management system 130 can select a comedy sitcom theme. The comedy sitcom theme can include any content, UI experience, UI appearance, UI design, UI element(s), UI container(s), visual element(s), UI organization(s), UI organization (e.g., UI elements, UI containers, content, etc.), UI and/or background color(s) and/or color scheme(s), UI attribute(s), UI animation(s), UI behavior(s), UI style(s), UI structure(s), UI object(s), UI artwork(s), UI imagery, and/or any other feature(s) about, related to, incorporating or including, depicting/conveying, associated with, and/or customized based on the comedy sitcom theme.

The topic(s) can include, for example, a topic that is relevant (or has a threshold relevance) in or to a date, context, location, environment, scenario, user, and/or device associated with the UI (e.g., when or in which the UI is displayed); a topic associated with a context, condition, event, activity, content, subject, trend, and/or category that has a threshold trend metric, relevance metric, temporal metric, popularity metric, user or group preference metric, user or group matching score, business or platform preference metric, priority metric, rank, content statistic, etc.

For example, if input data 902 indicates that a finale of a tour of a popular celebrity is on a particular date, UI management system 130 can determine that the celebrity, content associated with the celebrity (e.g., music, movie, etc.), the tour of the celebrity, a genre of content of the celebrity, a topic or theme of the tour or a content of the celebrity, or any attribute associated with the celebrity and/or the tour has/have a threshold relevance on that date, has/have a threshold trend score on that date, is/are a threshold match for a topic/theme associated with that date, etc. UI management system 130 can determine select the celebrity, content associated with the celebrity (e.g., music, movie, etc.), the tour of the celebrity, a genre of content of the celebrity, a topic or theme of the tour or a content of the celebrity, and/or attribute associated with the celebrity and/or tour as a topic(s) for the theme(s) of the UI displayed on that date (or within a number of days or time increments from that date), and use the topic(s) to select a theme(s) for the UI, such as a theme(s) related to the topic(s) and/or conveying the topic(s) (and/or aspects thereof).

In some cases, input data 902 can include metrics used to determine a level of user interest or relevance, such as attendance and/or viewership statistics of shows in the celebrity tour, metrics associated with content from the celebrity (e.g., views, purchases, subscriptions, chart rankings, etc.), and/or other data associated with the celebrity and/or the tour. UI management system 130 can use such information to determine that the celebrity, content of the celebrity, and/or the tour of the celebrity has/have a threshold popularity, interest, consumption, priority, rank, relevance, match, and/or selection score. UI management system 130 can take such information into account when determining the topic and the theme(s).

In other words, in addition to selecting the celebrity, the celebrity's content, and/or the celebrity's tour as a topic(s) for the theme(s) based on a relationship (e.g., a match) between the current date and the date of the final show in the tour (e.g., a temporal relevance), UI management system 130 can analyze the other metrics, statistics, weights, filters, cues, scores, and/or information to determine a level of interest or popularity as another factor used to select the celebrity and/or tour topic for the theme(s). In such cases, the selected topic for the theme(s) may have a higher relevance score as it would not only have a temporal relevance but also a broader or higher user interest. For example, if UI management system 130 determines that the current date matches the end date of the tour as well as the date of a game, UI management system 130 can determine, based on such temporal cues, that both the tour and the game are relevant to the current date. UI management system 130 may select both topics as the topic(s) of the theme(s) or may pick one of the topics for the theme(s). To select between the topics, UI management system 130 may analyze other data, such as metrics, preferences, weights, filters, rules, etc., as previously described.

For example, UI management system 130 can use metrics in input data 902 to compare a popularity of the game and a popularity of the tour. If the metrics indicate that the game has a lower popularity than the tour, UI management system 130 may select the tour as the topic for the theme(s) rather than the game. UI management system 130 may calculate a higher relevance or score for the tour than the game despite both being temporally relevant, as the relevance scores calculated by UI management system 130 can also account for user popularity. UI management system 130 can then use the tour as a topic of the theme(s). This way, the theme(s) may not only have a temporal relevance but also a popularity relevance that increases the overall relevance of the tour relative to the game.

By considering additional information, UI management system 130 can avoid selecting a theme that has a threshold temporal relevance but a lower popularity or overall relevance given the lower popularity score. For example, if the teams in the game have a smaller fanbase than the celebrity and a lower viewership or user support than the tour, the game may have a lower relevance than the tour to many users even though the game is also temporally relevant. UI management system 130 may optionally forego selecting the game as a topic for the theme(s), or may select the game as a topic but select the tour as a higher priority, more prominent, highlighted, and/or higher-weighted topic for the theme(s). UI management system 130 can select the tour as the topic instead of the game, since it has a higher overall score given that it is not only temporally relevant but also has higher popularity metrics, or can attribute the tour topic a higher emphasis, focus, highlight, and/or prominence for the theme(s) than the game.

In some cases, UI management system 130 can use weights, rules, preferences, and/or blacklists to select between multiple topics, such as multiple topics that satisfy a selection criteria or threshold metric (e.g., the tour and the game in the previous example). In some examples, a content platform or business associated with the UI can provide inputs that can be used as weights, preferences, filters, and/or blacklists for selecting a topic from multiple topics or excluding a topic.

In some examples, UI management system 130 can receive a request or instruction (e.g., from media device(s) 104) for a customized UI (or UI data used to generate, render, and/or display the customized UI). UI management system 130 can use input data 902 to determine a topic(s) (e.g., an event, cue, scene, activity, condition, context, location or landmark, scenario, content, subject, content item, activity, tournament, competition, object, celebration, etc.) for a theme(s) of the UI, and identify the theme(s) based on the topic(s). For example, if the UI is being displayed on a holiday or a celebrated event in a region where media device(s) 104 is located (and thus where the UI is displayed), UI management system 130 may select the holiday or the celebrated event as a topic for the theme(s). To illustrate, if the UI is being displayed on Saint Patrick's Day, UI management system 130 can determine that Saint Patrick's Day is a relevant topic on that day and select a Saint Patrick's Day topic for the theme(s). This way, the UI generated based on the theme(s) can be relevant (e.g., culturally relevant) and have an appearance (e.g., artwork, look, design, content, etc.) that user(s) 140 associates with Saint Patrick's Day. For example, the UI can include green-colored elements, a green background, content (e.g., movies, videos, shows, etc.) related to Saint Patrick's Day, a design (e.g., artwork/imagery, logos, visual elements, etc.) related to Saint Patrick's Day such as a green background and Sain Patrick's Day artwork (e.g., leprechauns, shamrocks, etc.), and thus appear customized for Saint Patrick's Day.

As another example, if input data 902 indicates that the World Cup final is on the day when the UI is being displayed, UI management system 130 can determine that soccer, the World Cup, the World Cup final, and/or the soccer teams in the final are relevant, candidate, and/or high-scoring/ranking topics for a theme of a UI displayed on that day. UI management system 130 can select soccer, the World Cup, the World Cup final, and/or the soccer teams in the final as the topic(s) for the theme(s), and select an associated theme(s) for the UI. The theme(s) can be used to customize the UI to provide a UI appearance and/or experience that relates to, celebrates, and/or promotes the World Cup, the World Cup final, soccer, and/or the soccer teams in the final.

The UI can include features associated with the theme(s), such as colors and/or symbols/logos of the teams playing in the final, soccer and/or World Cup artwork (e.g., an image of the World Cup trophy, an image of the stadium where the final is being played, interface objects shaped like or resembling soccer balls, flags of the countries playing in the final, etc.), content related to soccer and/or the World Cup (e.g., World Cup replays, World Cup highlight videos/clips, a soccer documentary, etc.), content related to the teams in the final and/or associated countries (e.g., previous games of the teams, video highlights of the teams or specific players, documentaries of any of the teams/players or countries, movies based on any of the teams/countries playing in the final, etc.), a UI container(s) (e.g., UI container 702, UI container 734, UI container 760, UI container 802, UI container 822, UI container 852, UI container 870, etc.) incorporating relevant features (e.g., content, UI components, animations, background, visual attributes, artwork, graphics, visual effects, content experiences, etc., related to soccer, the World Cup, the World Cup final, the teams playing in the final and/or associated countries, any player in the final, a host country/city of the World Cup, the World Cup trophy, etc.), and/or any other relevant details.

In some cases, the theme(s) can be additionally or alternatively selected by or based on a sponsor. For example, a sponsor can pay for a theme of any (or certain) UIs of a content platform that are presented on a particular day or period of time (e.g., week, month, etc.). As another example, a sponsor can provide a preference for a theme that can be used as a theme-selection metric such as a weight or factor.

In some cases, the theme(s) can be customized for user(s) 140. For example, if input data 902 indicates that user(s) 140 is a fan of one of the teams in the World Cup final or follows one of the teams, the theme(s) can be tailored based on that team. The UI customized for user(s) 140 based on the theme(s) can include, highlight, and/or promote UI features (e.g., content, UI elements, UI containers, UI design features, UI attributes, visual elements, artwork, graphics, UI appearance, UI style, UI background, UI animations, UI experiences, etc.) related to that team.

As another example, if input data 902 indicates that a popular movie is being released on the day when the UI is being displayed, UI management system 130 can select that movie as a topic of the theme for the UI. The theme can be customized based on that topic (the movie). In some examples, the theme can include any characters, scenes, and/or content in the movie, a logo or background of the movie, a motif or mood of the movie (e.g., if the movie is a horror movie the theme can be a dark or horror theme, if the movie is a romance movie the theme can include features that invoke or convey a romantic mood, etc.), images from the movie, fonts and/or shapes from the movie, references to the movie, an activity in the movie, items related to the movie, etc. In some cases, the theme can promote the movie or an associated movie franchise, movies in the movie franchise (if any), related movies (e.g., movies with a same actor, movies based in a same country or region, movies associated with a same topic, etc.), relevant content or merchandise (e.g., merchandise from the movie, movie collections associated with the movie, etc.), etc.

The theme(s) can include or can be used to determine any features of the UI, such as UI content, UI elements, UI containers, a UI organization, an arrangement of UI elements, an organization of UI containers, a UI background, visual characteristics of the UI and/or UI elements (e.g., colors, patterns, visual effects, shapes, imagery, etc.), any scenes depicted in the UI, brands or products to depict or promote in the UI, UI artwork (e.g., images, logos, symbols, thumbnails, keyframes, shapes, graphics, etc.), a mood of the UI, a UI design, a UI style, information to include in the UI, a structure of the UI, promoted or highlighted content, design elements for the UI, a layout and/or configuration of the UI and/or any UI components (e.g., a UI container, a UI element, a UI content item, a UI background, a UI template, etc.), parameters for any UI elements (e.g., UI element types such as tiles/cards or thumbnails, arrangement of UI elements such as a tile or card row or column, a shape of UI elements such as a size or aspect ratio of tiles and/or UI containers, etc.), an appearance of the UI, an activity or game available from the UI (e.g., a type of activity or game, a topic of an activity or game, etc.), any animations displayed by the UI, a content experience provided by the UI, a behavior of the UI, and/or any other attributes of the UI.

In some examples, the theme(s) can include a UI container(s) (e.g., UI banner, etc.) such as UI container 702 in FIG. 7A, UI container 734 in FIG. 7B, UI container 800 in FIG. 8A, UI container 822 in FIG. 8B, UI container 852 in FIG. 8C, etc. The UI container(s) may or may not be customized based on the theme(s). For example, the UI container(s) can include a background, content, animation, visual elements, and/or any other features associated with the theme(s). In some cases, the theme(s) can specify or dictate what content, animations, visual elements, UI containers, UI elements, organization, style, design, appearance, attributes, experiences, and/or any other features are included or implemented by the UI.

Once UI management system 130 determines the theme(s) for the UI, UI management system 130 can generate the UI or the UI data used to generate and/or configure the UI, as described below with respect to step 908. In some cases, UI management system 130 can optionally determine a UI experience(s) provided by the UI, as described below with respect to step 906. For example, rather than proceeding from step 904 to step 908, UI management system 130 can optionally perform step 906 in addition to step 904 before proceeding to step 908.

At step 906, UI management system 130 can optionally determine a UI experience(s) for the UI based on input data 902 and/or the theme(s) determined at step 904. The UI experience(s) can include, for example and without limitation, any animations that may displayed by the UI, CTAs that may be included in the UI, user and/or content interactions (and/or types of interactions) that may be supported and/or enabled by the UI, activities that may be displayed and/or supported by the UI, behaviors and/or actions that may be configured on or performed by the UI, outputs of the UI, games that may be displayed/provided and/or configured on the UI, challenges that may be configured on the UI, content item references (e.g., hidden messages or clues pertaining to specific content items such as movies or TV shows), and/or any other interactions between user(s) 140 and the UI (and/or content/features thereof).

For example, if UI management system 130 selects to promote a particular feature of the UI, UI management system 130 can determine whether to promote the feature by using an animation, as previously described, by configuring the UI (or aspects thereof) or the feature to have a certain appearance used to promote or highlight the feature (e.g., adjusting a size, placement, and/or visual attribute of the feature), by configuring the UI to provide a game or activity that may draw the user's attention to the feature, and/or by determining any other way to promote the feature. To illustrate, UI management system 130 can select to configure the UI to display content item references representing hidden messages/clues for a game or activity and invite user(s) 140 to take part in the game/activity. UI management system 130 can display a content item reference(s) on or around (e.g., adjacent to, within a proximity of, etc.) the feature or hide the content item reference(s) within/behind the feature to try to draw the attention of user(s) 140 to the feature via the content item reference(s) as part of the game/activity.

If UI management system 130 determines to use an animation to promote the feature, UI management system 130 can determine what animation and/or type of animation to use to promote the feature and/or how to configure such animation. For example, UI management system 130 can determine to configure the feature to be animated to draw the user's attention to the feature. As another example, to draw the user's attention to the feature in order to promote it, UI management system 130 can determine to configure an object to interact with the feature or move the feature to a UI location where the feature is then displayed, or animate other content in a way that draws the user's attention to the feature.

As another example, to promote the feature, UI management system 130 can select to configure the UI to invite, encourage, draw, or enable user(s) 140 to explore the feature in the UI in exchange of a benefit to user(s) 140 that incentivizes user(s) 140 to use or explore the feature as a way to promote the feature. The benefit can include, for example, unlocking a clue for a challenge, such as a game or a puzzle, unlocking a content add-on, receiving a credit, receiving a discount or free/discounted content, receiving a subscription or a subscription a credit or discount, receiving access to paid content, being promoted within UIs displayed on devices of other users (e.g., having a user avatar of user(s) 140 displayed on UIs presented to other users, being recognized in the UIs presented to other users, etc.), unlocking a feature/functionality, etc.

To illustrate, if the feature includes an advertisement, UI management system 130 can select to configure the UI to invite user(s) 140 to watch the advertisement in exchange for a benefit, such as unlocking a clue for a puzzle or receiving an add-on. If the feature includes a control setting used to implement or adjust a functionality, to promote the control setting, UI management system 130 can select to configure an animated UI element, such as an object or content item, that interacts with a portion of the UI used to access the control setting (or that displays a control element used to adjust/manage the control setting) or that interacts with each UI element that user(s) 140 would need to access to get to the control setting. For example, assume that, to reach the control element associated with the control setting, user(s) 140 would need to navigate to a menu, within the menu navigate to a first submenu, within the first submenu navigate to a second submenu, and the control element can be found within the second submenu.

In this example, UI management system 130 can select to configure the UI to display an animation that draws the attention of user(s) 140 to the menu to encourage user(s) 140 to navigate to the menu (e.g., an animation that interacts with the menu, an animation that places or drops a visual element on or about the menu, an animation that animates the menu, etc.). Once user(s) 140 navigates to the menu, the UI can display another animation that steers user(s) 140 towards the first submenu. Once user(s) 140 navigates to the first submenu, the UI can display another animation that steers user(s) 140 to the second submenu. Finally, once user(s) 140 navigates to the second submenu, the UI can display an animation that draws the attention of user(s) 140 to the control element. This way, the animations can provide a journey or navigation experience that leads to the control element to push user(s) 140 to explore or learn the control element. In this way, the animations can follow a journey or storyline and provide clues, signals, or “breadcrumbs” along a navigation path or journey that eventually lead user(s) 140 to the feature being promoted.

In some cases, the UI experience(s) can include an immersive experience involving content, UI functionalities, activities, or games. For example, the UI experience(s) can include a puzzle on the UI and clues that user(s) 140 can find by answering questions and can use to help user(s) 140 solve the puzzle. The clues can be placed somewhere in the UI so as user(s) 140 navigates the UI and performs an action, (e.g., selects a content item, watches a content item such as a movie or an advertisement, uses a part of the UI or a feature for a first time, etc.) the UI unlocks a corresponding clue that may appear in a game. In some examples, clues can be dispersed throughout UI pages, sections, contents, features, screens, UI containers, and/or any other locations. The UI experience(s) can include a game or journey where user(s) 140 can uncover clues at specific destinations until user(s) 140 finds the last clue (and/or all clues).

The UI experience(s) can optionally include interactions. For example, the UI experience(s) can include an option that allows user(s) 140 to select a favorite team in a sport. The UI can receive an answer identifying a team and display a comparison of the team pick of user(s) 140 with the teams picked by other users in the content platform to show user(s) 140 how the team preference of user(s) 140 compares to the team preferences of other users in a community of users. In some cases, the UI experience(s) can allow user(s) 140 pick or suggest UI themes, UI theme changes, content item references to display in the UI or as part of a theme, hidden messages/clues or surprises (also referred to as “Easter eggs” herein) to display in the UI and/or a location in the UI to display them, etc. The Easter eggs can be placed or hidden anywhere in the UI. For example, an Easter egg can be hidden in a control element for a specific setting, such as a closed caption setting or a video setting, to encourage users to explore or discover the specific setting. If user(s) 140 finds the Easter egg, the UI can display a celebration (e.g., a celebration that user(s) 140 found the Easter egg or landed on a special UI destination) such as an image of user(s) 140 or a name of user(s) 140 being depicted in a background or screensaver associated with a UI theme.

If the UI is being displayed on a particular holiday or a celebrated day, such as Halloween, the UI experience(s) can provide a Easter egg hunt challenge/game where Easter eggs are placed throughout the UI or a background city theme. Users can try to find the Easter eggs to win the challenge/game. The challenge/game can help users become familiar with the UI, discover features on the UI, learn certain aspects of the UI, explore new locations of the UI, learn how to access certain features of the UI, become more proficient with the UI, among other benefits. Users can win awards or other benefits for winning the challenge/game as previously mentioned. In some cases, a behavior of an Easter egg can change dynamically based on one or more conditions. For example, assume that a weather balloon from a popular movie is depicted in the UI and used as an Easter egg that is hidden within a background of the UI. As the number of users who find the weather balloon (the Easter egg) increases, the weather balloon can grow or move. The weather balloon can be configured to eventually burst or disappear to provide a timeliness constraint so users are encouraged to find the weather balloon faster.

In some examples, the UI experience(s) can be configured to assist user(s) 140 to setup a new device or profile. For example, the UI can display animations or highlight UI areas during a device or profile setup or activation/registration. The animations or highlighted UI areas can help the user learn the UI, discover UI features, etc. The UI can include Easter eggs that steer users to certain features and/or spaces, or engage in certain activities. To illustrate, to help user(s) 140 calibrate microphone(s) 112 on remote control(s) 110 or a voice recognition feature based on audio recorded by microphone(s) 112, the UI can display interactive content that prompts or encourages user(s) 140 to submit verbal commands or utterances through microphone(s) 112. This way, the UI can try to drive user(s) 140 to provide more voice commands or utterances that can be used to calibrate microphone(s) 112 or the voice recognition feature and make the calibration process easier/seamless for user(s) 140.

In some cases, the UI experience(s) at step 906 can relate to or be based on the theme(s) selected for the UI. For example, if the theme(s) includes a football theme, the UI experience(s) can involve football content, a football activity, a football game, and/or can be configured to have a visual appearance associated with football. Thus, UI management system 130 can take into account the theme(s) selected for the UI when determining a UI experience(s) for the UI (if any).

UI management system 130 can use any portion of input data 902 to help determine the UI experience(s). For example, UI management system 130 can use input data 902 to determine that a movie is being released on a particular day and select the movie as a theme for the UI. UI management system 130 can use this information to determine a UI experience(s) used to promote the movie on the day of release. This way, the UI experience(s) relates to the theme(s) of the UI and the movie release. As another example, if input data 902 indicates that a sponsor has paid to have a channel of the sponsor promoted, UI management system 130 can select a UI experience(s) configured to promote the channel of the sponsor through the UI.

If input data 902 includes a blacklist of topics that should not be used for a theme, UI management system 130 can use the blacklist to avoid UI experiences related to such topics. If input data 902 includes preferences (e.g., user preferences, business preferences, etc.) or topic weights, UI management system 130 can use the preferences or topic weights to select a UI experience from multiple candidate UI experiences or rank the multiple candidate UI experiences.

The UI experience(s) can optionally include an animation. In some aspects, UI management system 130 can provide a customized animation. For example, UI management system 130 can determine a set of features associated with the UI, select a feature from the set of features based on the theme(s) of the UI and/or a respective selection parameter of each feature from the set of features, generate (e.g., via an AI/ML model) animated content for the UI that depicts the selected feature and/or an interaction between the animated content and a portion of the UI associated with the selected feature, and provide the animated content to the UI (e.g., for display) and/or media device(s) 104 associated with user(s) 140.

The features can include a content item (e.g., movie, TV show, podcast, video game, image, interactive content, music item, etc.), a UI functionality (e.g., language functionality, closed captions, subtitles, accessibility functionality, display functionality, UI behavior, operation, playback functionality, streaming functionality, output functionality, interactive functionality, etc.), a setting of the UI (e.g., volume setting, accessibility setting, resolution setting, brightness setting, language setting, frame rate, picture quality setting, control setting, playback setting, display setting, output setting, channel setting, TV setting, etc.), a destination of the UI (e.g., UI page, container, section, UI element, content item destination, toolbar, menu or menu item, etc.), and/or any other feature. The respective selection parameter can define a feature preference, feature priority, feature metric, and/or feature relevance with respect to a date (e.g., a date associated with a presentation of the UI such as a date when the UI is displayed/rendered, a date of an event, a date in which the feature has a different significance than in other dates, etc.), user(s) 140, an application associated with the UI, a topic, an event, and/or any other signal.

The feature preference can be based on a preference of user(s) 140, a group of users, the application, an entity associated with the application, a sponsor, a business preference, a content provider preference, an advertiser preference, a preference statistic, and/or any other preference. The feature priority can be based on a feature trend score, a feature popularity, a feature promotion associated with a sponsor (e.g., an indication from the sponsor of a desire to promote the feature, a request to promote the feature, payment for promoting the feature, etc.), a feature interest score (e.g., a score representing an interest of user(s) 140, a group of users, a sponsor, a business, an entity associated with the UI/application, an interest rating chart or source, etc.), a respective count of references in one or more sources to a feature topic (e.g., how many times the feature or a topic of the feature was referenced, discussed, mentioned, etc.), and/or any other priority signal. The one or more sources can include a media source (e.g., news media, entertainment media, etc.), a social media network, the UI, and/or any other source.

In some aspects, the feature metric can include a feature request count, a feature statistic (e.g., a feature usage statistic, a feature feedback statistic, a feature access count or statistic, a number of times or percentage of times that users (or user(s) 140) used or ignored the feature, etc.), a feature selection weight specified by the application, user(s) 140, and/or an entity (e.g., an entity associated with the application, a sponsor, a content provider, etc.), and/or a feature performance value (e.g., a feature cost, a feature value to users, a feature usage, a feature rating, an amount of times the feature led to a particular user action such as playback of associated content or an associated conversion action such as a purchase of a product or content, how often or how many times did users ignore the feature or used the feature, a revenue attributed to the feature, how often or how many times did the feature result in an intended outcome or action when provided to users or in UIs, etc.), and/or any other weight or metric.

The feature relevance can be based on a relationship between each feature and a date, a context, a trend with a trend score, a user location, a user input, an event, a calendar, and/or any other relevance signal. In some cases, the feature can include a setting of the UI, and the animated content can depict an object or animated graphic interacting with a control element used to configure the setting, a portion of the UI associated with the feature, each UI element along a navigation path to a control element used to configure the setting, user(s) 140, a content item, etc. In some examples, the portion of the UI associated with the feature can include an area of the UI that includes/depicts the control element, such as a UI section that has the control element, a UI container that has the control element, a toolbar, a menu, an interface object, etc.

In some cases, the feature can include a functionality of the UI, and the animated content can depict an action of an object or animated graphic. The action can include, for example, an interaction with a control element associated with the functionality, an interaction with a UI area associated with the functionality, an animation that visually depicts a UI behavior associated with the functionality (e.g., an animation of what the functionality does, an operation of the UI associated with the functionality, etc.), an animation determined based on a UI behavior associated with the functionality, etc.

In some examples, the feature can include the destination of the UI, and the animated content can depict an object or animated graphic moving along a UI path and reaching the destination of the UI. The destination of the UI can include, for example, a UI element, an object configured to provide access to a media content item, a UI page, a UI section, a UI toolbar, a UI container, and/or any other destination.

In some aspects, UI management system 130 can determine that the date (e.g., the date when the UI is displayed) corresponds to a scheduled event. The scheduled event can include, for example, a content release date or promotion, a formal holiday recognized by one or more entities, an informal holiday including a commemorative day celebrated by one or more users, a game, a competition, an announcement, a news event, a political event, a community event, or any other event. Based on the determination that the date corresponds to the scheduled event, UI management system 130 can determine which feature has a highest selection parameter. The highest selection parameter can include a highest feature preference score, a highest feature priority, a highest feature metric, a highest feature relevance, and/or any other parameter. UI management system 130 can select the feature that has the highest selection parameter and generate the animated content based on the selected feature.

In some cases, UI management system 130 can select the feature further based on user data. The user data can include, for example, a user preference, a user input, a user history, a user interaction, a user purchase, a user characteristic (e.g., demographic, user experience, professional history, education, interests, etc.), a user activity, a user profile, and/or any other user information.

At step 908, UI management system 130 can generate UI data 910 based on the theme(s) selected for the UI and optionally based on the UI experience(s) selected (if any). UI data 910 can include the UI and/or data used to generate, render, and/or display the UI. The UI can be customized with the theme(s) and optionally include the UI experience(s) (if any).

In some cases, UI data 910 can include parameters used to configure and customize the UI based on the theme(s) (and optionally the UI experience(s), if any). The parameters can specify any content, UI elements (e.g., tiles, cards, input elements, navigation elements, output elements, controls, etc.), UI containers (e.g., UI banners, UI sections, etc.), UI behaviors, an organization and/or arrangement of items in the UI (e.g., UI containers such as UI banners and/or UI sections, UI elements such as tiles/cards and/or input elements, visual content and/or attributes (e.g., images, animations, visual elements, colors, color schemes, artwork, thumbnails, a background(s), a screensaver(s), graphics, visual effects, logos, symbols, etc.), style parameters (e.g., UI style parameters, UI fonts, UI element/container shapes and/or sizes, UI element/container borders or frameless settings, UI element types, etc.), UI design parameters, a UI structure, UI experience information, UI activities, content groupings or categories, content items (e.g., movies, TV shows, video games, etc.), UI appearance parameters, user personalization parameters, content types, types of UI design elements, etc. The UI parameters can implement, convey, include, depict, and/or relate to the theme(s) and/or can be customized for and/or based on the theme(s). In some cases, the UI parameters can also be used to configure the UI experience(s) determined at step 906.

In some cases, UI data 910 can include a UI customized based on the theme(s). The customized UI can optionally include the UI experience determined at step 906 (if any). UI management system 130 can send UI data 910 to media device(s) 104 which can use UI data 910 to render/display the customized UI. In other cases, UI data 910 can include the data used to generate and/or render the UI, such as instructions, parameters, objects, code, UI components, a UI template, etc. UI data 910 can be used to customize/configure the UI to include the theme(s) and the UI experience(s) (if any), such as any of the UIs shown in FIGS. 3A through 8C.

In some cases, UI management system 130 can provide UI data 910 to display device(s) 106, which can use UI data 910 to display/render the UI. In other examples, UI management system 130 can provide UI data 910 to media device(s) 104, and media device(s) 104 can use UI data 910 to display the UI or trigger display device(s) 106 to display the UI. In some cases, UI data 910 can include the UI to be displayed/rendered at display device(s) 106. For example, in a server-side rendering scenario, UI data 910 can include the UI generated by UI management system 130. UI management system 130 can provide the UI (e.g., UI data 910 in this example) to media device(s) 104 or display device(s) 106 for display. Alternatively, in a client-side rendering scenario, UI data 910 may include the data used to generate/build the UI at the edge (e.g., locally). In this scenario, rather than UI management system 130 building the UI and providing the generated UI, UI management system 130 can provide data used by media device(s) 104 or display device(s) 106 to generate/build and/or render the UI for display.

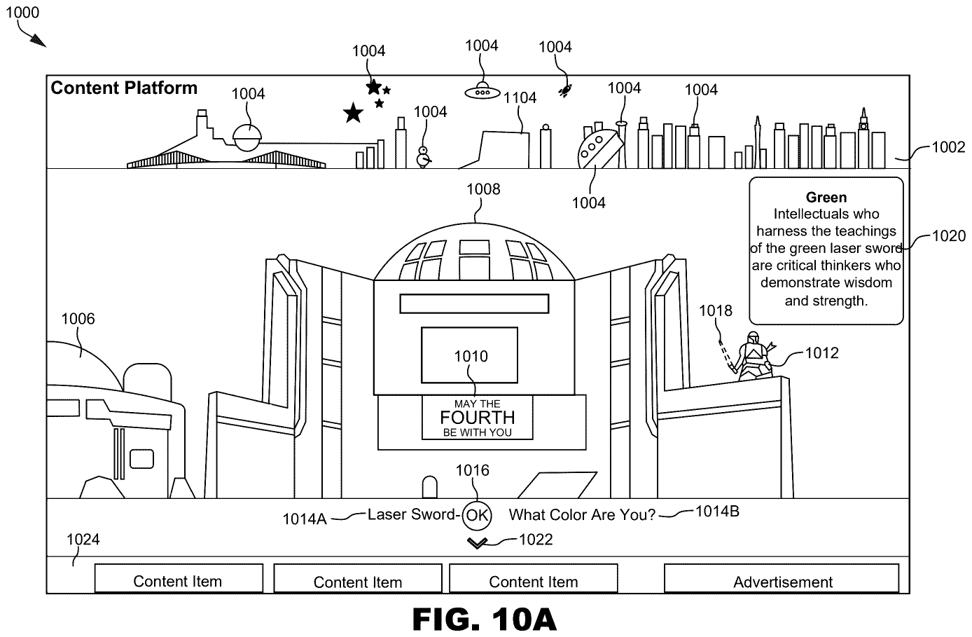

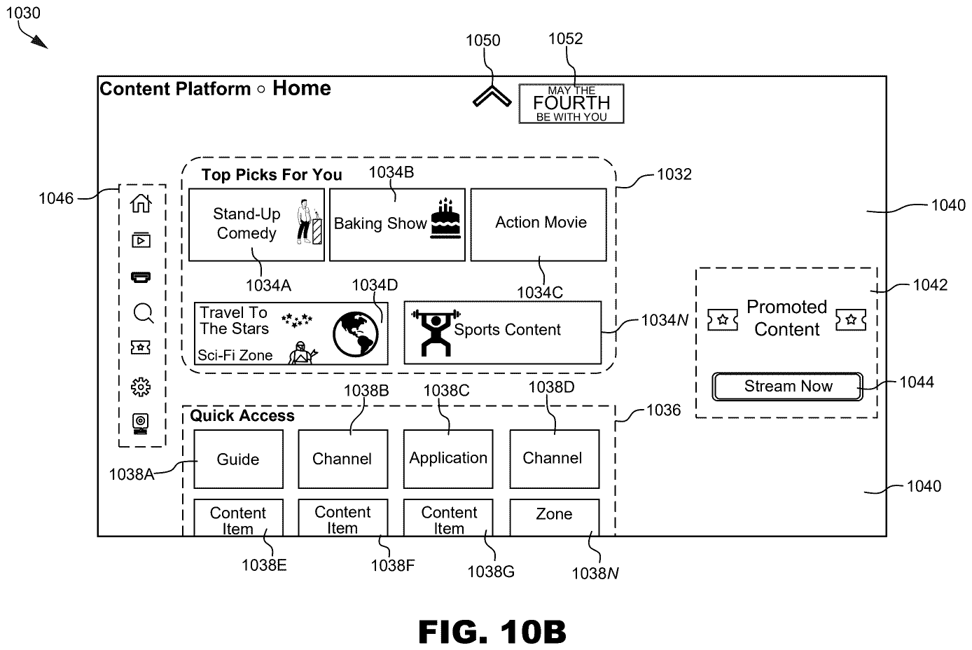

In some examples, the immersive experiences provided to users by a UI can include, solicit, and/or enable various levels of user interaction and/or inputs, including no explicit user interaction and/or input or any amount of user interaction and/or inputs. FIGS. 10A through 12B illustrate example user interfaces configured to provide, enable, and/or prompt for different types and/or levels of user interactions.

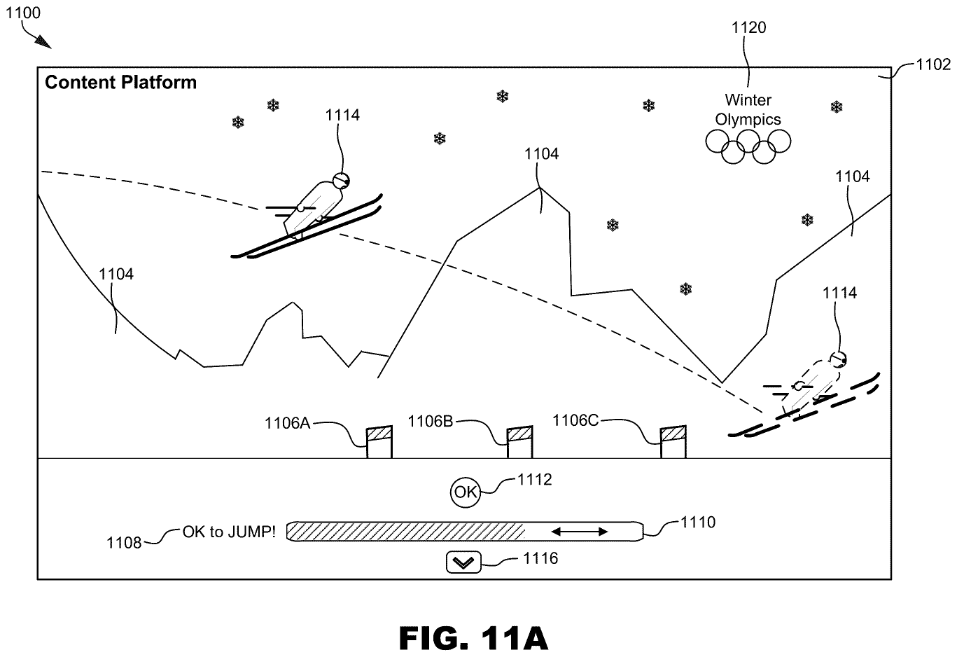

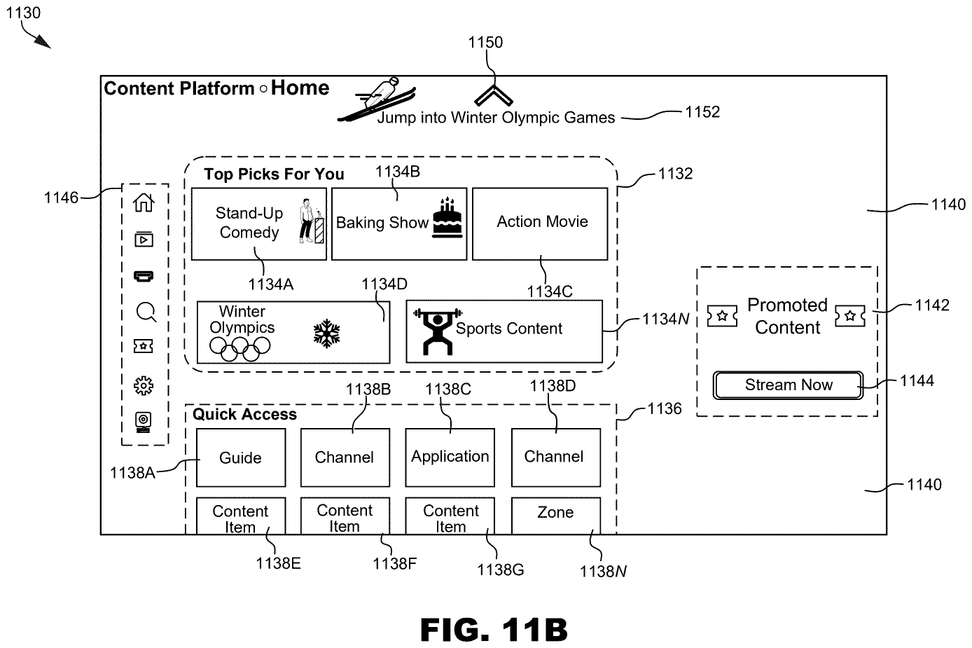

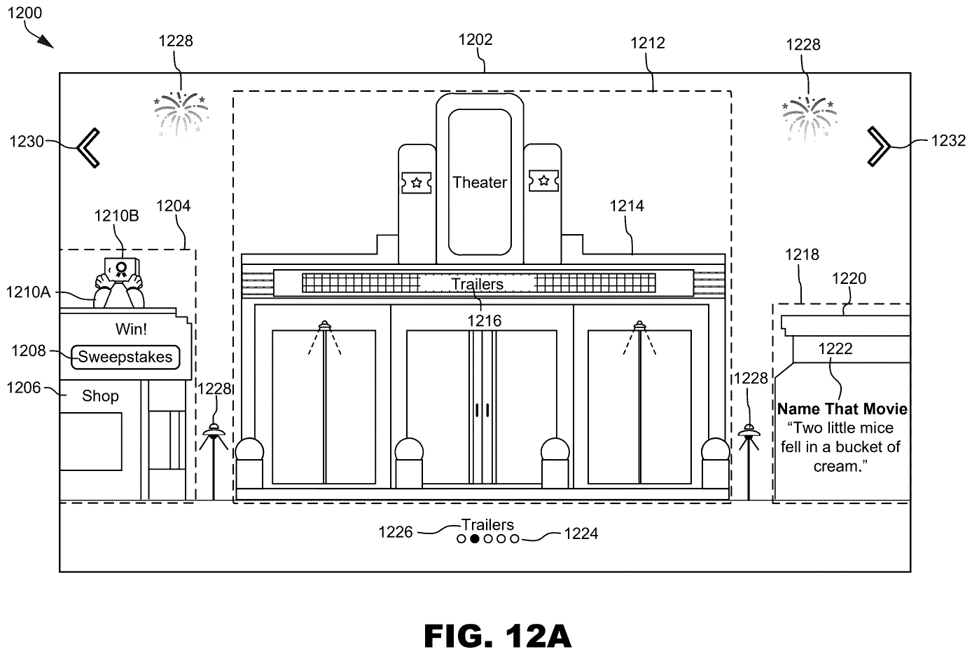

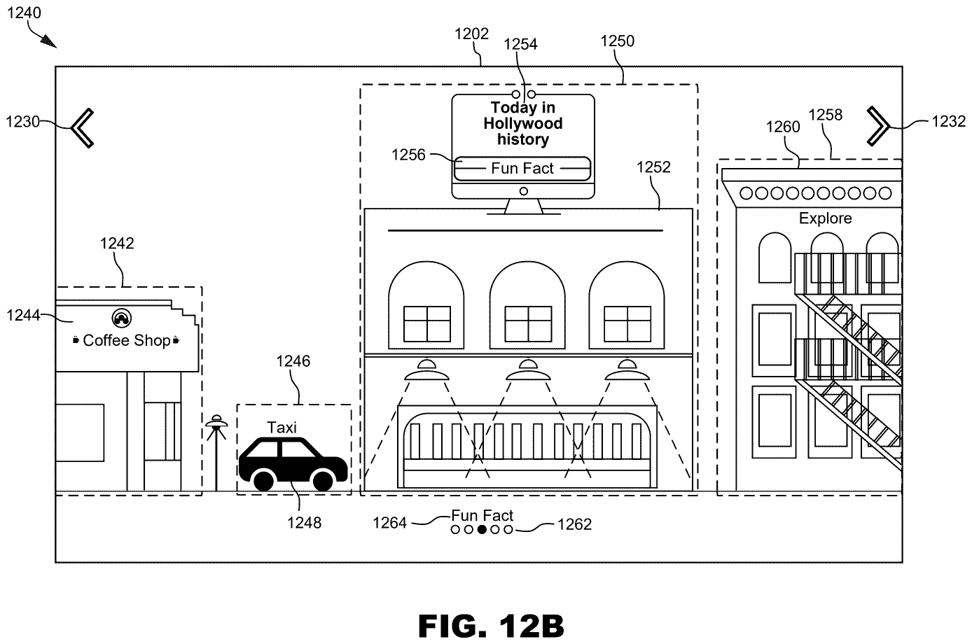

FIG. 10A is a diagram illustrating an example UI 1000 customized to include a theme(s) and provide an immersive user experience. In this example, the immersive user experience enabled by UI 1000 is more limited or passive than the immersive user experiences enabled by the UIs illustrative in FIGS. 11A through 12B. For example, UI 1000 in this example implements a space theme 1002 that is based on the “May The Fourth Be With You” topic associated with a space-related media content franchise. The space theme 1002 includes visual elements 1004 used to depict aspects of the space theme 1002. The space theme 1002 also includes space structures 1006 and 1008 depicted by UI 1000. The space structures 1006 and 1008 are associated with the space theme. For example, the space structures 1006 and 1008 can include space buildings, which may or may not match or correlate to space buildings depicted in the space-related media content franchise, such as space stations, space homes, space theaters, etc.

In this example, the space building 1008 depicts a visual message 1010 related to the space theme 1002. For example, the visual message 1010 in FIG. 10A includes the message “May The Fourth Be With You”, which corresponds to the theme of UI 1000 and is associated with the space building 1008. The space building 1008 also includes a space character 1012, which in this example is used in the immersive experience provided to the user(s) 140.

UI 1000 can include a navigation element 1022 that allows the user(s) 140 to navigate to destination 1024. The user(s) 140 can use navigation element 1022 to navigate to destination 1024 after the immersive experience is complete or at in other time. For example, the user(s) 140 can use navigation element 1022 to skip the immersive experience and navigate to destination 1024. The destination 1024 can include a content zone, a UI sheet, another UI space, another UI or UI page, another UI section, or any other destination.

UI 1000 can depict a UI element 1016 that the user(s) 140 can use to initiate/trigger the immersive experience. In some cases, the immersive experience may only be initiated if the user(s) 140 accepts the immersive experience via the UI element 1016 depicted by UI 1000. In some cases, the user(s) 140 can use the UI element 1016 to initiate the immersive experience at any time that the user(s) 140 wants to access the immersive experience. For example, the user(s) 140 can trigger the immersive experience by selecting or activating the UI element 1016.

UI 1000 can optionally include a visual indicator 1014A associated with the UI element 1016. The visual indicator 1014A can provide information and/or input options associated with the immersive experience. For example, the visual indicator 1014A can describe the immersive experience and/or type of immersive experience triggered by or accepted via the UI element 1016, identify a name/title and/or aspect of the immersive experience, and/or indicate that the UI element 1016 is an interactive element that the user(s) 140 can select or activate to trigger or accept an associated immersive experience.

The immersive experience can relate to the space theme 1002, a topic selected for promotion by UI management system 130, the user(s) 140 and/or a profile of the user(s) 140, and/or any other cue, topic, or UI feature. For example, in FIG. 10A, the immersive experience includes a laser sword experience, which relates to the space theme 1002 of UI 1000. In some cases, UI 1000 can display a prompt 1014B associated with the laser sword experience. The prompt 1014B can be displayed anywhere in UI 1000, such as near or in relation to UI element 1016, which user(s) 140 can use to trigger or accept the immersive experience.

For example, prompt 1014B in FIG. 10A includes the question “what color are you?”, which indicates that the laser sword experience associated with visual indicator 1014A is based on, depicts, relates to, and/or depends on the laser sword color selected. In some cases, UI 1000 can automatically select a laser sword color for user(s) 140. UI 1000 can automatically select a laser sword color to use for the laser sword experience based on a user profile, user preferences, user statistics, user content interactions, a user history, user demographics, a context of the user(s) 140, user data, and/or any other factors.

In some examples, UI 1000 can automatically select a laser sword color based on a context, a preference of a platform associated with UI 1000, a user input, a promotion, a random selection, and/or any other selection strategy. UI 1000 can additionally or alternatively ask the user(s) 140 to select or input a laser sword color for the immersive experience. For example, when the user(s) 140 selects or activates the UI element 1016, the user(s) 140 can also provide an answer to the prompt 1014B, such as a selected laser sword color, or can be prompted to input a laser sword color for the immersive experience.

The immersive experience can include an animation of a laser sword 1018 held by the space character 1012 depicted on the space building 1008. The laser sword 1018 can represent a fictional, illuminated laser sword used by characters of the space-related media content franchise associated with the space theme 1002 and the associated “May The Fourth Be With You” topic. When the user(s) 140 selects or activates the UI element 1016, UI 1000 can depict an animation that shows the laser sword 1018 changing from a retracted state where the illuminated laser blade of the laser sword 1018 is not shown, to an extended state where the illuminated laser blade of the laser sword 1018 is shown. The animation can depict the illuminated laser blade extending from a grip of the laser sword 1018 until the illuminated laser blade is in an extended position. The laser sword color selected can drive the immersive experience. For example, the illuminated laser blade of the laser sword 1018 can be illuminated according to the color selected based on the prompt 1014B. For example, in FIG. 10A, the color selected is green. Accordingly, the illuminated laser blade of the laser sword 1018 shown in the animation can include a green-colored laser blade.

In some cases, the animation can include sound/audio. For example, as the illuminated laser sword of the laser sword 1018 is extended or released to the extended state, the animation can output a sound (e.g., via a speaker device(s)) representing a sound made by the laser sword 1018 when the laser sword 1018 releases the illuminated laser blade.

The animation can also depict other features based on the color selected. For example, the animation can depict a message 1020 providing information selected based on the color selected. In this example, the selected color is green, and the message 1020 indicates that the selected color is green and provides information, such as trivia or a fun/fictitious message selected for the color green and/or the associated immersive experience. In some cases, the information in the message 1020 can be generated by UI management system 130, an application/platform associated with UI 1000, or an entity associated with the application/platform. In some cases, the information in the message 1020 can additionally or alternatively be retrieved from one or more additional sources or derived based on information from the one or more additional sources. The one or more additional sources can include a third party, the Internet, an external database or data store, an external server, a repository, and/or any other source. In some cases, UI management system 130 and/or media device(s) 104 can access the information in the message 1020 (and/or information used to derive the message 1020) from the one or more additional sources via a query, an interface (e.g., an application programming interface (API), etc.), network connection, a message, a subscription, a push or pull data acquisition strategy, and/or any other strategy/technology. Once the immersive experience is complete, UI 1000 can transition to UI 1030 shown in FIG. 10B.

FIG. 10B is a diagram illustrating an example customized UI 1030 that includes content related to the immersive experience and theme of UI 1000 shown in FIG. 10A. For example, UI 1030 can include a content section 1032 with content items 1034A-N (collectively “content items 1034” hereinafter). The content items 1034 can include tiles that the user(s) 140 can select to access or navigate to associated content or destinations, such as media content, media applications, media channels, content pages, etc. One or more of the content items 1034 can be based on the immersive experience and/or theme associated with UI 1000 shown in FIG. 10A. For example, content item 1034D depicts a tile that the user(s) 140 can use to access a space-related content item or a destination where the user(s) 140 can access a space-related content item(s). The space-related content item(s) can be selected based on the space theme 1002 of UI 1000 and/or a “laser sword” immersive experience provided by UI 1000.

UI 1030 can optionally include another content section 1036. Content section 1036 can include content items 1038A-N (collectively “content items 1038” hereinafter) accessible by the user(s) 140 from content section 1036. The content items 1038 can include movies, TV shows, media channels, media guides, media applications, content zones, podcasts, videos, music, video games, and/or any other type of content. UI 1030 can optionally depict a promotion 1042 of content. The promotion 1042 can include a UI element 1044 that the user(s) 140 can use to access the promoted content, such as a button or input element that the user(s) 140 can use to stream, watch, download, play, and/or otherwise access the promoted content.

UI 1030 can include a toolbar 1046 with toolbar items such as menus, menu items, settings, controls, navigation elements, linked destinations (e.g., pages, UI zones, UI spaces, etc.), etc. UI 1030 can also include a navigation element 1050 that the user(s) 140 can select to access and/or navigate to an immersive experience. For example, the user(s) 140 can select the navigation element 1050 to return to UI 1000 and optionally access the immersive experience in UI 1000, replay and/or continue the immersive experience, trigger another immersive experience configured for or based on a different laser sword color selection, access a related immersive experience, etc.

UI 1030 can depict an indication 1052 of the immersive experience associated with navigation element 1050. For example, the indication 1052 can identify the specific immersive experience accessible via navigation element 1050, the theme of the immersive experience, a title of the immersive experience, and/or any other related information. As previously noted, in some cases, the immersive experience can include a level of user involvement and/or inputs. For example, instead of providing a passive experience where the user(s) 140 merely accepts/triggers the immersive experience and passively engages with the immersive experience, the immersive experience can, in some cases, include more user engagement, participation, and/or inputs.

FIG. 11A is a diagram illustrating another UI 1100 that provides another immersive experience that is customized based on a theme and includes more user participation, interaction, and/or engagement. In this example, the immersive experience depicted by UI 1100 includes a game 1102 related to a winter Olympics theme 1120. The game 1102 includes a skiing game where the user(s) 140 can control a skiing jump by a character 1114 depicted in UI 1100. As shown, UI 1100 depicts a ski slope 1104 that character 1114 can use to perform a ski jump similar to a ski jump competition in the winter Olympics. UI 1100 also depicts ski flags 1106A-C used to measure the distance of the ski jump executed by character 1114, and thus the performance of the user(s) 140 in the immersive experience.

UI 1100 depicts a UI element 1112 that the user(s) 140 can select or activate to initiate the ski jump executed by character 1114. UI 1100 depicts an indication 1108 of how to trigger the immersive experience. In this example, the indication 1108 indicates that the user(s) 140 can select OK (e.g., UI element 1112) to initiate the ski jump. UI 1100 also depicts a control element 1110 used to control the ski jump executed by character 1114. The control element 1110 include a bar that begins to fill with color when user(s) 140 activates/triggers UI element 1112 (e.g., selects OK). The user(s) 140 can select OK (e.g., UI element 1112) a second time to stop filling the bar. Once the user(s) 140 selects OK again (e.g., UI element 1112) the fill levels of the bar stop changing (e.g., the bar stops filing or emptying/reversing in cases where the bar has completely filled and started to reverse/empty because the user(s) 140 has not stopped the fill/empty progress of the bar) and the fill levels of the bar are frozen and applied to the ski jump (e.g., translated into a ski jump strength or performance). Alternatively, in other cases, rather than initiating the bar filling process/progress by selecting OK (e.g., UI element 1112) and terminating the bar filling process/progress (e.g., stopping/freezing the fill levels/progress of the bar so the fill levels at the time are applied to the ski jump) when the user(s) 140 selects OK again, the user(s) 140 can select OK (e.g., UI element 1112) to initiate the fill progress/process and continue to hold/select/activate OK (e.g., UI element 1112) and release it (e.g., stop holding, selecting, or activating UI element 1112) when the user(s) 140 wants to stop/freeze the fill levels/progress of the bar such that the fill progress/process of the bar is initiated and continued by selecting and holding UI element 1112 and terminated/completed when the user(s) 140 releases UI element 1112 (e.g., stops pressing/holding, selecting, or activating UI element 1112).

The fill amount or percentage of the bar when the fill process/progress is stopped/frozen/terminated can represent the strength and performance of the ski jump by character 1114. In other words, the fill amount or percentage of the bar when the fill process/progress is stopped/frozen/terminated can be translated into the strength and/or performance of the ski jump applied. The best performance of the ski jump is achieved when the final fill level of the bar is maximized (e.g., when the bar is full (completely filled) when the fill process/progress is stopped/frozen/terminated). If the user(s) 140 is not able to time the trigger to stop filling the bar (or emptying/reversing the fill levels of the bar) such that the bar is completely filled when the user(s) 140 stops the fill progress/process, the greater the amount or percentage of the bar that is filled when the user(s) 140 stops the fill progress/process, the longer the distance of the ski jump achieved by character 1114 and thus the better the performance of user(s) 140 in the immersive experience (e.g., the ski jump).

In some cases, if the bar is completely filled before the user(s) 140 stops the fill progress/process, the bar may begin emptying (e.g., reversing the fill levels) such that stopping the fill progress/process too soon or too late (e.g., relative to a time when the bar reaches a full level) can both reduce the performance of the ski jump. Thus, the amount or percentage of the bar filled when the user(s) 140 stops the fill progress/process after the bar has completely filled and started reversing the fill process/progress will depend on the timing when the user(s) 140 stops the fill reversal such that the longer the delay between the time when the bar is full and starts emptying/reversing and the time when user(s) 140 stops the fill progress/process, the less that the bar is filled when the fill progress/process and thus the lower the performance of the user in the immersive experience (e.g., the shorter the distance of the ski jump of character 1114). This way, the user(s) 140 cannot simply wait until the bar is completely filled to stop the fill progress/process (e.g., via UI element 1112) and rather has to accurately time when to select or release OK (e.g., UI element 1112) as the progress of the bar will start reversing after the bar is full if the user(s) 140 does not stop the fill progress/process in a timely manner.

In other words, the user(s) 140 can use UI element 1112 to initiate the bar filling animation of the bar depicted by control element 1110 and stop the animation, and the fill amount or percentage of the bar depicted by control element 1110 when the animated fill progress/process is stopped/terminated will dictate the strength and thus the distance of the ski jump by character 1114. Therefore, to achieve a better performance, the user(s) 140 needs to time when to stop the animated fill progress/process of the bar depicted by control element 1110 with the aim of stopping it when the bar is as full as possible or, if the user(s) 140 stops the fill progress/process after the bar reached a full level and started reversing/emptying, the user(s) 140 needs to stop the fill progress/process as soon as possible after the fill progress/process starts reversing/emptying to reduce how much of the fill level of the bar is reversed/reduced.

The ski jump experience in UI 1100 can provide an entertaining experience and relate to a custom theme, such as the winter Olympics in the example shown in FIG. 11A. The user(s) 140 can perform the ski jump more than once. For example, the user(s) 140 can continue playing the game 1102 multiple times. If the user(s) 140 wants to navigate to other content, the user(s) 140 can select navigation element 1116 in UI 1100, which allows the user(s) 140 to navigate to a destination, such as a bottom sheet, a UI page, a UI content zone, etc. In some examples, when the user(s) 140 navigates to other content or UI 1100 transitions to another UI, the content presented to the user(s) 140 and/or made available to the user(s) 140 can optionally include content related to a theme of the game 1102, such as the winter Olympics

For example, with reference to FIG. 11B, the user(s) 140 can navigate from UI 1100 to UI 1130 shown in FIG. 11B. UI 1130 can include a content section 1132 with content items 1134A-N (collectively “content items 1134” hereinafter) and optionally content section 1136 with content items 1138A-N (collectively “content items 1138” hereinafter). The content section 1132 can include tiles that user(s) 140 can use to access content items 1134, and the content section 1136 can include tiles the user(s) 140 can use to access content items 1138. As shown, the tile associated with content item 1134D in content section 1132 indicates that content item 1134D includes winter Olympics content, such as a winter Olympics video, game, channel, event, competition, video game, and/or any other content.

In some cases, UI 1130 can also include promoted content 1142. User(s) 140 can play, stream, watch, download, record, and/or otherwise access promoted content 1142 via UI element 1144. In some examples, promoted content 1142 can relate to the theme of UI 1100 (e.g., the winter Olympics theme) and/or content item 1134D. For example, promoted content 1142 can include winter Olympics content selected for promotion via UI 1130. Promoted content 1142 can additionally or alternatively include any other content, such as sponsored content, highlighted content (e.g., by a platform associated with UI 1130), suggested content, or any other content.

UI 1130 can optionally include toolbar 1146 with menus, menu items, controls, settings, and/or any other toolbar item. UI 1130 can also include navigation element 1150, which the user(s) 140 can select to return to UI 1100, return to or continue with an immersive experience in UI 1100, access a same or related immersive experience, etc. UI 1130 can optionally depict an indication 1152 of the immersive experience accessible via navigation element 1150. The indication 1152 can describe/identify the immersive experience accessible via navigation element 1150. In some cases, the indication 1152 can optionally visually illustrate a content associated with the immersive experience accessible via navigation element 1150, such as a logo, a thumbnail, a trailer, an icon, an image, artwork, an animation, a preview, and/or any other illustration. For example, in FIG. 11B, the indication 1152 depicts character 1114 from the winter Olympics game 1102 in UI 1100. character 1114 is depicted with skis as if character 1114 is in the air during a ski jump as depicted in the winter Olympics game 1102.

FIGS. 12A and 12B illustrate example immersive experiences provided by UI 1202. The immersive experiences provided by UI 1202 can include, involve, and/or allow more participation, interaction, engagement, and/or activity from the user(s) 140 than the immersive experiences provided by UI 1000 in FIG. 10A and UI 1100 in FIG. 11A. In some examples, the immersive experience provided by UI 1202 can include an exploratory experience where the user(s) 140 can explore content, activities/experiences, spaces (e.g., sections, pages, UI containers, etc.) and/or interactive features via UI 1202.

FIG. 12A illustrates an example view 1200 of UI 1202. In this example, view 1200 includes UI spaces 1204, 1212, and 1218 that the user(s) 140 can explore and engage with as part of a respective immersive experience. In this example, UI space 1302 depicts a building 1206. The building 1206 represents a shop, such as a gift shop, a sponsored shop, an interactive shop, an online shop, or any other shop. The building 1206 includes a UI element 1208 that the user(s) 140 can select or activate to initiate, engage in, and/or explore a respective immersive experience. The immersive experience associated with the UI element 1208 in this example includes a sweepstakes experience. In some cases, if the user(s) 140 participates and wins in the sweepstakes experience, the user(s) 140 can obtain a recognition, an offer, a feature, or a reward for winning the sweepstakes. The reward can include any type of benefit such as, for example, a credit to a product or service, an add-on, a free or discounted UI content or access, a free or discounted service, free or discounted content, a token with a value that can be redeemed with one or more entities (e.g., a media platform(s), a sponsor, a store, etc.), a monetary benefit, or any other benefit.

When the immersive experience is accessed/triggered via the UI element 1208, UI 1202 can display an animation 1210A. The animation 1210A can display, reveal, carry, hold, and/or include an object 1210B that includes information about the performance of the user(s) 140 in the sweepstakes, such as whether the user(s) 140 has won and, if so, what if anything has the user(s) 140 won through the sweepstakes. In this example, the object 1210B includes a gift box. The animation 1210A can reveal or display the gift box depicted by the object 1210B and open the gift box (or allow user(s) 140 to open the gift box via an input such as a request or a selection of the gift box) to reveal whether user(s) 140 won the sweepstakes (and, optionally, what user(s) 140 won if anything). In some examples, the gift box depicted by the object 1210B can contain, reveal, and/or represent a sweepstakes outcome. For example, the gift box depicted by the object 1210B can open as part of the animation 1210A to reveal whether user(s) 140 won the sweepstakes. If user(s) 140 won, the gift box can reveal an indication that user(s) 140 won and, optionally, visually depict or identify what user(s) 140 won. To illustrate, if user(s) 140 won a discount code, the gift box can open during the animation 1210A to reveal the discount code. If user(s) 140 won a movie sold by a media store/platform, the gift box can open and reveal the movie or a visual representation of the movie, such as a thumbnail cover of the movie.

The animation 1210A in this example depicts a pair of hands that extends (e.g., appears to extend) from building 1206. The pair of hands can be shown holding object 1210B depicting the gift box. As part of the animation 1210A, the pair of hands can appear with the object 1210B to reveal the gift box depicted by the object 1210B. The gift box can open to reveal a sweepstakes outcome while the pair of hands holds the gift box. UI 1202 can depict the gift box opening and the content of the gift box being revealed when and/or as the gift box opens. For example, the animation 1210A can show the pair of hands opening the gift box and a content of the gift box being revealed as the gift box opens (or when the gift box opens). In another example, the animation 1210A can show the gift box opening on its own (or by something else). In other cases, the animation can include a character, person, object, and/or creature (in addition to or instead of the pair of hands) used to display, reveal, hold, and/or interact with the object 1210B depicting the gift box. In other cases, the object 1210B can be animated such that the object 1210B appears to move within view 1200 of UI 1202 and towards a particular location, such as the location above the building 1206.

In some cases, the animation can include an audio output such as, for example, a sound representing a movement or animation of the pair of hands, an announcement of the sweepstakes outcome, a sound representing opening of the gift box depicted by the object 1210B, specific music (e.g., music selected for the sweepstakes, music selected for the user(s) 140 and/or a profile of the user(s) 140 such as a suggested/recommended song, a song from a music collection/album of the user(s) 140, a song selected based on a preference(s) and/or music history (e.g., play history, purchase history, etc.) or statistics of the user(s) 140, etc.), audio indicating or representing suspense while the gift box opens (e.g., a drumroll, etc.), celebratory audio (e.g., clapping, cheering, sirens, etc.), or any other audio.

UI space 1212 depicts a theater 1214 that the user(s) 140 can use to access a movie trailers experience. The user(s) 140 can select or activate a UI element 1216 in the theater 1214 to enter the theater 1214 and/or trigger or participate in an immersive experience associated with the theater 1214 (e.g., the trailers experience). For example, the user(s) 140 can select or activate the UI element 1216 to access, play, download, or stream a trailer(s) (e.g., one or more trailers of one or more movies, TV shows, videos, etc.), browse trailers in the theater 1214, interact with the theater 1214 (or a portion thereof such as a theater room(s), a theater screen(s), etc.) and/or trailers in the theater 1214, enter the theater 1214 to explore the theater 1214 and/or watch or browse any trailers in the theater 1214, interact with a trailer(s), etc. In this example, the immersive experience associated with the theater 1214 can relate to trailers. In other examples, the immersive experience can additionally or alternatively relate to other content such as movies, TV shows, videos, advertisements, video games, content replays, etc.

UI space 1218 includes a structure 1220 depicting a trivia question 1222. The structure 1220 can include, for example, a building, a billboard, a board, a screen, or any other structure. In some cases, the structure 1220 can be based on the trivia question 1222. For example, if the trivia question 1222 includes a question about a scene in a movie that depicts a particular building, such as a campus building (e.g., a building of a hospital or university campus, etc.) or store, the structure 1220 can include that building or store. In other cases, the structure 1220 can be unrelated to the trivia question 1222.

The trivia question 1222 can provide an immersive experience to the user(s) 140. For example, the user(s) 140 can submit an answer to the trivia question 1222, which can optionally trigger any changes in UI 1202 or a different UI or UI view. In some cases, UI 1202 can be updated to depict content based on the answer to the trivia question 1222. For example, if the answer to the trivia question 1222 is correct, UI 1202 can depict content indicating that the answer is correct (e.g., a message or notification, etc.), a visual celebration of the correct answer (e.g., by showing celebration content and/or activity such as fireworks, balloons, confetti, a character performing a celebration, a congratulatory message, etc.), an invitation to answer another trivia question, content associated with the answer and/or trivia question 1222, a channel or UI that contains content associated with the answer, a UI space or destination that the user(s) 140 can explore to access or view content associated with the answer and/or trivia question 1222, etc. If the answer is not correct, UI 1202 can depict other content, animations, and/or behaviors, such as an indication that the answer is incorrect and/or an invitation to submit another answer.

In FIG. 12A, the trivia question 1222 includes a question describing a movie and asking the user(s) 140 to identify the movie. If the user(s) 140 identifies the correct movie in the trivia answer, UI 1202 can depict the movie (or a representation of the movie such as a cover of the movie), transition to a UI space or destination (or another UI) that includes certain content (e.g., the movie, movies related to the movie, movies recommended based on the movie, etc.) and/or that the user(s) 140 can explore to access or purchase the movie and/or related content, a page where the user(s) 140 can access the movie for free (or for a period of time) and/or at a discount.

In some cases, based on or in response to the answer to the trivia question 1222, UI 1202 can depict any additional trivia questions that the user(s) 140 can answer as part of the immersive experience. In some examples, the user(s) 140 can win a reward(s) for correctly answering one or more trivia questions (or a reward for each answer or set of answers that are correct). In other examples, UI 1202 can update to display content as the user(s) 140 answers trivia questions or can navigate through a content experience as the user(s) 140 answers trivia questions.

In some examples, UI 1202 can include a UI element 1224 that indicates which immersive experience is the current or active immersive experience being depicted or in focus, which immersive experience the user(s) 140 has selected or can select in a current navigation state, or any other information that can help guide the user(s) 140 to specific immersive experiences and/or navigation states. For example, the UI element 1224 can include circles representing respective immersive experiences. In this example, the first circle from the left (e.g., from the perspective of the user(s) 140 viewing UI 1202) can represent a first immersive experience from the left (e.g., the immersive experience associated with UI space 1204), the next circle can represent a next immersive experience that is adjacent to the first immersive experience (e.g., the immersive experience associate with UI space 1212), and the next circle can represent the next immersive experience to the right (e.g., the immersive experience associated with structure 1218). If UI 1202 includes other UI spaces for accessing immersive experiences, the UI element 1224 can include other circles representing such immersive experiences and located relative to other circles in the UI element 1224 based on the location of such immersive experiences relative to the location of the immersive experiences associated with the other circles in the UI element 1224.

In some cases, if UI 1202 includes other immersive experiences displayed or accessible within another view of UI 1202 presented when/if user(s) 140 navigates to a location/destination that is outside of the current view 1200 of UI 1202, the UI element 1224 can include circles representing such immersive experiences. For example, if user(s) 140 uses navigation element 1232 to navigate to the right of UI space 1218 (e.g., in a right direction from a perspective of user(s) 140 viewing UI 1202), UI 1202 can update to view 1240 shown in FIG. 12B, and if user(s) 140 uses navigation element 1230 to navigate to the left of UI space 1204, UI 1202 can update to another view depicting content and spaces located to the left of UI space 1204 (if any). User(s) 140 can also use navigation element 1230 and navigation element 1232 to navigate towards a left or right direction (e.g., relative to a current location or space selected, in focus, highlighted, activated, etc.), respectively, in order to navigate to or access immersive experiences within the current view 1200 and optionally explore or place into focus such immersive experiences. Accordingly, the navigation elements 1230 and 1232 can allow user(s) 140 to navigate and explore immersive experiences within UI 1202, including immersive experiences within the current view 1200 and, optionally, immersive experiences within another view (e.g., view 1240).

The UI element 1224 can include a circle representing a current UI space and/or associated immersive experience; a UI space and/or immersive experience that is currently active, selected, in focus, or in a position to be selected/activated/explored; and/or a UI space and/or associated immersive experience at a location that matches a current navigation state/location. Such circle can be depicted with one or more attributes that differ from the attributes of other circles in the UI element 1224. For example, the circle can be filled with color while the other circles can be hollow/blank (or vice versa) to indicate that the UI space and/or immersive experience associated with that circle is in focus, active, selected, and/or a current UI space and/or immersive experience.

The UI element 1224 can optionally include an indication 1226 of the immersive experience that is active, selected, in focus, and/or accessible from a current navigation state. For example, in FIG. 12A, the indication 1226 identifies the trailers experience associated with UI space 1212 as the immersive experience that is in focus, active, selected, playing, current, and/or accessible from a current navigation state/location. If user(s) 140 navigates to the immersive experience associated with UI space 1218 located to the right (from the perspective of user(s) 140) of UI space 1212 and the trailers experience, the UI element 1224 can update to depict the circle representing UI space 1218 and the associated immersive experience as active, selected, current, in focus, and/or accessible from a current navigation state/location, and update the indication 1226 to identify the immersive experience associated with UI space 1218 as active, selected, current, in focus, and/or accessible from a current navigation state/location. Accordingly, user(s) 140 can use the UI element 1224 (e.g., the circles depicted by the UI element 1224) and the indication 1226 as a guide when navigating UI 1202 and determine which immersive experience is active, in focus, selected, current, and/or selectable/accessible from a current navigation state/location.

In some cases, UI 1202 can depict additional visual elements 1228, which can be part of or separate from any of the immersive experiences. The visual elements 1228 can include static and/or dynamic/animated UI elements. Moreover, the visual elements 1228 can include any visual UI elements such as, for example and without limitation, imagery, interface elements, artwork, a background or backdrop, animations, thumbnails, text, visual objects, thematic elements, decorative content, references to content such as movies or TV shows, hidden clues or messages, advertisements, UI containers, tiles, content items, and/or any other UI elements.

In some examples, in addition to or instead of using specific UI elements (e.g., UI element 1208, UI element 1216, UI element 1222, etc.) to access respective immersive experiences associated with UI spaces 1204, 1212, and 1218, user(s) 140 may access the respective immersive experiences by selecting any portion of the respective content depicted in UI spaces 1204, 1212, and 1218. For example, in addition to or instead of using the UI element 1208 to access the immersive experience associated with UI space 1204, user(s) 140 may select any portion of the building 1206 and/or any other portion of UI space 1204 to access the immersive experience associated with UI space 1204. In some cases, user(s) 140 can access an immersive experience associated with a UI space by selected any portion of the content in the UI space if the UI space is in focus and/or active. For example, user(s) 140 can access an immersive experience by selected any portion of the content in the associated UI space when the navigation location or state of the user(s) 140 matches the location of the UI space (e.g., when the UI space is in focus/current/active).

To illustrate, in FIG. 12A, the UI element 1224 and indication 1226 indicate that the immersive experience that is current, active, and/or in focus given the current navigation location/state of user(s) 140 is the trailers experience associated with UI space 1212. Since the trailers experience associated with UI space 1212 is current, active, and/or in focus, user(s) 140 can select a content of UI space 1212 (e.g., any portion or specific portions of the building 1214) to access the trailers experience. If user(s) 140 subsequently uses the navigation element 1230 to navigate to the left (from the perspective of user(s) 140) such that the sweepstakes experience associated with UI space 1204 becomes the current, active, or in focus experience, user(s) 140 can select UI space 1204 (e.g., the shop 1206) to access the sweepstakes experience.

In some cases, when an immersive experience is current, active, or in focus, user(s) 140 can select any portion of UI 1202 to access such immersive experience. For example, when the trailers experience is current, active, or in focus, user(s) 140 can select any portion of the scene depicted in UI 1202 (e.g., in addition to any portion of UI space 1212 associated with the trailers experience) to access the trailers experience. Moreover, user(s) 140 can select or activate the navigation elements 1230 and 1232 to navigate about the immersive experiences provided by UI 1202 and the scene depicted by UI 1202, including other views of UI 1202.

FIG. 12B illustrates another view 1240 of UI 1202. The user(s) 140 can navigate from view 1200 to view 1240 using the navigation element 1230 or 1232. The user(s) 140 can navigate from view 1240 back to view 1200 or another view using navigation elements 1230 or 1232 in view 1240. In some cases, the user(s) 140 can additionally or alternatively use the navigation elements 1230 and 1232 depicted in view 1240 to navigate to different immersive experiences within view 1240.

View 1240 can include UI spaces 1242, 1246, 1250, and 1258. Each of the UI spaces can depict, can provide, and/or can be used to access a respective immersive experience, as further described below. For example, each UI space (and/or an element(s) within that UI space) can be selected or activated to initiate, trigger, enter, play, and/or execute a respective immersive experience, or explore areas/destinations within the UI space from which the user(s) 140 can access, view, play, initiate, trigger, and/or execute a respective immersive experience(s).

In this example, UI space 1242 depicts a coffee shop 1244. The user(s) 140 can select, activate, or enter the coffee shop 1244 to access an immersive experience associated with the coffee shop 1244. The immersive experience can include, for example, an offer from a coffee brand or sponsor, a trivia game related to coffee or a coffee brand, a video related to coffee (e.g., a coffee-making video, a coffee documentary, a movie with a coffee theme or topic/scene, etc.), a video related to a coffee brand, a coffee shop scene, a coffee advertisement, a UI element that the user(s) 140 can use to purchase coffee, an animation showing making or pouring of coffee, or any other immersive experience.

UI space 1246 depicts a taxi 1248. The taxi 1248 can be animated and thus move within UI 1202 or can be static (e.g., parked). The user(s) 140 can select the taxi 1248 to access, trigger, initiate, and/or play an immersive experience. The immersive experience can relate to a taxi or can involve the taxi 1248. For example, the immersive experience can include an animated journey through a town or any other environment depicted from the perspective of a passenger of the taxi 1248, which can appear to change as the taxi 1248 appears to move to explore different scenes/locations. As another example, the immersive experience can include a video with a taxi theme or topic, such as a taxi movie or a movie where a character owns, drives, and/or has a taxi or is a taxi driver, a documentary about taxis, a video game involving a taxi(s), etc. In another example, the immersive experience can include a trivia game about taxis or a particular taxi movie/show, an animated challenge involving the taxi 1248, or any other immersive experience related to and/or accessible from the taxi 1248.

UI space 1250 depicts a building 1252 with a sign 1254 that displays a portion of a fact (e.g., a fun fact) used as part of an immersive experience called a “fun fact” experience in FIG. 12B. The sign 1254 includes a UI element 1256 that the user(s) 140 can activate to reveal the portion of the fact that is not shown in the sign 1254. For example, the portion of the fact displayed by the sign 1254 can include a portion of the fact that describes the question or factual detail that is answered or described by the remaining portion of the fact revealed when the UI element 1256 is selected or activated. When the UI element 1256 is activated or selected, UI 1202 can update to reveal the remaining portion of the fact that answers or describes the factual details corresponding to the information displayed in the sign 1254. To illustrate, in FIG. 12B, the sign 1254 display the text “Today in Hollywood history”, which indicates that the fact is about something that happened on this day (today) in Hollywood history. When the user(s) 140 selects or activates the UI element 1256, UI 1202 can display the remaining portion of the fun fact which, in this example, indicates what happened on this day (today) in Hollywood history.

In some cases, when revealing the fun fact upon activation or selection of the UI element 1256, UI 1202 can display an image, video, text, animation, and/or any other visual content. For example, UI 1202 can display text describing what happened in Hollywood history on this day. UI 1202 can additionally or alternatively display an image and/or animation conveying information about what happened in Hollywood history on this day and/or content related to the fun fact. To illustrate, if the fun fact is that a famous movie was released on this day (today) in Hollywood history, when the UI element 1256 is activated or selected, UI 1202 can display imagery and/or animated content from that movie in order to tie the fun fact experience to the movie. In some cases, when the UI element 1256 is activated or selected, UI 1202 can provide access to the movie, display an offer to purchase the movie, provide access to the movie (e.g., display a link, tile, UI container, page, address, or selectable object that the user(s) 140 can use to access the movie), display additional fun facts, etc.

UI space 1258 depicts a building 1260 that user(s) 140 can select to access an immersive experience or enter the building 1260 to access an immersive experience. The immersive experience can include any content such as text (e.g., facts, trivia, questions, etc.), image content, video content, video game content, animated content, etc. For example, the user(s) 140 may select the building 1260 to enter the building and engage in an immersive experience where the user explores an interior of the building 1260 to search for clues as part of a game such as a scavenger hunt, enter rooms in the building 1260 to access respective immersive experiences such as games/activities, navigate to a portion of the building 1260 to access an immersive experience, etc.

View 1240 displays a UI element 1262 that guides the user(s) 140 as the user(s) 140 navigates/explores immersive experiences provided by UI 1202. The UI element 1262 can identify a current immersive experience that is in focus, activated, or that the user(s) 140 can access from a current navigation location/state. In this example, the UI element 1262 indicates that the fun fact experience associated with UI space 1250 is in focus, activate, or accessible from a current navigation location/state. The UI element 1262 can include an indication 1264 of the current immersive experience. For example, the indication 1264 can identify and/or describe the current immersive experience. In FIG. 12B, the indication 1264 identifies the “Fun Fact” experience associated with UI space 1250 as the current/active/in-focus experience.

User(s) 140 can use navigation elements 1230 and 1232 to navigate areas within UI 1202, views of UI 1202, etc. In some cases, UI 1202 can display a city or scene with immersive experiences and content that user(s) 140 can explore. User(s) 140 can use navigation elements 1230 and 1232 to move about the city or scene, views of the city or scene (e.g., view 1200, view 1240), etc., and engage in immersive experiences.

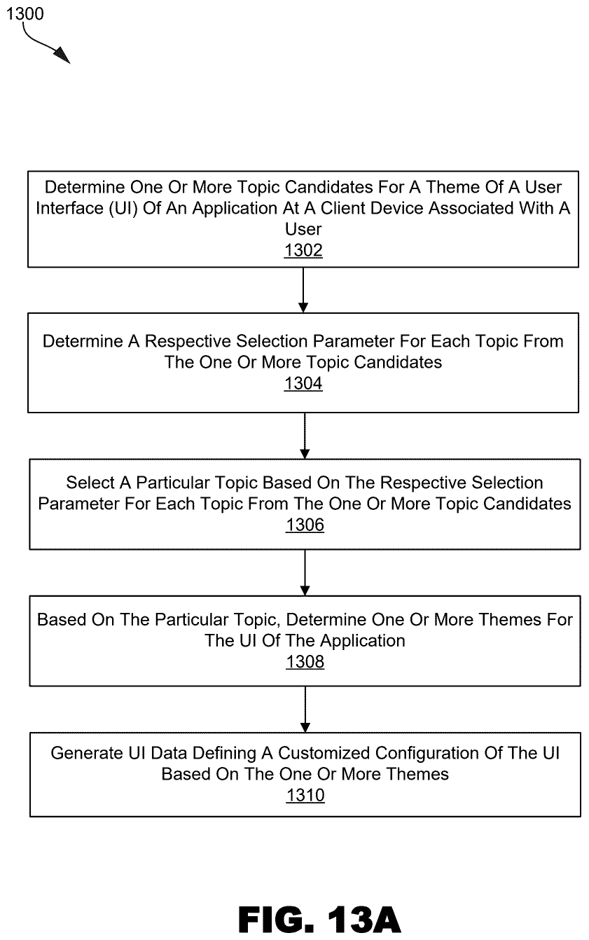

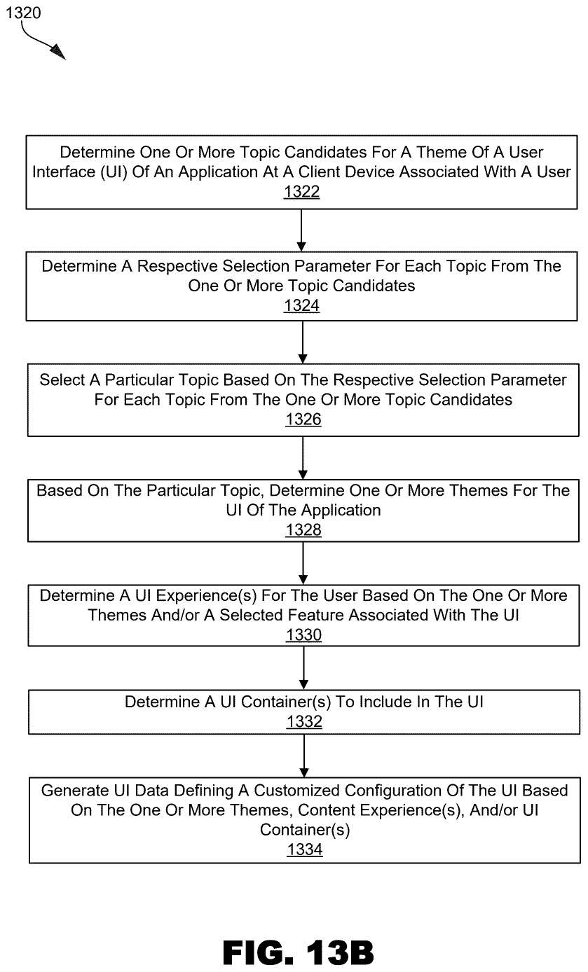

FIG. 13A is a flowchart illustrating an example method 1300 for customizing a UI based on one or more themes. Method 1300 can be performed by processing logic that can include hardware (e.g., circuitry, dedicated logic, programmable logic, microcode, etc.) and/or software (e.g., instructions executing on a processing device). It is to be appreciated that not all steps may be needed to perform method 1300. Some of the steps may be performed simultaneously, or in a different order than shown in FIG. 13A, as will be understood by a person of ordinary skill in the art. Method 1300 shall be described with reference to FIGS. 1 and 2. However, method 1300 is not limited to those examples.

At step 1302, UI management system 130 or media device(s) 104 can determine one or more topic candidates for a theme of a UI of an application at media device(s) 104 associated with user(s) 140. The application can include a media application, TV application, streaming application, media player application, entertainment system application, content platform application, streaming platform application, etc. In some cases, UI management system 130 or media device(s) 104 can determine the one or more topic candidates based on one or more signals.

At step 1304, UI management system 130 or media device(s) 104 can determine a respective selection parameter for each topic from the one or more topic candidates. Each topic can have a respective selection parameter (or multiple selection parameters). The respective selection parameter can include, for example, a topic preference score, topic priority, topic metric, and/or topic relevance. The topic relevance can include a relevance of the topic with respect to a date when the UI is displayed (e.g., a current date), user(s) 140, the application, content associated with the application, an event, a trend, a context, and/or any other cue (e.g., any other signal).

At step 1306, UI management system 130 or media device(s) 104 can select a particular topic from the one or more topic candidates based on the respective selection parameter for each topic from the one or more topic candidates. UI management system 130 or media device(s) 104 can compare the respective selection parameter of each topic candidate with the respective selection parameter of each of the remaining topic candidates to identify the topic candidate that has the highest selection parameter. UI management system 130 or media device(s) 104 can select the topic candidate with the highest selection parameter.

In some cases, UI management system 130 or media device(s) 104 can select the particular topic based on a relevance of the particular topic as compared to the relevance of each of the remaining topic candidates. For example, UI management system 130 or media device(s) 104 can select the topic that has a highest relevance score and/or highest amount of relevant features (e.g., features related to the date, user(s) 140, the application, a content of the application, an event, etc.), a topic that has a threshold relevance and/or is associated with another selection parameter (e.g., a particular topic preference score or a user preference, topic priority, topic metric, etc.), a topic that has a specific type of relevance (e.g., a type of relationship to the date, user(s) 140, the application, a content of the application, a content item, an event, etc.), etc.

In some cases, UI management system 130 or media device(s) 104 can select the particular topic based on a comparison between the respective selection parameter of each of the one or more topic candidates. For example, the particular topic can include the topic determined to have the highest relevance (or relevance score), the best match for the date and/or a user preference, the highest number of relevant characteristics, a highest relevance ranking, a threshold relevance, a threshold relevance as well as one or more additional selection criteria or factors relative to other topics (e.g., a user preference, a rating or ranking, an additional relevance, a cultural significance relative to other topics, a celebration statistic, a relevance history, etc.).

In some cases, the topic relevance can include a relevance score, a match or matching score, a similarity value, a relationship or relationship metric, a comparison metric, a relevance value, etc. For example, to determine the topic relevance of each topic, UI management system 130 or media device(s) 104 can compare the topic with the date, user preferences, user activity, a content item, the application, an event, a context, etc., to determine whether the topic is related to the date, is of more significance on the date (or a period that includes the date) than other dates, is related to an item being released/presented or promoted, matches or has a similarity/relevance to an event or topic associated with the date, etc.

At step 1308, UI management system 130 or media device(s) 104 can determine, based on the particular topic, one or more themes for the UI. The particular topic can define the one or more themes and/or any aspect of the one or more themes. At step 1310, UI management system 130 or media device(s) 104 can generate UI data defining a customized configuration of the UI based on the one or more themes.

The UI data can define a configuration that customizes the UI based on the one or more themes. In some examples, the customized configuration of the UI can include a user experience (UX) design that incorporates or is at least partly based on the one or more themes. The UX design can define a UI design customized based on the one or more themes, a configuration of the one or more themes, a user experience, a UI behavior, a UI background, a UI organization, an interaction design, an organization/arrangement, UI parameters, and/or any other UI attributes. In some cases, the UI design can include a visual design of the UI customized based on the one or more themes.

The visual design can include a UI layout, style, background, artwork, imagery, animation, graphics, UI element definitions, UI containers, and/or any other UI attributes. The UI style can define visual attributes of the UI, such as a color and/or color scheme, a typography, objects, a style, a visual property, and/or any other visual attributes. The UI design can include the one or more UI elements and one or more UI containers. The one or more UI elements can include navigation elements (e.g., navigation bar, navigation drawer, navigation rail, bottom app bar, search element, tab, top app bar, scrolling element, next or back button, etc.), action/CTA elements (e.g., a button, selectable icon, selectable tile or card, link, input element, selectable content, etc.), input elements, text elements, interactive elements, control elements, menus, dividers, dialogue elements, silhouettes, tiles, cards, communication elements, and/or any other UI element. The one or more UI containers can include UI banners, sections, spaces, frames, sheets, carousels, dialogs, dividers, toolbars, etc.

The one or more definitions can include a definition of each UI element, which can specify or define a UI element type, position, size, appearance, shape, background, behavior, data/content, hierarchy, and/or any other UI element characteristic. The UI element appearance can include a color(s) and/or color scheme(s), font, border setting, style, image, link, background, pattern, label, text, visual attribute, and/or any other characteristic. In some cases, the customized configuration of the UI can include a UI design customized based on the one or more themes. The UI design can include a layout, UI element definitions, UI content (e.g., displayed and/or available content items, content selected for the one or more themes, etc.), a visual design of the UI customized based on and/or incorporating the one or more themes, a navigation design, a UI template, a UI container(s), one or more UI parameters customized based on the one or more themes, and/or any other characteristics. The one or more UI parameters can define one or more UI properties, content spaces, UI behaviors, etc. The visual design of the UI can include visual attributes customized based on the one or more themes and/or styling information based on the one or more themes. The styling information can include/specify a color(s) and/or color scheme, a background, a typography, artwork, graphics, imagery, fonts, styles, border settings, iconography of any UI elements, labels, spacing, content structures, formatting, visual patterns, etc. The UI elements can include, for example, a UI tile, a UI card, a silhouette, a menu, a form element, a button, a navigation element, a search element, a selection element, a control element, a display element, an input element, and/or the like.

In some cases, UI management system 130 or media device(s) 104 can determine that a date corresponds to a scheduled event (e.g., content release date or promotion, holiday, game, competition, announcement, news event, etc.) and determine (based on the determination that the date corresponds to the scheduled event) that the particular topic associated with the scheduled event has a highest selection parameter from the respective selection parameter of each topic. The highest selection parameter can include a highest topic preference score, priority, metric, and/or relevance. UI management system 130 or media device(s) 104 can select the particular topic associated with the scheduled event based on the highest selection parameter and determine the one or more themes based on the particular topic. The one or more themes can be customized based on the particular topic associated with the scheduled event.

In some examples, the topic preference score can be based on a preference of a user (e.g., user(s) 140) or group, an application/platform, an entity or sponsor, a business, and/or any other preference. The topic priority can be based on a topic trend score, popularity, promotion, reference count (e.g., a count of references to the topic in one or more sources and/or social media networks such as how many times the topic was referenced in one or more sources and/or social media networks), interest score, and/or any other criteria. The topic metric can include a topic request count, statistic, weight (e.g., defined by an application, user(s) 140, an entity or sponsor, etc.), performance value, etc. The topic relevance can be based on a relationship between the topic and the date when the UI is displayed, a user context, a trend with a trend score (e.g., a trend on social media, a community, popular culture, a region, etc., that has a threshold trend score, trend count, popularity score, etc.), a user/device location, a UI content, an event, etc.

In some aspects, UI management system 130 or media device(s) 104 can select, based on user data, a topic personalized to user(s) 140 and/or features of the one or more themes personalized to user(s) 140. UI management system 130 or media device(s) 104 can determine the one or more themes further based on the personalized topic and/or features, and determine the customized configuration of the UI based on the one or more themes and the personalized topic and/or features. In some cases, UI management system 130 or media device(s) 104 can determine that a date corresponds to a holiday (e.g., a formal or informal/commemorative holiday), determine a respective relevance of a holiday topic associated with the holiday based on the determination that the date corresponds to the holiday, select the holiday topic from the one or more topic candidates based on the respective relevance of the holiday topic, and determine the one or more themes based on the holiday topic. In some cases, UI management system 130 or media device(s) 104 can determine that the date matches a content release date and determine a respective relevance of a content topic associated with the content associated with the content release data based on the determination that the date matches the content release date. UI management system 130 or media device(s) 104 can select the content topic based on the respective relevance of the content topic and determine the one or more themes based on the content topic.

In some cases, UI management system 130 or media device(s) 104 can determine that the date matches a scheduled date of an event, and determine a respective relevance of an event topic associated with the event based on the determination that the date matches the scheduled date of the event. UI management system 130 or media device(s) 104 can select the event topic from the one or more topic candidates based on the respective relevance of the event topic and determine the one or more themes based on the event topic.

UI management system 130 or media device(s) 104 can additionally or alternatively determine a preferred topic of user(s) 140, which can include a preferred activity, content, team, a media character, genre of content, event, celebration, geographic location, etc. UI management system 130 or media device(s) 104 can determine a respective relevance of the preferred topic and select the preferred topic from the one or more topic candidates based on the respective relevance of the preferred topic. In this example, the one or more themes can based on the preferred topic.

FIG. 13B is a flowchart illustrating another example method 1320 for customizing user interfaces. Method 1320 can be performed by processing logic that can include hardware (e.g., circuitry, dedicated logic, programmable logic, microcode, etc.), software (e.g., instructions executing on a processing device), or a combination thereof. It is to be appreciated that not all steps may be needed to perform method 1320. Some of the steps may be performed simultaneously, or in a different order than shown in FIG. 13B, as will be understood by a person of ordinary skill in the art. Method 1300 shall be described with reference to FIGS. 1 and 2. However, method 1320 is not limited to those examples.

At step 1322, UI management system 130 (e.g., running at system server(s) 126 and/or media device(s) 104) can determine one or more topic candidates for a theme of a UI of an application at media device(s) 104. At step 1324, UI management system 130 can determine a respective selection parameter for each topic from the one or more topic candidates.

Each topic can have a respective selection parameter(s). The respective selection parameter(s) can include a topic preference score, priority, metric, and/or relevance. The topic relevance can include a relevance of the topic with respect to a date, user(s) 140, the application, application content, an event, a trend, a context, or any other cue/signal. The topic preference score can be based on a preference of user(s) 140, a group, an application/platform, an entity or sponsor, a business, etc. The topic priority can be based on a topic trend score, topic popularity, topic promotion associated with the sponsor, count of references to the topic in one or more sources and/or social media networks, topic interest score, and/or any other priority score. The topic metric can include a topic request count, topic statistic, topic weight (e.g., topic weight specified by the application, the entity associated with the application, a user, etc.), topic performance value, etc. In some examples, the topic relevance can be based on a relationship between the topic and a date when the UI is displayed, a context associated with user(s) 140, a trend associated with a trend score, a location associated with user(s) 140, a content of the UI, an event, etc.

At step 1326, UI management system 130 can select a particular topic from the one or more topic candidates based on the respective selection parameter of each topic. UI management system 130 can compare the respective selection parameter of each topic candidate to identify the topic candidate with the highest selection parameter, and select that topic candidate.

At step 1328, UI management system 130 can determine, based on the particular topic, one or more themes for the UI. For example, UI management system 130 can determine a theme(s) that is based on or relates to the particular topic and select that theme(s) for the UI. The particular topic can define the one or more themes and/or any aspect of the one or more themes.

At step 1330, UI management system 130 can determine a UI experience(s) based on the one or more themes and/or a feature associated with the UI. The feature can include content to be highlighted or promoted by the UI, a menu, a toolbar, a control, a setting, a functionality, and/or any other aspects of the UI. The UI experience(s) can include an animation(s), CTA(s), game(s), user/content interaction(s) (and/or type of interaction), activity, UI behavior(s) and/or action(s), output(s), challenge(s), content reference(s) (e.g., hidden message), and/or any other interaction. For example, to promote a feature of the UI, UI management system 130 can configure the UI to provide an animation, have an appearance that promotes the feature (e.g., adjusting a size, placement, and/or visual attribute of the feature), provide a game or activity that draws the user's attention to the feature, etc.

To illustrate, UI management system 130 can configure the UI to display content references representing hidden messages (e.g., Easter eggs) for a game and invite user(s) 140 to take part in the game. UI management system 130 can display a content reference(s) on or around the feature or hide the content reference(s) within/behind the feature to draw the attention of user(s) 140 to the feature via the game and content reference(s). If UI management system 130 determines to use an animation to promote the feature, UI management system 130 can determine what animation and/or type of animation to use to promote the feature and/or how to configure such animation. For example, UI management system 130 can determine to configure the feature to be animated to draw the user's attention to the feature. As another example, to draw the user's attention to the feature in order to promote it, UI management system 130 can determine to configure an object to interact with the feature or move the feature to a UI location where the feature is then displayed, or animate other content to draw the user's attention to the feature.

As another example, to promote the feature, UI management system 130 can select to configure the UI to invite, encourage, draw, or enable user(s) 140 to explore the feature in the UI in exchange of a benefit to user(s) 140 that incentivizes user(s) 140 to use or explore the feature as a way to promote the feature. The benefit can include, for example, unlocking a clue for a challenge, such as a game or a puzzle, unlocking a content add-on, receiving a credit, receiving a discount or free/discounted content, receiving a subscription or a subscription a credit or discount, receiving access to paid content, being promoted within UIs displayed on devices of other users (e.g., having a user avatar of user(s) 140 displayed on UIs presented to other users, being recognized in the UIs presented to other users, etc.), unlocking a feature/functionality, etc.

To illustrate, if the feature includes an advertisement, UI management system 130 can select to configure the UI to invite user(s) 140 to watch the advertisement in exchange for a benefit, such as unlocking a clue for a puzzle or receiving an add-on. If the feature includes a control setting used to implement or adjust a functionality, to promote the control setting, UI management system 130 can select to configure an animated UI element, such as an object or content item, that interacts with a portion of the UI used to access the control setting (or that displays a control element used to adjust/manage the control setting) or that interacts with each UI element that user(s) 140 would need to access to get to the control setting. For example, assume that, to reach the control element associated with the control setting, user(s) 140 would need to navigate to a menu, within the menu navigate to a first submenu, within the first submenu navigate to a second submenu, and the control element can be found within the second submenu.

In this example, UI management system 130 can select to configure the UI to display an animation that draws the attention of user(s) 140 to the menu to encourage user(s) 140 to navigate to the menu (e.g., an animation that interacts with the menu, an animation that places or drops a visual element on or about the menu, an animation that animates the menu, etc.). Once user(s) 140 navigates to the menu, the UI can display another animation that steers user(s) 140 towards the first submenu. Once user(s) 140 navigates to the first submenu, the UI can display another animation that steers user(s) 140 to the second submenu. Finally, once user(s) 140 navigates to the second submenu, the UI can display an animation that draws the attention of user(s) 140 to the control element.

In some cases, the UI experience(s) can include an immersive experience involving content, UI functionalities, activities, or games. For example, the UI experience(s) can include a puzzle with clues hidden in the UI that can help user(s) 140 solve the puzzle. The clues can be placed in the UI such that as user(s) 140 navigates the UI and performs an action, the UI unlocks a corresponding clue to appear in the UI. The UI experience(s) can include a game or journey where user(s) 140 uncovers clues at locations.

If the one or more themes of the UI and/or a content of the UI is/are associated with food, the UI experience(s) can include a question asking user(s) 140 to identify a favorite celebrity chef, and use an answer to update the one or more themes and/or UI content. For example, the UI can be updated to include content associated with the favorite celebrity chef or add a UI container with content or tiles associated with the favorite celebrity chef. The answer can be used to update an avatar. For example, if the favorite celebrity chef is known for wearing a chef hat, the avatar can show user(s) 140 with the chef hat.

The UI experience(s) can optionally include interactions. For example, the UI experience(s) can include an option to select a team. The UI can receive a user input identifying a team and generate content, an experience, or information based on the team. To illustrate, the UI can display a comparison of the team with teams picked by other users to show how the team of user(s) 140 compares to the teams of other users. In some cases, the UI experience(s) can allow user(s) 140 to pick or suggest UI themes, theme changes, content, content references, Easter eggs and/or Easter egg placements/locations, etc. The Easter eggs can be placed or hidden anywhere in the UI. For example, an Easter egg can be hidden in a control setting, such as a closed caption or video setting, to encourage users to explore/discover such setting.

The UI experience(s) can provide a scavenger hunt challenge where Easter eggs are placed throughout the UI and/or a UI background. Users can try to find the Easter eggs to win the challenge. The challenge can help users become familiar with the UI, discover UI features/functionalities, explore UI locations, become more proficient with the UI, etc. Users can win awards or other benefits for a performance in the challenge. In some cases, a behavior of an Easter egg can change dynamically based on a condition(s). For example, assume that a weather balloon from a movie is used as an Easter egg hidden within a background of the UI. As the number of users who find the weather balloon (Easter egg) increases, the weather balloon can grow or move. The weather balloon can eventually burst or disappear when a threshold number of users find it, to provide a timeliness constraint and encourage users to find it faster.

In some cases, the UI experience(s) can assist user(s) 140 to setup a device or profile. The UI can display animations or highlight UI areas during the device or profile setup. The animations or highlighted UI areas can help the user learn the UI, discover UI features, etc. The UI can include Easter eggs used to steer users to certain features, spaces, activities, etc. For example, to help user(s) 140 calibrate microphone(s) 112 or a voice recognition feature based on audio recorded by microphone(s) 112, the UI can display content prompting or encouraging user(s) 140 to submit verbal commands or utterances via microphone(s) 112. This way, the UI can drive user(s) 140 to provide voice commands or utterances used to calibrate microphone(s) 112 or the voice recognition feature, and make the calibration process easier/seamless for user(s) 140.

In some cases, the UI experience(s) can be based on the one or more themes. When determining the UI experience(s) (and/or to help determine the UI experience(s)), UI management system 130 can use content information, sponsor information, campaign information, event information, user information, application information, statistics, social media data, historical data, topic information, and/or any other data described herein.

At 1332, UI management system 130 can optionally determine a UI container(s) to include in the UI. UI management system 130 can also determine a configuration of the UI container(s) such as, for example, a UI container type, size, shape, style, design (e.g., row, column, circle, etc.), appearance, behavior, placement, animation, background, customization (e.g., based on the one or more themes, etc.), type(s) of UI elements, UI content, content organization/arrangement, number of UI containers, and/or any other UI container attributes. The UI container(s) can organize and/or host content, UI elements, animations, and/or any other features. The UI container(s) can be customized based on the one or more themes.

UI management system 130 can generate data to configure the UI container(s) and/or a UI container specification(s) defining how to configure the UI container(s). The configuration data can include code and/or data to render, generate, and/or configure the UI container(s), such as a UI container template, specification, design, element(s), content, animation(s), UI element definition(s), behavior, parameter(s), and/or other data. The UI container(s) can be based on the one or more themes and/or include visual components thereof.

For example, the UI container(s) can display content related to the one or more themes (e.g., imagery, UI elements, media, interactive content, metadata, logos, icons, tiles, etc.). The tiles can be selectable to access or navigate to associated content, pages, and/or views. The UI container(s) (and/or tiles) can include the one or more visual attributes and/or additional attributes that are based on, related to, or have a similarity to the one or more visual attributes. To illustrate, if the one or more visual attributes of the UI include a background and imagery depicting a city theme, the UI container(s) (and/or tiles) can include the background (or a portion thereof) and/or the imagery (or a portion thereof) depicting the city theme, or can include other visual attributes that depict the city theme or another city theme (e.g., a theme of another city, the same real or fictitious city with modifications or from a different view, etc.).

At step 1344, UI management system 130 can generate UI data defining a customized configuration of the UI based on the one or more themes, the content experience(s), and/or the UI container(s). The UI data can include the customized UI or data used to generate, build, render, configure, and/or customize the UI, the content experience(s), and/or the UI container(s). For example, the UI data can include a description and/or specification of the UI, instructions for generating/customizing and/or rendering/displaying the UI, UI objects (e.g., UI elements, UI container(s), etc.), UI content, UI parameters, and/or any other data. Media device(s) 104 can use such data to generate, build, customize, render, and/or display the customized UI. The UI can include the one or more themes and the UI container(s). The UI can provide the UI experience(s) (e.g., when loaded, at a specific time, in response to a trigger/event, based on an instruction, etc.).

The UI can be further customized based on a user profile. UI management system 130 can use the profile to collect data associated with user(s) 140 and use the data when customizing the UI. UI management system 130 can customize the UI based on the data in the profile (e.g., user preferences, a watch history, user statistics, user purchases, user subscriptions, user inputs, social media data, interactions, etc.), such as the theme(s), background, experience(s), UI container(s), UI elements, visual elements, UI content, etc.

The content preference can based on a preference of a user or group, the application, an entity or sponsor, etc. The content priority can be based on a content trend score, popularity, promotion, interest score, topic reference count (e.g., a respective count of references (in one or more sources) to a respective topic associated with a content item). The content metric can include a content request count, statistic, selection weight, performance value, and/or any other metric. The content relevance can be based a relationship between each content item and a date, context, trend with a trend score, user/device location, user input, event, topic, and/or any other cue/signal.

The one or more visual attributes can be based on a UI background, animated content, UI content, visual elements, artwork, objects, UI graphics, UI imagery, UI colors or color schemes, depicted characters, a theme-based content, UI banners, UI page, and/or any other UI feature. The one or more visual attributes can include a color, text, font, thumbnail, icon, image, shape, object, graphic, scene, background, animation, garment, landmark, device, content feature, costume, accessory, activity, property or prop, artwork, and/or any other visual features. In some aspects, UI management system 130 can determine that a date corresponds to a scheduled event (e.g., a content release date, formal or informal holiday, game, competition, announcement, news event, political event, community event, social event, etc.), and select a UI theme applied to the UI displayed on that day based on the scheduled event.

In some cases, UI management system 130 can identify content that has a highest selection parameter from the respective selection parameter of each content item, and select the content based on the highest selection parameter. UI management system 130 can determine the one or more visual attributes based on the content. The highest selection parameter can include a highest content preference score, content priority, content metric, and/or content relevance.

In some examples, UI management system 130 can select content and/or features of the theme personalized to user(s) 140 based on user data. The user data can include user preferences, user inputs, historical data, user interactions, user purchases, user characteristics, user activity, profile data, social media data, and/or any other user data. The content and/or features personalized to user(s) 140 can be associated with an activity, content, team, character, competition, genre, event, topic, preference, attribute, input, etc. UI management system 130 can determine the one or more visual attributes based on the content and/or one or more features.

### Example Computer System

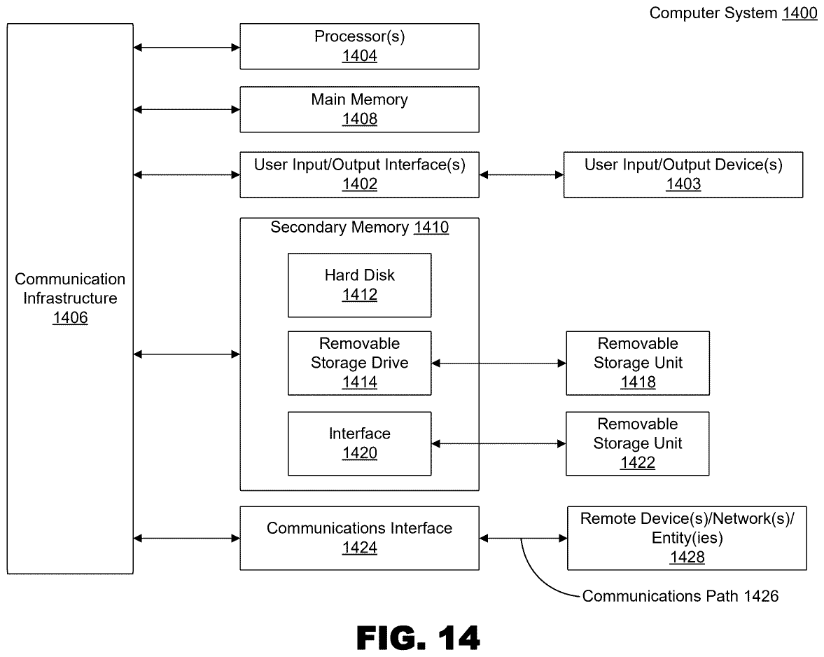

Aspects and examples described herein may be implemented using one or more computer systems, such as computer system 1400 shown in FIG. 14. For example, media device(s) 106, display device(s) 106, content server(s) 120, system server(s) 126, UI management system 130, and/or any other device may be implemented using computer system 1400 (or combinations or sub-combinations thereof). Computer system 1400 may include one or more processors (e.g., central processing units (CPUs)), such as processor 1404. Processor 1404 may be connected to communication infrastructure 1406 (or communication bus). Computer system 1400 may include input/output device(s) 1403, such as monitors, keyboards, pointing devices, etc., which may communicate with communication infrastructure 1406 through user input/output interface(s) 1402.

In some cases, the one or more processors 1404 may include a graphics processing unit (GPU). A GPU can include a processor that is a specialized electronic circuit designed to process mathematically intensive applications. The GPU may have a parallel structure for efficient, parallel processing of data, such as mathematically intensive data common to computer graphics applications, images, videos, etc. The one or more processors 1404 may additionally or alternatively include or be part of a digital signal processor (DSP), an image signal processor (ISP), an application-specific integrated circuit (ASIC), a field-programmable gate array (FPGA), an integrated circuit, a microcontroller, and/or any other processing device.

Computer system 1400 may include a main or primary memory 1408, such as random-access memory (RAM). Memory 1408 may include one or more levels of cache. Main memory 1408 may have stored therein control logic (e.g., computer software) and/or data. Computer system 1400 may also include one or more secondary storage devices or memory 1410. Secondary memory 1410 may include, for example, a hard disk drive 1412 and/or a removable storage device or drive 1414. Removable storage drive 1414 may be a floppy disk drive, magnetic tape drive, compact disk drive, optical storage device, tape backup device, and/or other storage device/drive.

Removable storage drive 1414 may interact with a removable storage unit 1418. Removable storage unit 1418 may include a computer usable or readable storage device having stored thereon computer software (control logic) and/or data. Removable storage unit 1418 may be a floppy disk, magnetic tape, compact disk, DVD, optical storage disk, /d/ any other computer data storage device. Removable storage drive 1414 may read from and/or write to removable storage unit 1418. Secondary memory 1410 may include other means, devices, components, instrumentalities or approaches for allowing computer programs, instructions, and/or data to be accessed by computer system 1400. Such means, devices, components, instrumentalities or other approaches may include, for example, a removable storage unit 1422 and an interface 1420. Examples of the removable storage unit 1422 and the interface 1420 may include a program cartridge and cartridge interface (such as that found in video game devices), removable memory chip (e.g., EPROM, PROM, etc.) and associated socket, memory stick and USB or other port, memory card and associated card slot, and/or any removable storage and associated interface.

Computer system 1400 may include a communication or network interface 1424. Communication interface 1424 may enable computer system 1400 to communicate and interact with any combination of external devices, external networks, external entities, etc. (individually and collectively referenced by reference number 1428). For example, communication interface 1424 may allow computer system 1400 to communicate with external or remote devices 1428 over communications path 1426, which may be wired and/or wireless (or a combination thereof), and which may include any combination of LANs, WANs, the Internet, etc. Control logic and/or data may be transmitted to and from computer system 1400 via communication path 1426.

Computer system 1400 may also be any of a personal digital assistant (PDA), desktop workstation, laptop or notebook computer, netbook, tablet, mobile phone (e.g., smartphone), smart watch or other wearable, appliance, part of the Internet-of-Things, and/or embedded system, to name a few non-limiting examples, or any combination thereof.

Computer system 1400 may be a client or server, accessing or hosting any applications and/or data through any delivery paradigm, including but not limited to remote or distributed cloud computing solutions; local or on-premises software (“on-premise” cloud-based solutions); “as a service” models (e.g., content as a service (CaaS), digital content as a service (DCaaS), software as a service (SaaS), managed software as a service (MSaaS), platform as a service (PaaS), desktop as a service (DaaS), framework as a service (FaaS), backend as a service (BaaS), mobile backend as a service (MBaaS), infrastructure as a service (IaaS), etc.); and/or a hybrid model including any combination of the foregoing examples or other services or delivery paradigms.

Any applicable data structures, formats, and schemas in computer system 1400 may be derived from standards including but not limited to JavaScript Object Notation (JSON), Extensible Markup Language (XML), Yet Another Markup Language (YAML), Extensible Hypertext Markup Language (XHTML), Wireless Markup Language (WML), MessagePack, XML User Interface Language (XUL), or any other functionally similar representations alone or in combination. Proprietary data structures, formats or schemas may be used, either exclusively or in combination with known or open standards.

In some cases, a tangible, non-transitory apparatus or article of manufacture comprising a tangible, non-transitory computer useable or readable medium having control logic (software) stored thereon may also be referred to herein as a computer program product or program storage device. This includes, but is not limited to, computer system 1400, main memory 1408, secondary memory 1410, and removable storage units 1418 and 1422, as well as tangible articles of manufacture embodying any combination of the foregoing. Such control logic, when executed by one or more data processing devices (such as computer system 1400 or processor(s) 1404), may cause such data processing devices to operate as described herein.

Based on the teachings contained in this disclosure, it will be apparent to one of skill in the relevant art how to make and use embodiments of this disclosure using computer and processing devices, systems, and architectures other than those described herein, which can operate with software, hardware, and/or operating system implementations other than those described herein.

### Conclusion

It is to be appreciated that the Detailed Description section, and not any other section, is intended to be used to interpret the claims. Other sections can set forth one or more but not all exemplary embodiments as contemplated by the inventor(s), and thus, are not intended to limit this disclosure or the appended claims in any way.

While this disclosure describes exemplary embodiments for exemplary fields and applications, it should be understood that the disclosure is not limited thereto. Other embodiments and modifications thereto are possible, and are within the scope and spirit of this disclosure. For example, and without limiting the generality of this paragraph, embodiments are not limited to the software, hardware, firmware, and/or entities illustrated in the figures and/or described herein. Further, embodiments (whether or not explicitly described herein) have significant utility to fields and applications beyond the examples described herein.

Embodiments have been described herein with the aid of functional building blocks illustrating implementations of specified functions and relationships thereof. The boundaries of these functional building blocks have been defined herein for the convenience of the description. Alternate boundaries can be defined as long as the specified functions and relationships (or equivalents thereof) are appropriately performed. Alternative embodiments can perform functional blocks, steps, operations, methods, etc. using orderings different than those described herein.

References to “one embodiment,” “an embodiment,” “an example embodiment,” or similar phrases indicate that the embodiment may include a particular feature, structure, or characteristic, but every embodiment may not necessarily include that feature, structure, or characteristic. Moreover, such phrases are not necessarily referring to the same embodiment. When a particular feature, structure, or characteristic is described in connection with an embodiment, it would be within the knowledge of persons skilled in the relevant art(s) to incorporate such feature, structure, or characteristic into other embodiments whether or not explicitly mentioned or described herein. Additionally, some embodiments can be described using the expression “coupled” and “connected” along with their derivatives. These terms are not necessarily intended as synonyms for each other. For example, some embodiments can be described using the terms “connected” and/or “coupled” to indicate that two or more elements are in direct physical or electrical contact with each other. The term “coupled,” however, can also mean that two or more elements are not in direct contact with each other, but yet still co-operate or interact with each other.

The breadth and scope of this disclosure should not be limited by any of the above-described exemplary embodiments, but should be defined only in accordance with the following claims and their equivalents.

Claim language or other language in the disclosure reciting “at least one of” a set and/or “one or more” of a set indicates that one member of the set or multiple members of the set (in any combination) satisfy the claim. For example, claim language reciting “at least one of A and B” or “at least one of A or B” means A, B, or A and B. In another example, claim language reciting “at least one of A, B, and C” or “at least one of A, B, or C” means A, B, C, or A and B, or A and C, or B and C, or A and B and C. The language “at least one of” a set and/or “one or more” of a set does not limit the set to the items listed in the set. For example, claim language reciting “at least one of A and B” or “at least one of A or B” can mean A, B, or A and B, and can additionally include items not listed in the set of A and B.

Illustrative examples of the disclosure include:
Aspect 1. A system comprising: memory and one or more processors coupled to the memory and configured to perform operations comprising: determining a set of features associated with a user interface (UI) of an application, the set of features comprising at least one of a content item, a functionality of the UI, a setting of the UI, and a destination of the UI; selecting a feature from the set of features based on at least one of a theme of the UI and a respective selection parameter of each feature from the set of features, the respective selection parameter defining at least one of a feature preference, a feature priority, a feature metric, and a feature relevance with respect to at least one of a date associated with a presentation of the UI, a user associated with the UI, the application, and feature topic; generating, via an artificial intelligence (AI) model, animated content for the UI, the animated content depicting at least one of the selected feature and an interaction between the animated content and a portion of the UI associated with the selected feature; and providing the animated content to at least one of the UI and a device associated with the user.
Aspect 2. The system of Aspect 1, wherein the feature preference is based on a preference of at least one of the user, a group of users, the application, an entity associated with the application, and a sponsor associated with the application.
Aspect 3. The system of any of Aspects 1 or 2, wherein the feature priority is based on at least one of a feature trend score, a feature popularity, a feature promotion associated with a sponsor or business, a feature interest score, and a respective count of references in one or more sources to a respective topic associated with a respective feature, the one or more sources comprising at least one of a media source, a social media network, and the UI.
Aspect 4. The system of any of Aspects 1 to 3, wherein the feature metric comprises at least one of a feature request count, a feature statistic, a feature selection weight specified by at least one of the application and an entity associated with the application, and a feature performance value.
Aspect 5. The system of any of Aspects 1 to 4, wherein the feature relevance is based on at least one of a relationship between each feature and at least one of the date, a context associated with the user, a trend associated with a trend score, a location associated with the user, a user input, and an event.
Aspect 6. The system of any of Aspects 1 to 5, wherein the feature comprises the setting of the UI, and wherein the animated content depicts an object or animated graphic interacting with at least one of a control element used to configure the setting, the portion of the UI associated with the feature, and each UI element along a navigation path to a control element used to configure the setting, and wherein the portion of the UI associated with the feature comprises an area of the UI comprising the control element.
Aspect 7. The system of any of Aspects 1 to 6, wherein the feature comprises the functionality of the UI, and wherein the animated content depicts an action of an object or animated graphic, the action comprising at least one of an interaction with a control element associated with the functionality, an interaction with a UI area associated with the functionality, a first animation that visually depicts a UI behavior associated with the functionality, and a second animation determined based on the UI behavior associated with the functionality.
Aspect 8. The system of any of Aspects 1 to 7, wherein the feature comprises the destination of the UI, wherein the animated content depicts an object or animated graphic moving along a UI path and reaching the destination of the UI, and wherein the destination of the UI comprises at least one of a UI element, an object configured to provide access to a media content item, a UI page, and a UI section.
Aspect 9. The system of any of Aspects 1 to 8, wherein the one or more processors are configured to perform operations further comprising: determining that the date corresponds to a scheduled event, wherein the scheduled event comprises at least one of a content release date or promotion, a formal holiday recognized by one or more entities, an informal holiday comprising a commemorative day celebrated by one or more users, a game, a competition, an announcement, a news event, a political event, and a community event; based on the determining that the date corresponds to the scheduled event, determining which feature has a highest selection parameter from the respective selection parameter of each feature, the highest selection parameter comprising at least one of a highest feature preference score, a highest feature priority, a highest feature metric, and a highest feature relevance; selecting the feature based on a determination that the selected feature has the highest selection parameter; and generating the animated content based on the selected feature.
Aspect 10. The system of any of Aspects 1 to 9, wherein the one or more processors are configured to perform operations further comprising: selecting the feature further based on user data, the user data comprising at least one of a user preference, a user input, a user history, a user interaction, a user purchase, a user characteristic, a user profile, and a user activity.
Aspect 11. A computer-implemented method comprising: determining a set of features associated with a user interface (UI) of an application, the set of features comprising at least one of a content item, a functionality of the UI, a setting of the UI, and a destination of the UI; selecting a feature from the set of features based on at least one of a theme of the UI and a respective selection parameter of each feature from the set of features, the respective selection parameter defining at least one of a feature preference, a feature priority, a feature metric, and a feature relevance with respect to at least one of a date associated with a presentation of the UI, a user associated with the UI, the application, and topic; generating, via an artificial intelligence (AI) model, animated content for display at the UI, the animated content depicting at least one of the selected feature and an interaction between the animated content and a portion of the UI associated with the selected feature; and providing the animated content to at least one of the UI and a device associated with the user.
Aspect 12. The computer-implemented method of Aspect 11, wherein the feature preference is based on a preference of at least one of the user, a group of users, the application, an entity associated with the application, and a sponsor associated with the application.
Aspect 13. The computer-implemented method of any of Aspects 11 to 12, wherein the feature priority is based on at least one of a feature trend score, a feature popularity, a feature promotion associated with a sponsor, a feature interest score, and a respective count of references in one or more sources to a respective feature topic, the one or more sources comprising at least one of a media source, a social media network, and the UI.
Aspect 14. The computer-implemented method of any of Aspects 11 to 13, wherein the feature metric comprises at least one of a feature request count, a feature statistic, a feature selection weight, and a feature performance value.
Aspect 15. The computer-implemented method of any of Aspects 11 to 14, wherein the feature relevance is based on at least one of a relationship between each feature and at least one of the date, a user context, a trend, a location associated with the user, a user input, and an event.
Aspect 16. The computer-implemented method of any of Aspects 11 to 15, wherein the feature comprises the setting of the UI, and wherein the animated content depicts an object or animated graphic interacting with at least one of a control element used to configure the setting, the portion of the UI associated with the feature, and each UI element along a navigation path to a control element used to configure the setting, and wherein the portion of the UI associated with the feature comprises an area of the UI comprising the control element.
Aspect 17. The computer-implemented method of any of Aspects 11 to 16, wherein the feature comprises the functionality of the UI, and wherein the animated content depicts an action of an object or animated graphic, the action comprising at least one of an interaction with a control element associated with the functionality, an interaction with a UI area associated with the functionality, a first animation that visually depicts a UI behavior associated with the functionality, and a second animation determined based on the UI behavior associated with the functionality.
Aspect 18. The computer-implemented method of any of Aspects 11 to 17, wherein the feature comprises the destination of the UI, wherein the animated content depicts an object or animated graphic moving through the UI and reaching the destination of the UI, and wherein the destination of the UI comprises at least one of a UI element, an object configured to provide access to content, a UI page, and a UI section.
Aspect 19. The computer-implemented method of any of Aspects 11 to 18, wherein the one or more processors are configured to perform operations further comprising: determining that the date corresponds to a scheduled event, wherein the scheduled event comprises at least one of a content release date or promotion, a formal holiday recognized by one or more entities, an informal holiday comprising a commemorative day celebrated by one or more users, a game, a competition, an announcement, a news event, a political event, and a community event; based on the determining that the date corresponds to the scheduled event, determining which feature has a highest selection parameter, the highest selection parameter comprising at least one of a highest feature preference score, a highest feature priority, a highest feature metric, and a highest feature relevance; selecting the feature that has the highest selection parameter; and generating the animated content based on the selected feature.
Aspect 20. A non-transitory computer-readable medium having instructions stored thereon that, when executed by one or more processors, cause the one or more processors to perform a method according to any of Aspects 11 to 19.

What is claimed is:

1. A system comprising:
memory; and
one or more processors are coupled to the memory and configured to perform operations comprising:
determining a set of features associated with a user interface (UI) of an application, the set of features comprising at least one of a content item, a functionality of the UI, a setting of the UI, and a destination of the UI;
selecting a feature from the set of features based on at least one of a theme of the UI and a respective selection parameter of each feature from the set of features, the respective selection parameter defining at least one of a feature preference, a feature priority, a feature metric, and a feature relevance with respect to at least one of a date associated with a presentation of the UI, a user associated with the UI, the application, and feature topic;
generating, via an artificial intelligence (AI) model, animated content for the UI, the animated content depicting at least one of the selected feature and an interaction between the animated content and a portion of the UI associated with the selected feature; and
providing the animated content to at least one of the UI and a device associated with the user.

2. The system of claim 1, wherein the feature preference is based on a preference of at least one of the user, a group of users, the application, an entity associated with the application, and a sponsor associated with the application.

3. The system of claim 1, wherein the feature priority is based on at least one of a feature trend score, a feature popularity, a feature promotion associated with a sponsor or business, a feature interest score, and a respective count of references in one or more sources to a respective topic associated with a respective feature, the one or more sources comprising at least one of a media source, a social media network, and the UI.

4. The system of claim 1, wherein the feature metric comprises at least one of a feature request count, a feature statistic, a feature selection weight specified by at least one of the application and an entity associated with the application, and a feature performance value.

5. The system of claim 1, wherein the feature relevance is based on at least one of a relationship between each feature and at least one of the date, a context associated with the user, a trend associated with a trend score, a location associated with the user, a user input, and an event.

6. The system of claim 1, wherein the feature comprises the setting of the UI, and wherein the animated content depicts an object or animated graphic interacting with at least one of a control element used to configure the setting, the portion of the UI associated with the feature, and each UI element along a navigation path to a control element used to configure the setting, and wherein the portion of the UI associated with the feature comprises an area of the UI comprising the control element.

7. The system of claim 1, wherein the feature comprises the functionality of the UI, and wherein the animated content depicts an action of an object or animated graphic, the action comprising at least one of an interaction with a control element associated with the functionality, an interaction with a UI area associated with the functionality, a first animation that visually depicts a UI behavior associated with the functionality, and a second animation determined based on the UI behavior associated with the functionality.

8. The system of claim 1, wherein the feature comprises the destination of the UI, wherein the animated content depicts an object or animated graphic moving along a UI path and reaching the destination of the UI, and wherein the destination of the UI comprises at least one of a UI element, an object configured to provide access to a media content item, a UI page, and a UI section.

9. The system of claim 1, wherein the one or more processors are configured to perform operations further comprising:
determining that the date corresponds to a scheduled event, wherein the scheduled event comprises at least one of a content release date or promotion, a formal holiday recognized by one or more entities, an informal holiday comprising a commemorative day celebrated by one or more users, a game, a competition, an announcement, a news event, a political event, and a community event;
based on the determining that the date corresponds to the scheduled event, determining which feature has a highest selection parameter from the respective selection parameter of each feature, the highest selection parameter comprising at least one of a highest feature preference score, a highest feature priority, a highest feature metric, and a highest feature relevance;
selecting the feature based on a determination that the selected feature has the highest selection parameter; and
generating the animated content based on the selected feature.

10. The system of claim 1, wherein the one or more processors are configured to perform operations further comprising:
selecting the feature further based on user data, the user data comprising at least one of a user preference, a user input, a user history, a user interaction, a user purchase, a user characteristic, a user profile, and a user activity.

11. A computer-implemented method comprising:
determining a set of features associated with a user interface (UI) of an application, the set of features comprising at least one of a content item, a functionality of the UI, a setting of the UI, and a destination of the UI;
selecting a feature from the set of features based on at least one of a theme of the UI and a respective selection parameter of each feature from the set of features, the respective selection parameter defining at least one of a feature preference, a feature priority, a feature metric, and a feature relevance with respect to at least one of a date associated with a presentation of the UI, a user associated with the UI, the application, and topic;
generating, via an artificial intelligence (AI) model, animated content for display at the UI, the animated content depicting at least one of the selected feature and an interaction between the animated content and a portion of the UI associated with the selected feature; and
providing the animated content to at least one of the UI and a device associated with the user.

12. The computer-implemented method of claim 11, wherein the feature preference is based on a preference of at least one of the user, a group of users, the application, an entity associated with the application, and a sponsor associated with the application.

13. The computer-implemented method of claim 11, wherein the feature priority is based on at least one of a feature trend score, a feature popularity, a feature promotion associated with a sponsor, a feature interest score, and a respective count of references in one or more sources to a respective feature topic, the one or more sources comprising at least one of a media source, a social media network, and the UI.

14. The computer-implemented method of claim 11, wherein the feature metric comprises at least one of a feature request count, a feature statistic, a feature selection weight specified by at least one of the application and an entity associated with the application, and a feature performance value.

15. The computer-implemented method of claim 11, wherein the feature relevance is based on at least one of a relationship between each feature and at least one of the date, a context associated with the user, a trend associated with a trend score, a location associated with the user, a user input, and an event.

16. The computer-implemented method of claim 11, wherein the feature comprises the setting of the UI, and wherein the animated content depicts an object or animated graphic interacting with at least one of a control element used to configure the setting, the portion of the UI associated with the feature, and each UI element along a navigation path to a control element used to configure the setting, and wherein the portion of the UI associated with the feature comprises an area of the UI comprising the control element.

17. The computer-implemented method of claim 11, wherein the feature comprises the functionality of the UI, and wherein the animated content depicts an action of an object or animated graphic, the action comprising at least one of an interaction with a control element associated with the functionality, an interaction with a UI area associated with the functionality, a first animation that visually depicts a UI behavior associated with the functionality, and a second animation determined based on the UI behavior associated with the functionality.

18. The computer-implemented method of claim 11, wherein the feature comprises the destination of the UI, wherein the animated content depicts an object or animated graphic moving along a UI path and reaching the destination of the UI, and wherein the destination of the UI comprises at least one of a UI element, an object configured to provide access to a media content item, a UI page, and a UI section.

19. The computer-implemented method of claim 11, wherein the one or more processors are configured to perform operations further comprising:
determining that the date corresponds to a scheduled event, wherein the scheduled event comprises at least one of a content release date or promotion, a formal holiday recognized by one or more entities, an informal holiday comprising a commemorative day celebrated by one or more users, a game, a competition, an announcement, a news event, a political event, and a community event;
based on the determining that the date corresponds to the scheduled event, determining which feature has a highest selection parameter, the highest selection parameter comprising at least one of a highest feature preference score, a highest feature priority, a highest feature metric, and a highest feature relevance;
selecting the feature that has the highest selection parameter; and
generating the animated content based on the selected feature.

20. A non-transitory computer-readable medium having instructions stored thereon that, when executed by one or more processors, cause the one or more processors to perform operations comprising:
determining a set of features associated with a user interface (UI) of an application, the set of features comprising at least one of a content item, a functionality of the UI, a setting of the UI, and a destination of the UI;
selecting a feature from the set of features based on at least one of a theme of the UI and a respective selection parameter of each feature from the set of features, the respective selection parameter defining at least one of a feature preference, a feature priority, a feature metric, and a feature relevance with respect to at least one of a date associated with a presentation of the UI, a user associated with the UI, the application, and topic;
generating, via an artificial intelligence (AI) model, animated content for the UI, the animated content depicting at least one of the selected feature and an interaction between the animated content and a portion of the UI associated with the selected feature; and
providing the animated content to at least one of the UI and a device associated with the user.
